(19) United States
(12) Patent Application Publication
(10) Pub. No.: US 2013/0013589 A1
(43) Pub. Date: Jan. 10, 2013

(54) Customer Relationship Management System

(76) Inventors: Todd Stevenson, San Rafael, CA (US); Tony Magee, Pt. Reyes Station, CA (US); Jason Gregori, Petaluma, CA (US); Greg Merideth, Napa, CA (US); Jeremy Grenert, Petaluma, CA (US)

(21) Appl. No.: 13/544,863

(22) Filed: Jul. 9, 2012

Related U.S. Application Data
(60) Provisional application No. 61/505,453, filed on Jul. 7, 2011.

(51) Int. Cl. G06F 17/30

(52) U.S. Cl. 707/722; 707/E17.059

(57) ABSTRACT

A computer-implemented method for customer relationship management is provided. The method may include receiving an indication from a user at one or more customer relationship management graphical user interfaces. The method may further include identifying one or more accounts associated with the user. The method may also include providing an itinerary or portion of an itinerary to the user for a particular time period via at least one of the one or more customer relationship management graphical user interfaces. The method may additionally include filtering the one or more accounts based upon, at least in part, an input from the user to generate a filtered result set. The method may also include storing at least one of the filtered result set and the itinerary.

### CROSS-REFERENCE TO RELATED APPLICATIONS

This application claims the benefit of U.S. provisional patent application Ser. No. 61/505,453, entitled “CRM System” filed on, Jul. 7, 2011, the entire disclosure of which application is incorporated herein by reference.

### TECHNICAL FIELD

This disclosure relates to customer relationship management systems and, more particularly, to a system and method for customer relationship management in the beverage industry.

### BACKGROUND

Customer relationship management (CRM) generally refers to a model for managing a company's dealings with customers, clients, and sales prospects. CRM may involve using technology to organize, automate, and synchronize business processes. Some of which may include, but are not limited to, sales activities, marketing, customer service, and technical support.

### SUMMARY OF DISCLOSURE

In one implementation, a computer-implemented method for customer relationship management is provided. The method may include receiving an indication from a user at one or more customer relationship management graphical user interfaces. The method may further include identifying one or more accounts associated with the user. The method may also include providing an itinerary or portion of an itinerary to the user for a particular time period via at least one of the one or more customer relationship management graphical user interfaces. The method may additionally include filtering the one or more accounts based upon, at least in part, an input from the user to generate a filtered result set. The method may also include storing at least one of the filtered result set and the itinerary.

One or more of the following features may be included. The method may include ordering, using the one or more computing devices, the filtered result set based upon a predetermined setting. In some embodiments, ordering may be based upon at least one of, a volume of products sold, a dollar amount of products sold, a city name, a zip code, and a name. The method may also include providing, using the one or more computing devices, a map view with a geographical location corresponding to each of the one or more accounts. The method may also include generating, using the one or more computing devices, at least one route based upon, at least one of, the geographical location, account information, and account volume. The method may further include generating, using the one or more computing devices, a new account based upon, at least in part, information received from the user. In some embodiments, the new account information may include classification information.

In another implementation, a computer program product residing on a computer readable storage medium is provided. The computer program product may have a plurality of instructions stored thereon, which when executed by a processor, cause the processor to perform operations. Operations may include receiving an indication from a user at one or more customer relationship management graphical user interfaces. Operations may further include identifying one or more accounts associated with the user. Operations may also include providing an itinerary or portion of an itinerary to the user for a particular time period via at least one of the one or more customer relationship management graphical user interfaces. Operations may additionally include filtering the one or more accounts based upon, at least in part, an input from the user to generate a filtered result set. Operations may also include storing at least one of the filtered result set and the itinerary.

One or more of the following features may be included. In some embodiments, operations may include ordering, using the one or more computing devices, the filtered result set based upon a predetermined setting. In some embodiments, ordering may be based upon at least one of, a volume of products sold, a dollar amount of products sold, a city name, a zip code, and a name. Operations may also include providing, using the one or more computing devices, a map view with a geographical location corresponding to each of the one or more accounts. Operations may also include generating, using the one or more computing devices, at least one route based upon, at least one of, the geographical location, account information, and account volume. Operations may further include generating, using the one or more computing devices, a new account based upon, at least in part, information received from the user. In some embodiments, the new account information may include classification information.

In another implementation, a computing system having one or more processors is provided. The one or more processors may be configured to receive an indication from a user at one or more customer relationship management graphical user interfaces. The one or more processors may be further configured to identify one or more accounts associated with the user. The one or more processors may be further configured to provide an itinerary or portion of an itinerary to the user for a particular time period via at least one of the one or more customer relationship management graphical user interfaces. The one or more processors may be further configured to filter the one or more accounts based upon, at least in part, an input from the user to generate a filtered result set. The one or more processors may be further configured to store at least one of the filtered result set and the itinerary.

One or more of the following features may be included. The one or more processors may be configured to order the filtered result set based upon a predetermined setting. In some embodiments, ordering may be based upon at least one of, a volume of products sold, a dollar amount of products sold, a city name, a zip code, and a name. The one or more processors may be further configured to provide a map view with a geographical location corresponding to each of the one or more accounts. The one or more processors may be further configured to generate at least one route based upon, at least one of, the geographical location, account information, and account volume. The one or more processors may be further configured to generate a new account based upon, at least in part, information received from the user. In some embodiments, the new account information may include classification information.

The details of one or more implementations are set forth in the accompanying drawings and the description below. Other features and advantages will become apparent from the description, the drawings, and the Claims.

### BRIEF DESCRIPTION OF THE DRAWINGS

FIG. 1 is a diagrammatic view of a CRM process coupled to a distributed computing network;

FIG. 2 is a flowchart of the CRM process of FIG. 1;

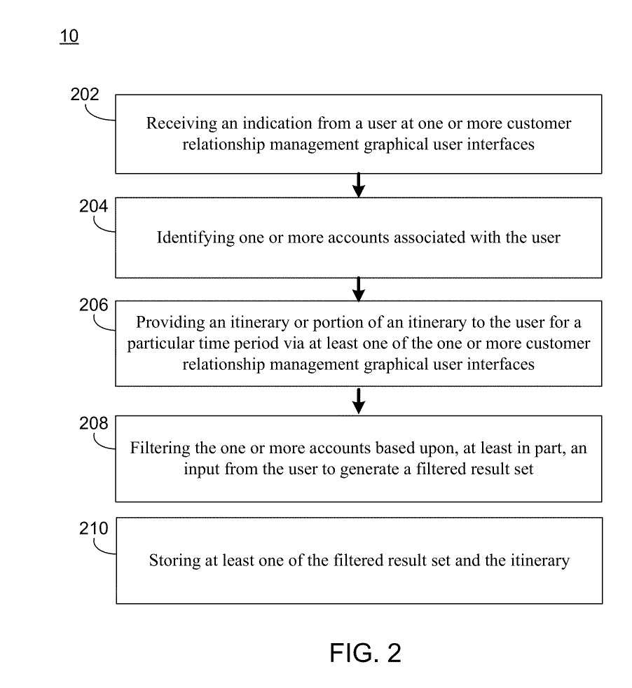

FIG. 3 is a diagrammatic view of a graphical user interface displayed by the CRM process of FIG. 1;

FIG. 4 is a diagrammatic view of a graphical user interface displayed by the CRM process of FIG. 1;

FIG. 5 is a diagrammatic view of a graphical user interface displayed by the CRM process of FIG. 1;

FIG. 6 is a diagrammatic view of a graphical user interface displayed by the CRM process of FIG. 1;

FIG. 7 is a diagrammatic view of a graphical user interface displayed by the CRM process of FIG. 1;

FIG. 8 is a diagrammatic view of a graphical user interface displayed by the CRM process of FIG. 1;

FIG. 9 is a diagrammatic view of a graphical user interface displayed by the CRM process of FIG. 1;

FIG. 10 is a diagrammatic view of a graphical user interface displayed by the CRM process of FIG. 1;

FIG. 11 is a diagrammatic view of a graphical user interface displayed by the CRM process of FIG. 1;

FIG. 12 is a diagrammatic view of a graphical user interface displayed by the CRM process of FIG. 1;

FIG. 13 is a diagrammatic view of a graphical user interface displayed by the CRM process of FIG. 1;

FIG. 14 is a diagrammatic view of a graphical user interface displayed by the CRM process of FIG. 1;

FIG. 15 is diagrammatic view of a graphical user interface displayed by the CRM process of FIG. 1; and

FIG. 16 is a diagrammatic view of a graphical user interface displayed by the CRM process of FIG. 1;

FIG. 17 is a diagrammatic view of a graphical user interface displayed by the CRM process of FIG. 1;

FIG. 18 is a diagrammatic view of a graphical user interface displayed by the CRM process of FIG. 1;

FIG. 19 is a diagrammatic view of a graphical user interface displayed by the CRM process of FIG. 1;

FIG. 20 is a diagrammatic view of a graphical user interface displayed by the CRM process of FIG. 1;

FIG. 21 is a diagrammatic view of a graphical user interface displayed by the CRM process of FIG. 1;

FIG. 22 is a diagrammatic view of a graphical user interface displayed by the CRM process of FIG. 1;

FIG. 23 is a diagrammatic view of a graphical user interface displayed by the CRM process of FIG. 1;

FIG. 24 is a diagrammatic view of a graphical user interface displayed by the CRM process of FIG. 1;

FIG. 25 is a diagrammatic view of a graphical user interface displayed by the CRM process of FIG. 1;

FIG. 26 is a diagrammatic view of a graphical user interface displayed by the CRM process of FIG. 1;

FIG. 27 is a diagrammatic view of a graphical user interface displayed by the CRM process of FIG. 1;

FIG. 28 is a diagrammatic view of a graphical user interface displayed by the CRM process of FIG. 1;

FIG. 29 is a diagrammatic view of a graphical user interface displayed by the CRM process of FIG. 1;

FIG. 30 is a diagrammatic view of a graphical user interface displayed by the CRM process of FIG. 1;

FIG. 31 is a diagrammatic view of a graphical user interface displayed by the CRM process of FIG. 1;

FIG. 32 is a diagrammatic view of a graphical user interface displayed by the CRM process of FIG. 1;

FIG. 33 is a diagrammatic view of a graphical user interface displayed by the CRM process of FIG. 1;

FIG. 34 is a diagrammatic view of a graphical user interface displayed by the CRM process of FIG. 1;

FIG. 35 is a diagrammatic view of a graphical user interface displayed by the CRM process of FIG. 1;

FIG. 36 is a diagrammatic view of a graphical user interface displayed by the CRM process of FIG. 1;

FIG. 37 is a diagrammatic view of a graphical user interface displayed by the CRM process of FIG. 1;

FIG. 38 is a diagrammatic view of a graphical user interface displayed by the CRM process of FIG. 1;

FIG. 39 is a diagrammatic view of a graphical user interface displayed by the CRM process of FIG. 1;

FIG. 40 is a diagrammatic view of a graphical user interface displayed by the CRM process of FIG. 1;

FIG. 41 is diagrammatic view of a graphical user interface displayed by the CRM process of FIG. 1; and

FIG. 42 is a diagrammatic view of a graphical user interface displayed by the CRM process of FIG. 1;

FIG. 43 is a diagrammatic view of a graphical user interface displayed by the CRM process of FIG. 1;

FIG. 44 is a diagrammatic view of a graphical user interface displayed by the CRM process of FIG. 1;

FIG. 45 is a diagrammatic view of a graphical user interface displayed by the CRM process of FIG. 1;

FIG. 46 is a diagrammatic view of a graphical user interface displayed by the CRM process of FIG. 1;

FIG. 47 is a diagrammatic view of a graphical user interface displayed by the CRM process of FIG. 1;

FIG. 48 is a diagrammatic view of a graphical user interface displayed by the CRM process of FIG. 1;

FIG. 49 is a diagrammatic view of a graphical user interface displayed by the CRM process of FIG. 1;

FIG. 50 is a diagrammatic view of a graphical user interface displayed by the CRM process of FIG. 1;

FIG. 51 is a diagrammatic view of a graphical user interface displayed by the CRM process of FIG. 1;

FIG. 52 is a diagrammatic view of a graphical user interface displayed by the CRM process of FIG. 1;

FIG. 53 is a diagrammatic view of a graphical user interface displayed by the CRM process of FIG. 1;

FIG. 54 is a diagrammatic view of a graphical user interface displayed by the CRM process of FIG. 1;

FIG. 55 is a diagrammatic view of a graphical user interface displayed by the CRM process of FIG. 1;

FIG. 56 is a diagrammatic view of a graphical user interface displayed by the CRM process of FIG. 1;

FIG. 57 is a diagrammatic view of a graphical user interface displayed by the CRM process of FIG. 1;

FIG. 58 is a diagrammatic view of a graphical user interface displayed by the CRM process of FIG. 1;

FIG. 59 is a diagrammatic view of a graphical user interface displayed by the CRM process of FIG. 1;

FIG. 60 is a diagrammatic view of a graphical user interface displayed by the CRM process of FIG. 1;

FIG. 61 is a diagrammatic view of a graphical user interface displayed by the CRM process of FIG. 1;

FIG. 62 is a diagrammatic view of a graphical user interface displayed by the CRM process of FIG. 1;

FIG. 63 is a diagrammatic view of a graphical user interface displayed by the CRM process of FIG. 1;

FIG. 64 is a diagrammatic view of a graphical user interface displayed by the CRM process of FIG. 1;

FIG. 65 is a diagrammatic view of a graphical user interface displayed by the CRM process of FIG. 1;

FIG. 66 is a diagrammatic view of a graphical user interface displayed by the CRM process of FIG. 1;

FIG. 67 is diagrammatic view of a graphical user interface displayed by the CRM process of FIG. 1; and

FIG. 68 is a diagrammatic view of a graphical user interface displayed by the CRM process of FIG. 1;

FIG. 69 is a diagrammatic view of a graphical user interface displayed by the CRM process of FIG. 1;

FIG. 70 is a diagrammatic view of a graphical user interface displayed by the CRM process of FIG. 1;

FIG. 71 is a diagrammatic view of a graphical user interface displayed by the CRM process of FIG. 1;

FIG. 72 is a diagrammatic view of a graphical user interface displayed by the CRM process of FIG. 1;

FIG. 73 is a diagrammatic view of a graphical user interface displayed by the CRM process of FIG. 1;

FIG. 74 is a diagrammatic view of a graphical user interface displayed by the CRM process of FIG. 1;

FIG. 75 is a diagrammatic view of a graphical user interface displayed by the CRM process of FIG. 1;

FIG. 76 is a diagrammatic view of a graphical user interface displayed by the CRM process of FIG. 1;

FIG. 77 is a diagrammatic view of a graphical user interface displayed by the CRM process of FIG. 1;

FIG. 78 is a diagrammatic view of a graphical user interface displayed by the CRM process of FIG. 1;

FIG. 79 is a diagrammatic view of a graphical user interface displayed by the CRM process of FIG. 1;

FIG. 80 is a diagrammatic view of a graphical user interface displayed by the CRM process of FIG. 1;

FIG. 81 is a diagrammatic view of a graphical user interface displayed by the CRM process of FIG. 1;

FIG. 82 is a diagrammatic view of a graphical user interface displayed by the CRM process of FIG. 1;

FIG. 83 is a diagrammatic view of a graphical user interface displayed by the CRM process of FIG. 1;

FIG. 84 is a diagrammatic view of a graphical user interface displayed by the CRM process of FIG. 1;

FIG. 85 is a diagrammatic view of a graphical user interface displayed by the CRM process of FIG. 1;

FIG. 86 is a diagrammatic view of a graphical user interface displayed by the CRM process of FIG. 1;

FIG. 87 is a diagrammatic view of a graphical user interface displayed by the CRM process of FIG. 1;

FIG. 88 is a diagrammatic view of a graphical user interface displayed by the CRM process of FIG. 1;

FIG. 89 is a diagrammatic view of a graphical user interface displayed by the CRM process of FIG. 1;

FIG. 90 is a diagrammatic view of a graphical user interface displayed by the CRM process of FIG. 1;

FIG. 91 is a diagrammatic view of a graphical user interface displayed by the CRM process of FIG. 1;

FIG. 92 is a diagrammatic view of a graphical user interface displayed by the CRM process of FIG. 1;

FIG. 93 is diagrammatic view of a graphical user interface displayed by the CRM process of FIG. 1; and

FIG. 94 is a diagrammatic view of a graphical user interface displayed by the CRM process of FIG. 1;

FIG. 95 is a diagrammatic view of a graphical user interface displayed by the CRM process of FIG. 1;

FIG. 96 is a diagrammatic view of a graphical user interface displayed by the CRM process of FIG. 1; and

FIG. 97 is a diagrammatic view of a graphical user interface displayed by the CRM process of FIG. 1.

Like reference symbols in the various drawings may indicate like elements.

### DETAILED DESCRIPTION OF THE EMBODIMENTS

### System Overview:

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

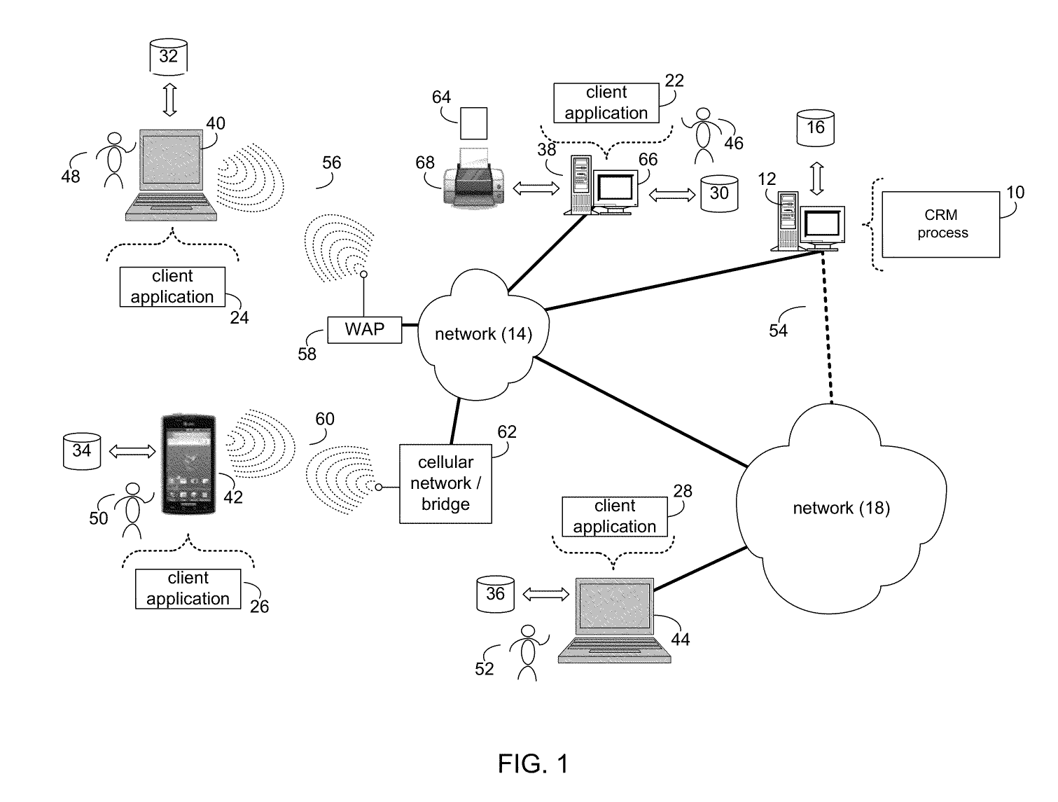

Referring to FIG. 1, there is shown CRM process 10 that may reside on and may be executed by computer 12, which may be connected to network 14 (e.g., the Internet or a local area network). Examples of computer 12 may include but are not limited to a single server computer, a series of server computers, a single personal computer, a series of personal computers, a mini computer, a mainframe computer, or a computing cloud. The various components of computer 12 may execute one or more operating systems, examples of which may include but are not limited to: Microsoft Windows Server™; Novell Netware™; Redhat Linux™, Unix, or a custom operating system, for example.

As will be discussed below in greater detail, CRM process 10 may include receiving (202) an indication from a user at one or more customer relationship management graphical user interfaces. The method may further include identifying (204) one or more accounts associated with the user. The method may also include providing (206) an itinerary or portion of an itinerary to the user for a particular time period via at least one of the one or more customer relationship management graphical user interfaces. The method may additionally include filtering (208) the one or more accounts based upon, at least in part, an input from the user to generate a filtered result set. The method may also include storing (210) at least one of the filtered result set and the itinerary.

The instruction sets and subroutines of CRM process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

CRM process 10 may be accessed via client applications 22, 24, 26, 28. Examples of client applications 22, 24, 26, 28 may include but are not limited to a standard web browser, a customized web browser, or a custom application. The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively).

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, personal computer 38, laptop computer 40, smart phone 42, notebook computer 44, a server (not shown), a data-enabled, cellular telephone (not shown), and a dedicated network device (not shown).

One or more of client applications 22, 24, 26, 28 may be configured to effectuate some or all of the functionality of CRM process 10. Accordingly, CRM process 10 may be a purely server-side application, a purely client-side application, or a hybrid server-side/client-side application that is cooperatively executed by one or more of client applications 22, 24, 26, 28 and CRM process 10.

Users 46, 48, 50, 52 may access computer 12 and CRM process 10 directly through network 14 or through secondary network 18. Further, computer 12 may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Smart phone 42 is shown wirelessly coupled to network 14 via wireless communication channel 60 established between smart phone 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and smart phones to be interconnected using a short-range wireless connection.

Client electronic devices 38, 40, 42, 44 may each execute an operating system, examples of which may include but are not limited to Apple iOS™, Microsoft Windows™, Android™, Redhat Linux™, or a custom operating system.

Embodiments disclosed herein are directed towards a CRM process. CRM process 10 may be implemented in one or more applications, the organization of which may help to facilitate a sales call for employees in the beverage industry, and beyond. The flow and layout the various user interfaces associated with CRM process 10 are configured to address how management expects a sales person to complete their account visits throughout the day. The order of tasks to complete are laid out for the sales person to complete one by one. The CRM process described herein includes a system configured to manage remote sales employees, facilitate their craft, and report on the outcome.

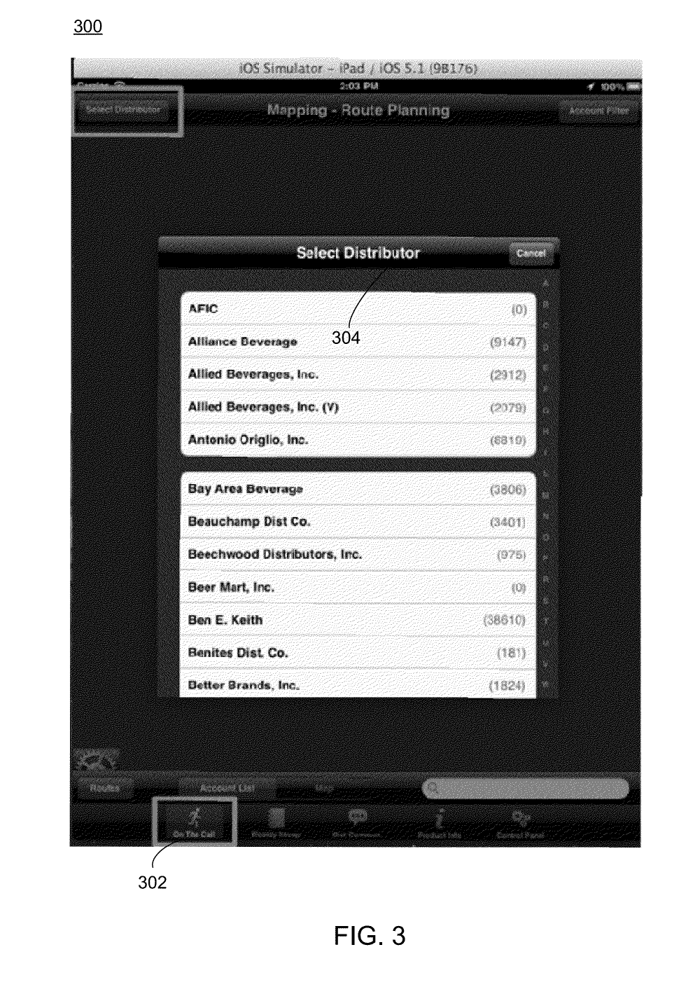

Referring now to FIGS. 3-31, examples of graphical user interfaces generated in accordance with CRM process 10 are provided. In some embodiments, the interfaces shown in FIGS. 3-31 may be generated by one or more computing devices, for example, client electronic devices 38, 40, 42, 44 shown in FIG. 1. Each of the graphical user interfaces may be configured to receive an indication from a user, for example, users 46, 48, 50, 52.

Referring now to FIG. 3, an embodiment depicting interface 300 generated in accordance with CRM process 10 is depicted. In some embodiments, interface 300 may include an “on the call” portal 302. Portal 302 may be generated in accordance with CRM process 10 and may be used by any suitable user (e.g. members of the sales department, etc). Accordingly, portal 302 may include capabilities that allow users to perform numerous operations. Some operation may include, but are not limited to, filtering distributor account lists, creating account visits, setting sales goals for the visit, communicating important account level information back to the distributor, etc. Interface 300 may further include a select distributor button 304. Select distributor button 304 may allow for the generation of a distributor selection view as is shown in FIG. 3. The distributor selection view may be generated by CRM process 10 and may allow various users to review a list of all distributors, and to choose which distributor's account list to view.

As shown in FIG. 3, portal 302 may dictate a sales person's day, and may be configured to demonstrate the flow of how an employee will conduct their business. With the CRM, our users have the ability to bring down a complete account list from anyone of our many distributors. The accounts for that distributor may be brought on to the device, and may be displayed in a table view. The accounts may be sorted in alphabetical order. However, in some embodiments, upon user selection, these accounts may be ordered by the volume of products they have sold (e.g., rolling 12 month, or YTD), as well as the proximity of the account to the sales person. This account ordering mechanism provides our employees the ability to see the top accounts within the distributor, or to see the distributor's accounts closest to them.

In some embodiments, in order to narrow a search, there may be an array of filter options that can be applied to the account list. The sales person can filter the list by name, city, state, zip. The list can be filtered by whether the account sells certain products or not, or by exactly which products are sold.

In some embodiments, at any point the account list may be shown in a map view, where each account is plotted with a pin, and the color of the pin is determined by whether the account currently sells certain products. This may provide members of the sales team with the advantage of seeing the distributor's accounts from a geographical standpoint, and the ability to determine which type of accounts, buying or non-buying, need to be targeted most.

In some embodiments, CRM process 10 may provide the ability to dictate not only which accounts a given sales person visits on a day, but also, the method in which the sales calls are performed. CRM process 10 may allow for the creation of account routes (e.g. ordered lists of accounts can be saved). These routes may be assigned to a particular user (e.g., a sales representative for a specific market). Regional Managers create routes based on geography, account information, account volume, etc. These routes may be viewed in map view, and the sales representative may receive detailed step-by-step travel instructions on how to get from account to account.

In some embodiments, once a member of the sales team gets to an account they may access the account to view more detailed information. Accordingly, a user may view the account name, address, products carried at the account, and competitor's products carried at the account. In this way, CRM process may allow a user to view the name, phone number, and email address of the account buyer, manager, owner, bartender, and distributor representative, which may have been entered by a member of the sales team during previous visits. CRM process 10 may also provide a view a list of past visits to the account, and review the visit to get more detailed information regarding the visit. CRM process 10 may also provide a view of notes left by sales people from previous visits.

CRM process 10 may further provide members of the sales team with an option to create account visits of their own. Some components of a sales call may include, but are not limited to, setting sales goals, surveying the account, and relaying important account information back to the distributor (e.g., action items). Surveying an account allows a user to set the serving size and price for some or all of the products sold at the account. Within the survey CRM process 10 may also allow a user to “classify” the account from a list of options, e.g. sports bar, pub, dive, etc. These classifications may give the sales people another way to filter accounts when they are back at the account list table view. Next, sales goals may be set for certain products. This may include both core products as well as any promotional items (e.g., beer, neon or wood signs, glassware, coasters, setting up a feature or promo, etc.). CRM process 10 may also allow a user to set goals for account maintenance such as checking draft lines, quality control, etc. Through the action item portal described herein, members of the sales team may communicate important account level information back to the distributor via the CRM system. This information could be anything from alerting the distributor that a product was sold in and needs to be delivered, to alerting the distributor that signage or promotional items were dropped off, or that an event or promo may occur at this account on a specific day. Any and all account information that requires the distributor's attention may be created in an action item, at the account level. Some or all of the action items, from all account visits may aggregate back to a distributor action item view, within the CRM. Each day this information may be reviewed by management, and upon receiving an indication from a user, an email may be sent to some or all of the applicable distributor representatives, containing all action items for the day.

In some embodiments, this process may be repeated for each daily account visit, for each account established in the sales person's daily route. Accordingly, CRM process 10 may provide management with visibility into not only what is going on at every account visit, but also with the ability to see what each of their employees are doing on a daily basis. As discussed herein, CRM process 10 may further include a time management portal, which may require a user to input which activities and how much time is associated with the activity, for a given day. There may be a back-end reporting system logging all data occurring on account visits, and through the time management portal, to give management dashboards showing exactly what has transpired for each sales person. Reporting may occur on a daily, weekly, monthly, or YTD basis.

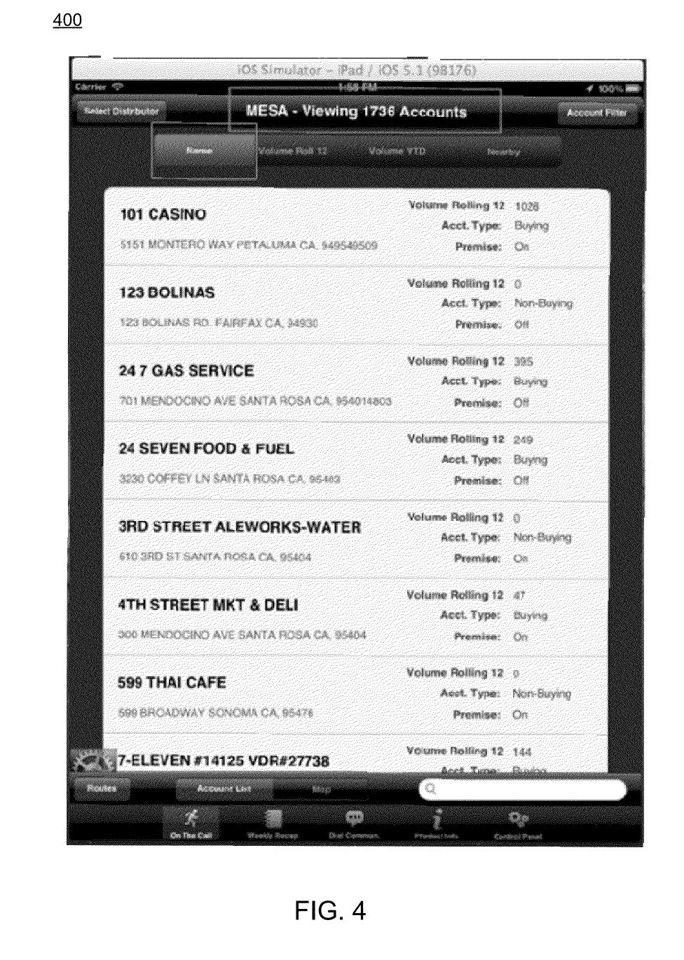

Referring now to FIG. 4, an embodiment depicting interface 400 generated in accordance with CRM process 10 is depicted. Interface 400 depicts an account list associated with a particular distributor. For example, the embodiment shown in interface 400 includes a list of all 1736 accounts that Mesa Beverage sells to, shown in a tabular format. The list may be ordered by account name, and may display the account level volume, shows whether the account is buying/non-buying (e.g., sells products), and whether the account is on or off premise (e.g., the product is consumed at the account or away).

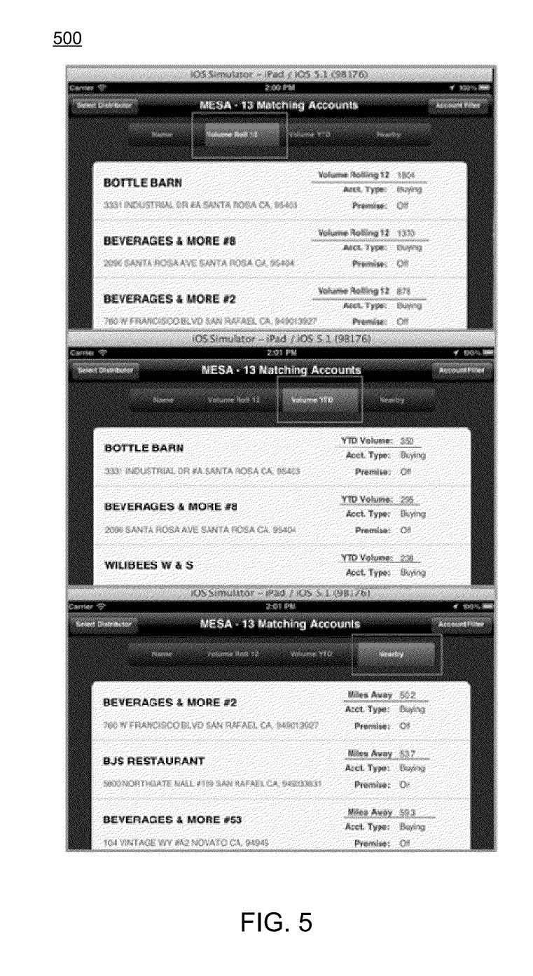

Referring now to FIG. 5, an embodiment depicting interface 500 generated in accordance with CRM process 10 is depicted. Interface 500 may include an account list, which may be ordered by a sold account level volume (e.g., on a rolling 12 month basis, or YTD). The account list may also be ordered by the user's current proximity to the accounts, etc.

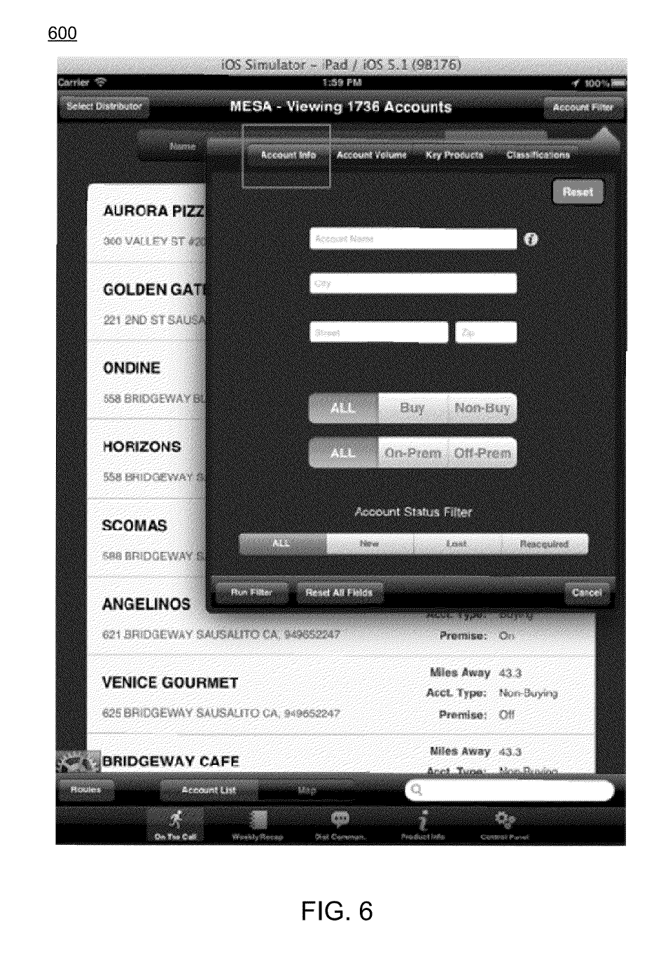

Referring now to FIG. 6, an embodiment depicting interface 600 generated in accordance with CRM process 10 is depicted. In some embodiments, CRM process 10 may be configured to filter the account list using any suitable format. Some filtering techniques may include, but are not limited to, filtering the account list by one or more of an Account Name, City, Street, Zip Code, filtering the account list by Buying/Non-Buying accounts, and On/Off Premise accounts, filtering the account list by first time buying accounts (new), accounts that have transitioned from buying to non-buying (lost), accounts that are transitioning from non-buying to buying again (reacquired), etc.

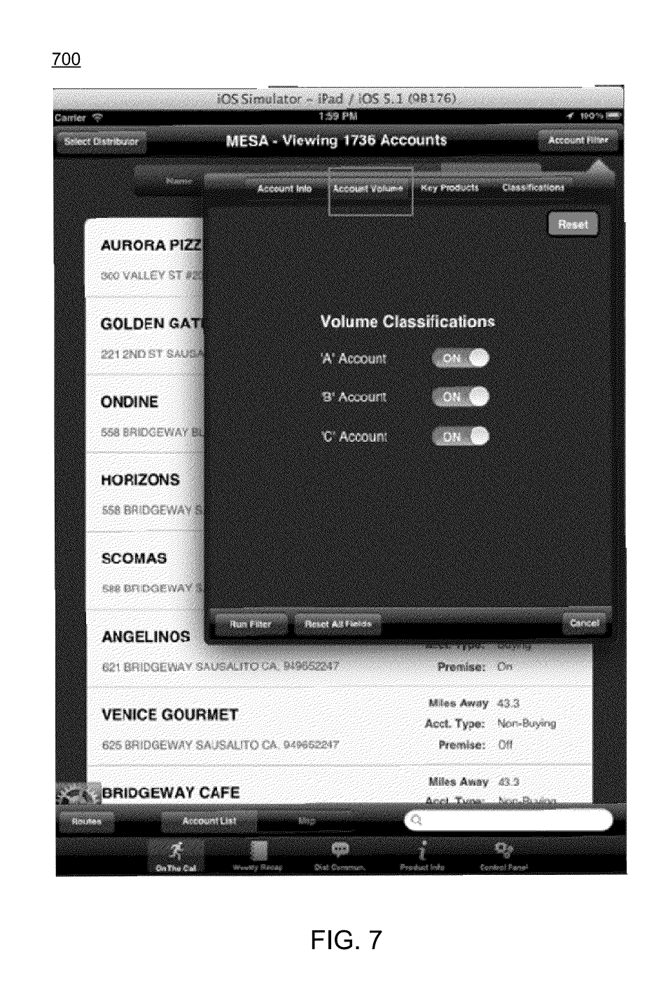

Referring now to FIG. 7, an embodiment depicting interface 700 generated in accordance with CRM process 10 is depicted. CRM process may be configured to filter the account list in accordance with an account type. For example, and as shown in FIG. 7, by A, B, or C Accounts, where each account type may pertain to the volume of products sold within the account. In this example, an A account may correspond to the top 20% of distributor accounts, a B account may correspond to the next 30% of distributor accounts, and a C account may correspond to the remaining distributor accounts.

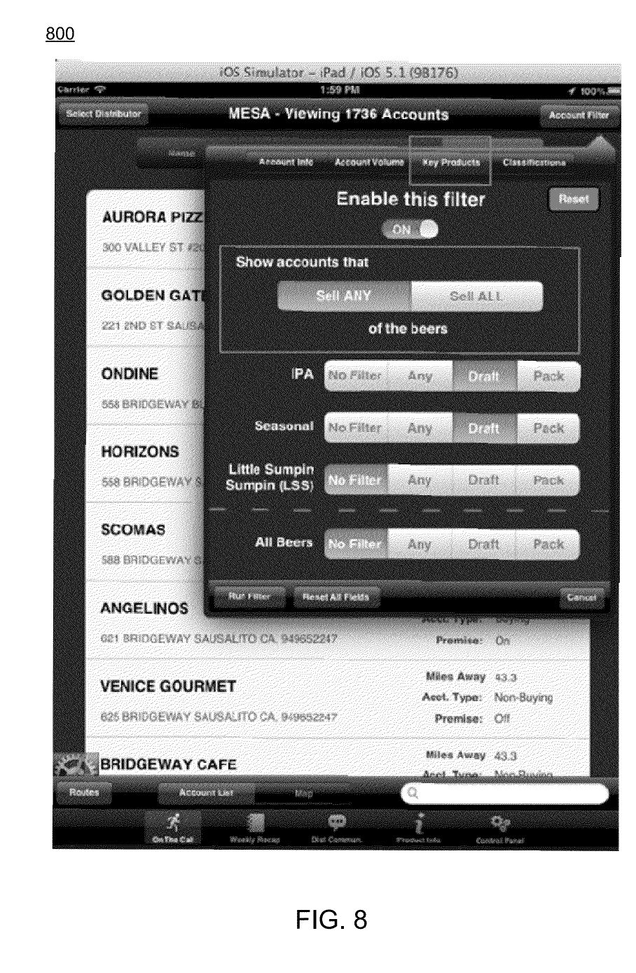

Referring now to FIG. 8, an embodiment depicting interface 800 generated in accordance with CRM process 10 is depicted. CRM process 10 may be configured to filter the account list by key products that are sold in the account. In some embodiments, CRM process 10 may provide an option to select whether an account needs to contain ALL product selections, or ANY product selections. For example, the selection shown to the left of interface 800 may return the account list where either IPA draft, or Seasonal draft is sold.

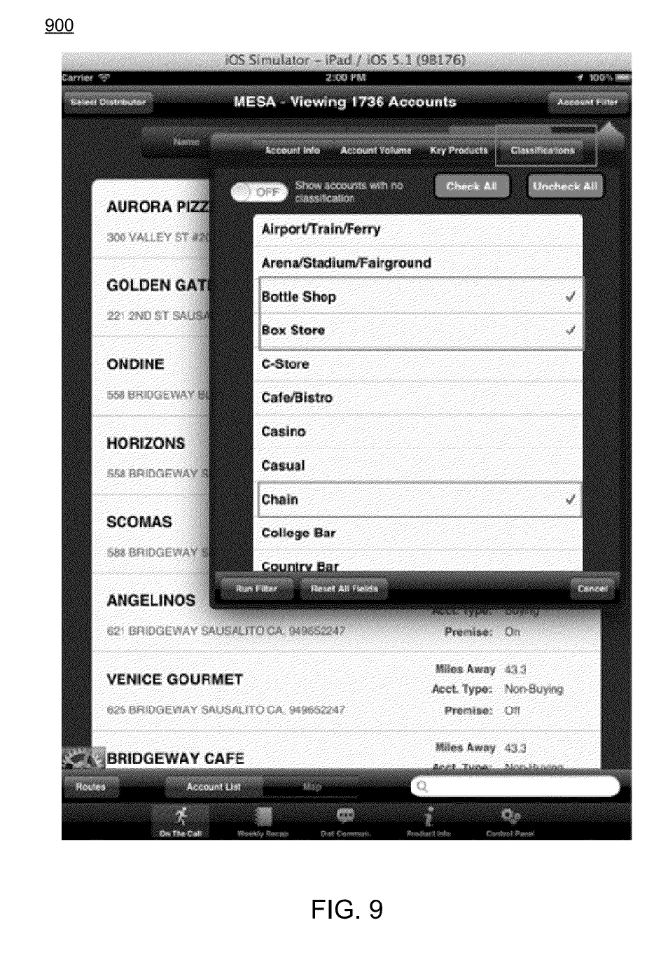

Referring now to FIG. 9, an embodiment depicting interface 900 generated in accordance with CRM process 10 is depicted. CRM process 10 may be configured to filter the account list by the account classification. This may be set using any suitable technique, for example, in some embodiments a user (e.g. a member of the sales force) may set during account surveys. The adjacent screen may filter the account list to only show accounts classified as Bottle Shops, Box Stores, Chains, etc.

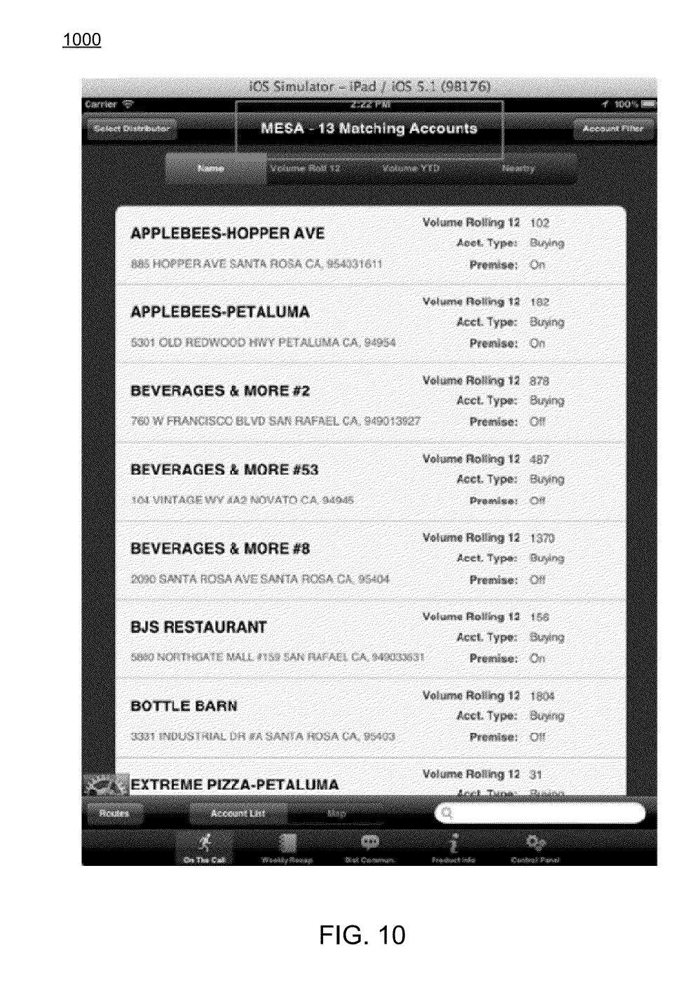

Referring now to FIG. 10, an embodiment depicting interface 1000 generated in accordance with CRM process 10 is depicted. In this embodiment, the account list now displays the filtered accounts for Mesa Beverage, based on all filter criteria previously entered. In this particular example, this list of 13 accounts represents all accounts in Mesa's region, which are buying IPA or Seasonal draft, and are a Bottle Shop, Box Store, or Chain account. This list may be ordered using any suitable approach. For example, the list may be ordered by Name, but may also be ordered by Volume (e.g., rolling 12 month, or YTD), or by proximity to the users current location, as shown above.

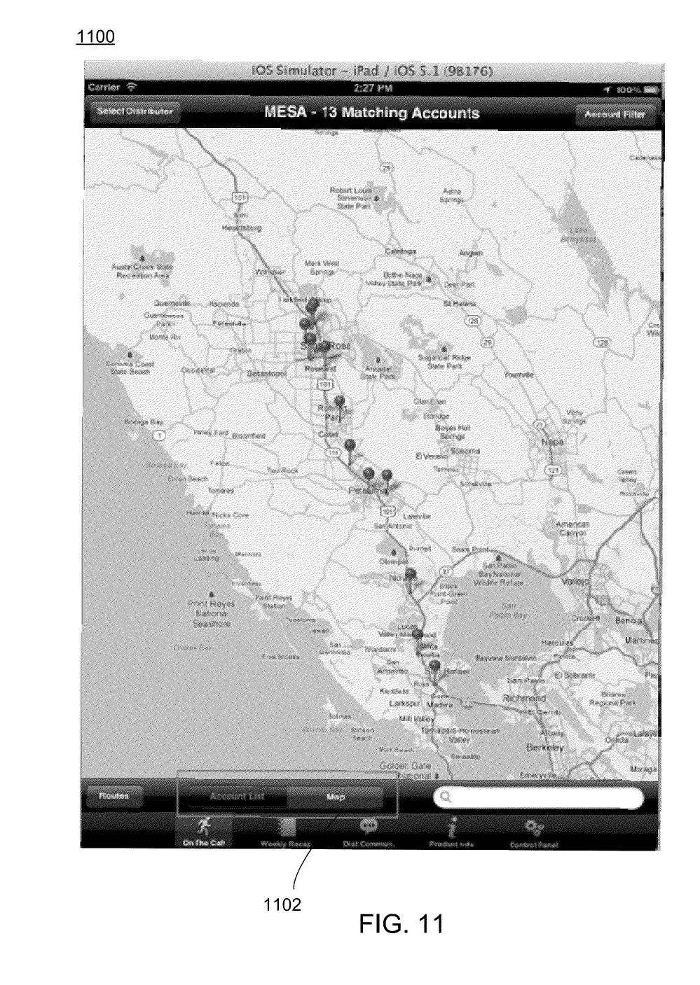

Referring now to FIG. 11, an embodiment depicting interface 1100 generated in accordance with CRM process 10 is depicted. Interface 1100 depicts a filtered account list, in map view. In some embodiments, all account lists may be converted to map view upon selection of map button 1102. For example, green pins may represent buying accounts, and red pins may represent non-buying accounts.

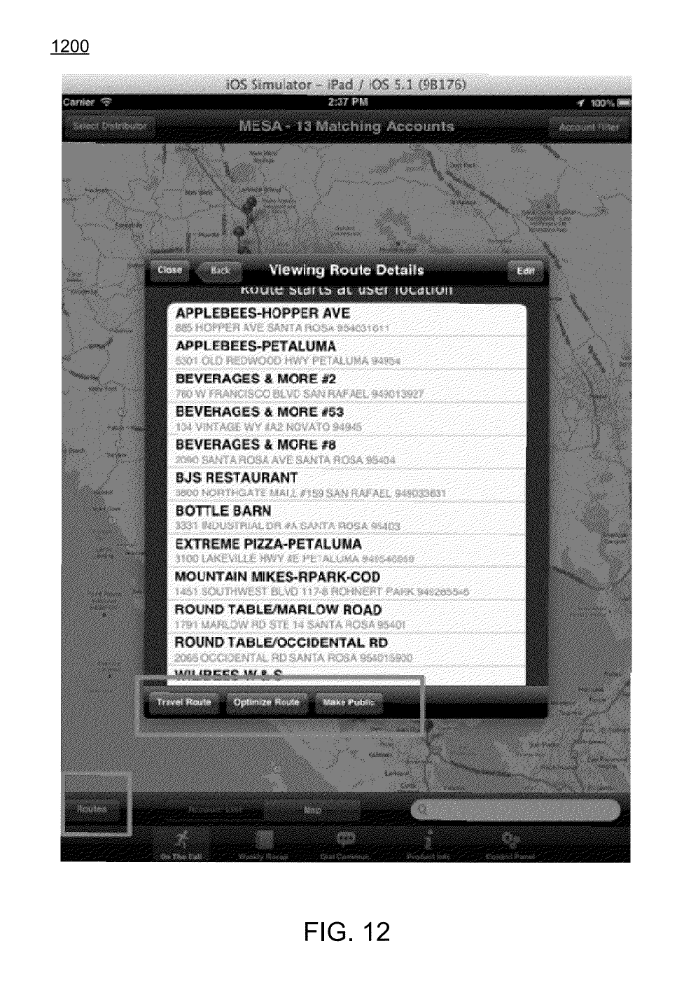

Referring now to FIG. 12, an embodiment depicting interface 1200 generated in accordance with CRM process 10 is depicted. Accordingly, CRM process 10 may generate one or more routes, which may allow members of the sales force to receive step-by-step directions to each account within the route. In some embodiments, the order of accounts in the route may be manually adjusted. Additionally and/or alternatively, the user may choose to “optimize” the existing route. The optimization may re-order the list to achieve the shortest path from the first account in the route, to the last. In some embodiments, routes may be kept private for just the user who created it, or made public by management, and set for specific sales people to traverse.

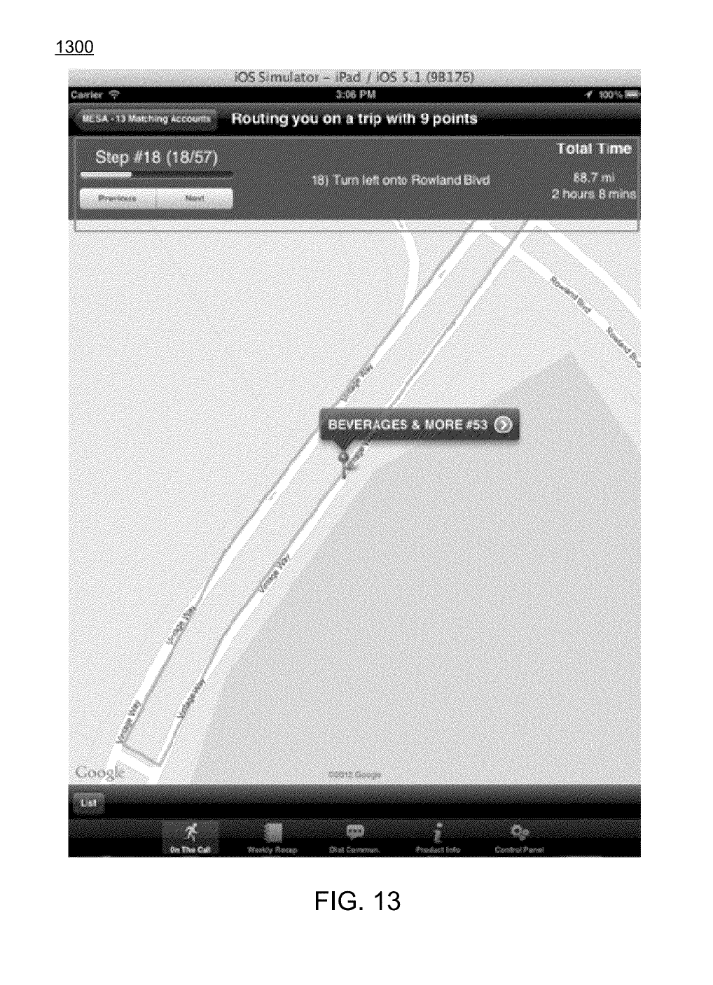

Referring now to FIG. 13, an embodiment depicting interface 1300 generated in accordance with CRM process 10 is depicted. In some embodiments, when traveling a route, a user may tap the “Previous” or “Next” buttons to move to the previous or next instruction. CRM process 10 may be configured to provide the total route time (drive), along with the total miles for the route. For example, when a user arrives at an account, a flag appears for the account, and can be tapped to begin an account visit. It is not necessary to be traversing a route to begin an account visit. A visit may be started at any time while in list view or map view by selecting the appropriate table cell, or map pin.

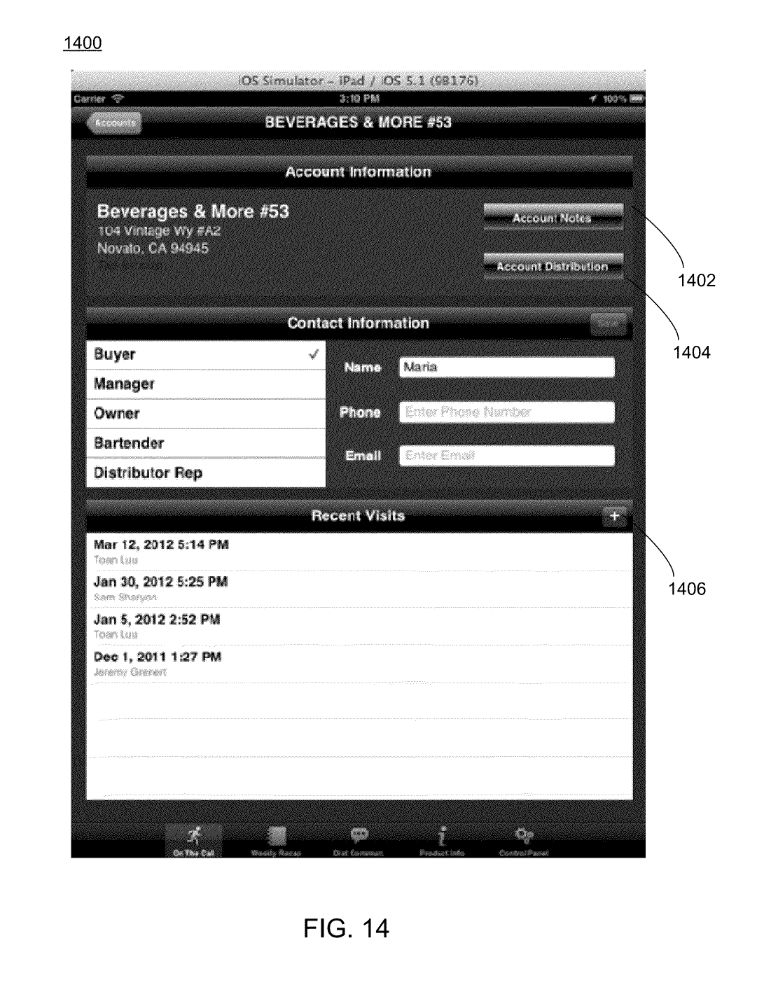

Referring now to FIG. 14, an embodiment depicting interface 1400 generated in accordance with CRM process 10 is depicted. CRM process 10 may be configured to receive a selection from a user (e.g. Selecting “Account Notes” button 1402) and may provide notes regarding the account, from previous visits. Additionally and/or alternatively, CRM process 10 may be configured to receive a selection from a user (e.g., Selecting “Account Distribution” button 1404), which may bring up a list of all products sold at the account. In some embodiments, the sales force may enter contact information individually for the buyer, manager, owner, bartender, or distributor for the account. All previous account visits may be listed under the “Recent Visits” view. A user may access any past visit to view what occurred on that visit, or tap the ‘+’ button 1406 to create a new visit.

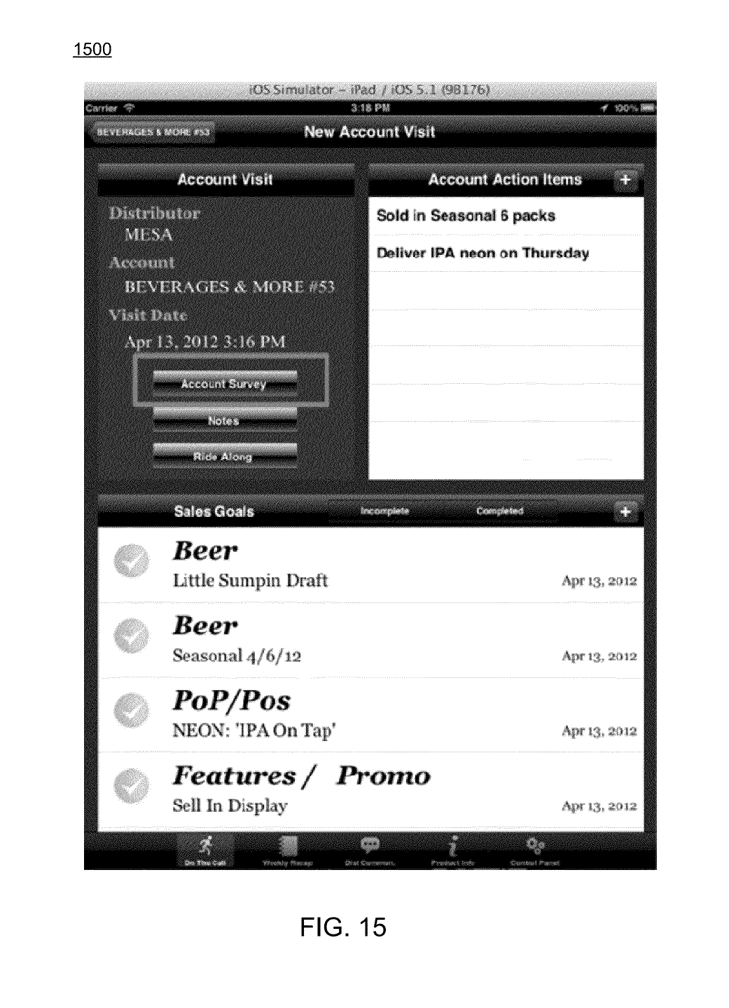

Referring now to FIG. 15, an embodiment depicting interface 1500 generated in accordance with CRM process 10 is depicted. In some embodiments, account action items may be created in order to easily communicate account visit actions to the distributor. Some or all of the action items from each account visit may aggregate to the distributor portal. With the selection of a button, all Action Items may be emailed to the distributor. Selecting the “Account Survey” button may allow a user to survey the account as well as competitors distribution. Sales goals for selling in Beer, POP/POS, Features/Promos, and Account Maintenance may be set from this view.

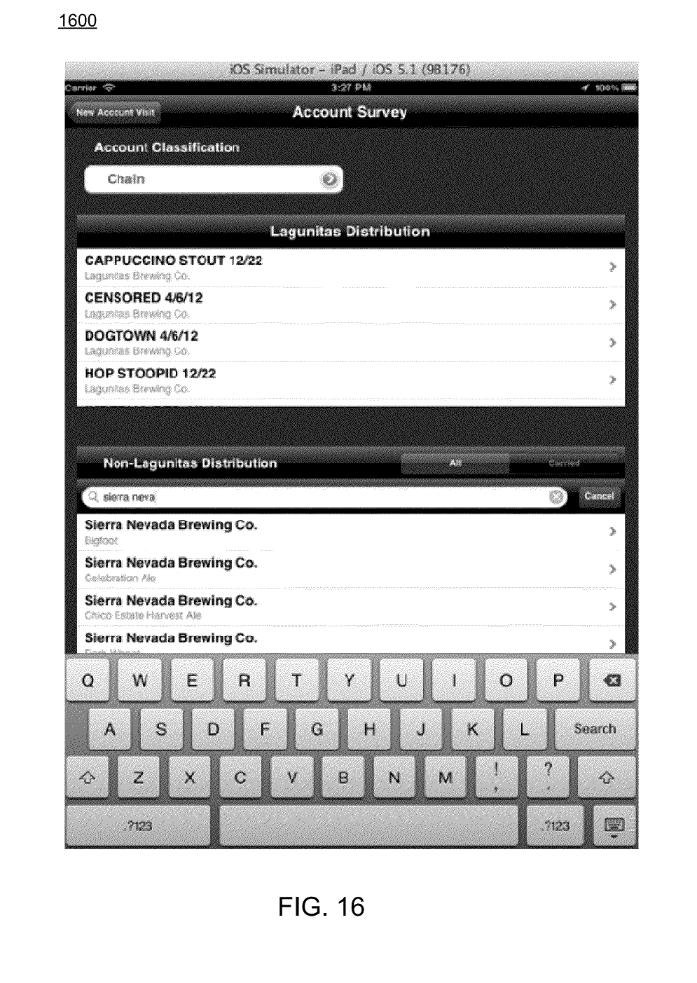

Referring now to FIG. 16, an embodiment depicting interface 1600 generated in accordance with CRM process 10 is depicted. In some embodiments, completing a survey for an account enables the user to classify the account, and set pricing and serving sizes for both a company's products, and competitors products. A company's current products for the account are listed and ready to be surveyed. Accordingly, the user may easily and quickly search through a large, and ever-growing list of competitors products to survey.

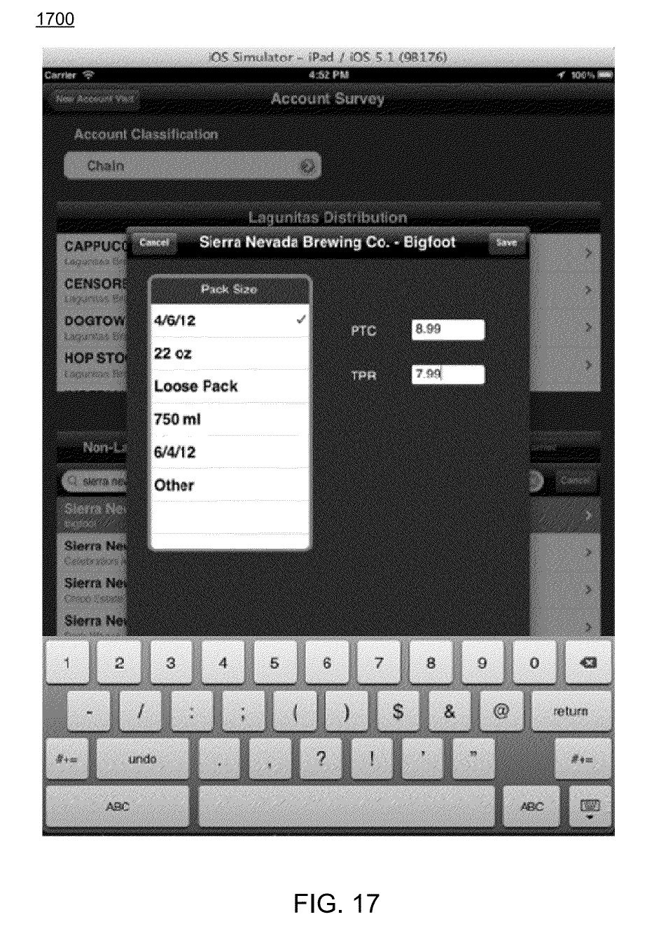

Referring now to FIG. 17, an embodiment depicting interface 1700 generated in accordance with CRM process 10 is depicted. When setting pricing for bottled products the user chooses the bottle size, and sets the Price To Consumer, and the Temporary Price Reduction price. For products on draught the user may set the serving glass size (e.g., 12 oz, 16 oz, 20 oz, etc.), as well as the keg size (e.g., 15.5 gall, 7.75 gall, etc.), as well as the Price Per Serving, and the Feature Price (e.g., happy hour).

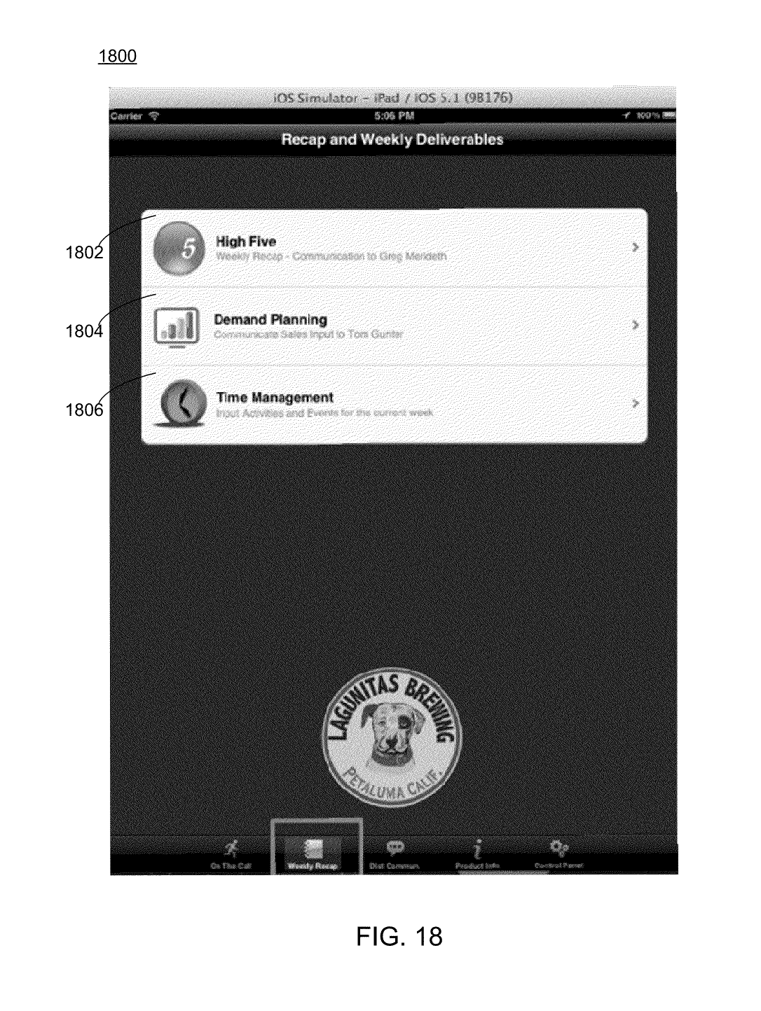

Referring now to FIG. 18, an embodiment depicting interface 1800 generated in accordance with CRM process 10 is depicted. CRM process 10 may include a “Weekly Recap” tab, which may allow one or more members of the sales team to communicate daily progress towards key responsibilities, using a “High Five” portal 1802. In some embodiments, users may communicate sales information to a demand planning department regarding large events or new placements, which were unknown during our planning period, but have the potential to affect production. This may be achieved via demand planning portal 1804. Users may track their daily time, for each activity performed, via time management portal 1806.

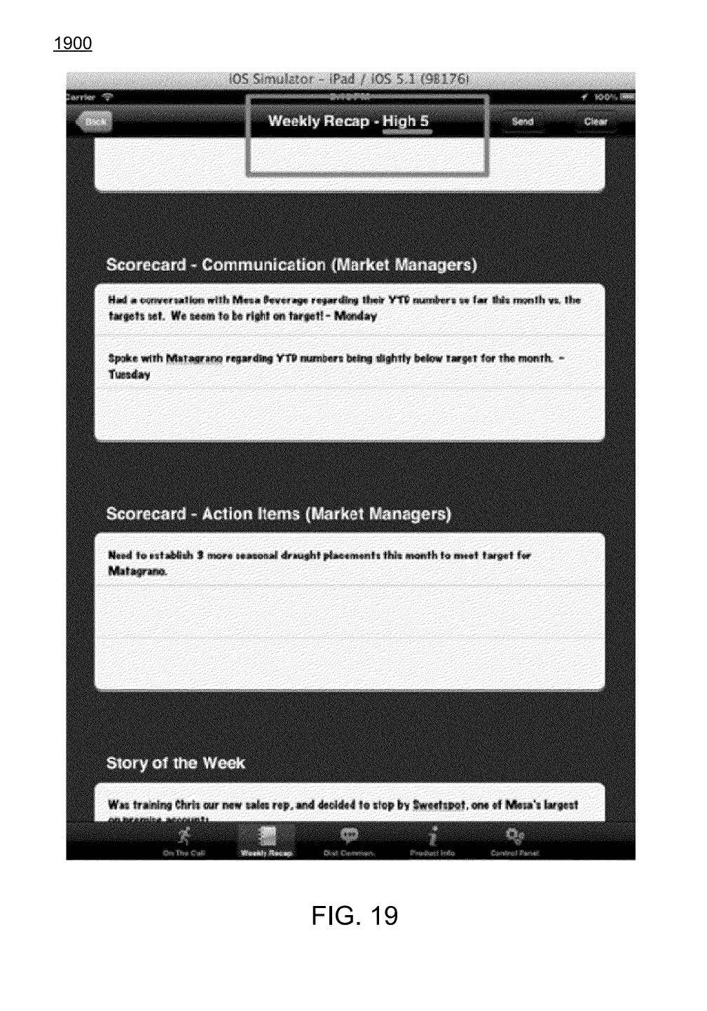

Referring now to FIG. 19, an embodiment depicting interface 1900 generated in accordance with CRM process 10 is depicted. In some embodiments, through the High 5 portal shown in interface 1900, members of the sales team may communicate information to sales management regarding key areas/responsibilities which need to be addressed each week. At the end of the week the information may be automatically sent to management and the form may be reset.

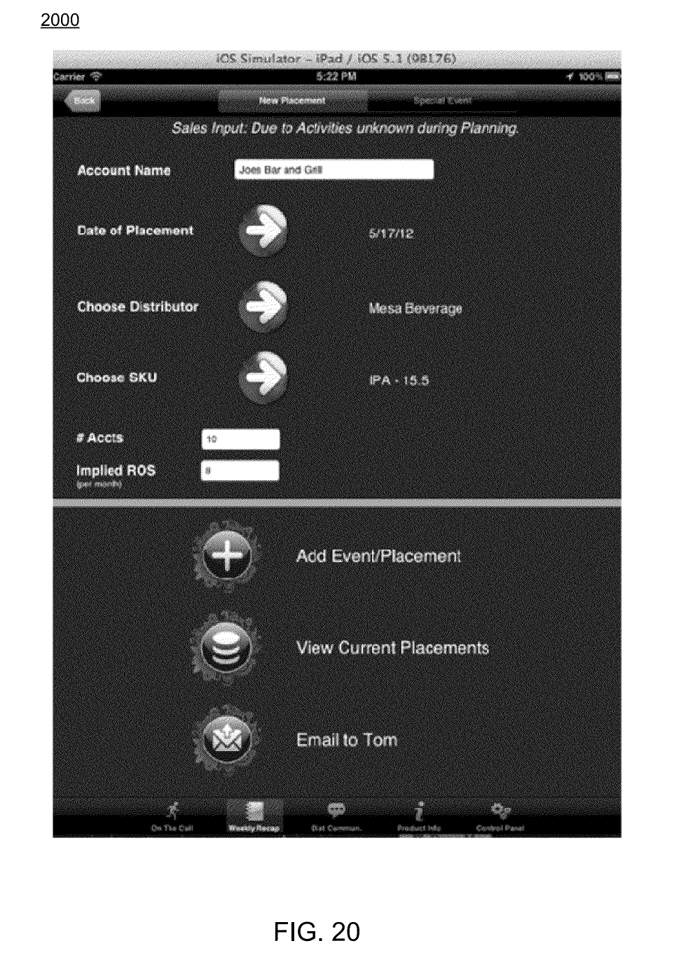

Referring now to FIG. 20, an embodiment depicting interface 2000 generated in accordance with CRM process 10 is depicted. In some embodiments, CRM process 10 may generate a demand planning portal. The demand planning portal may be used by one or more members of the sales team to communicate sales input, which was unknown during preliminary planning stages, to a demand planning department (i.e., forecasting). This portal may be reserved for communication with the potential to affect production/planning at the brewery. In this particular example, a new on premise placement has come in, with 10 accounts within the distributor's region, wanting to put on IPA draught with a projected ROS of 8 units/month. In some embodiments, this portal may be used to communicate any number of SKU's per new account, for any number of new accounts. Some or all information may be automatically generated into a pre-populated email which may be sent from a user's computing device.

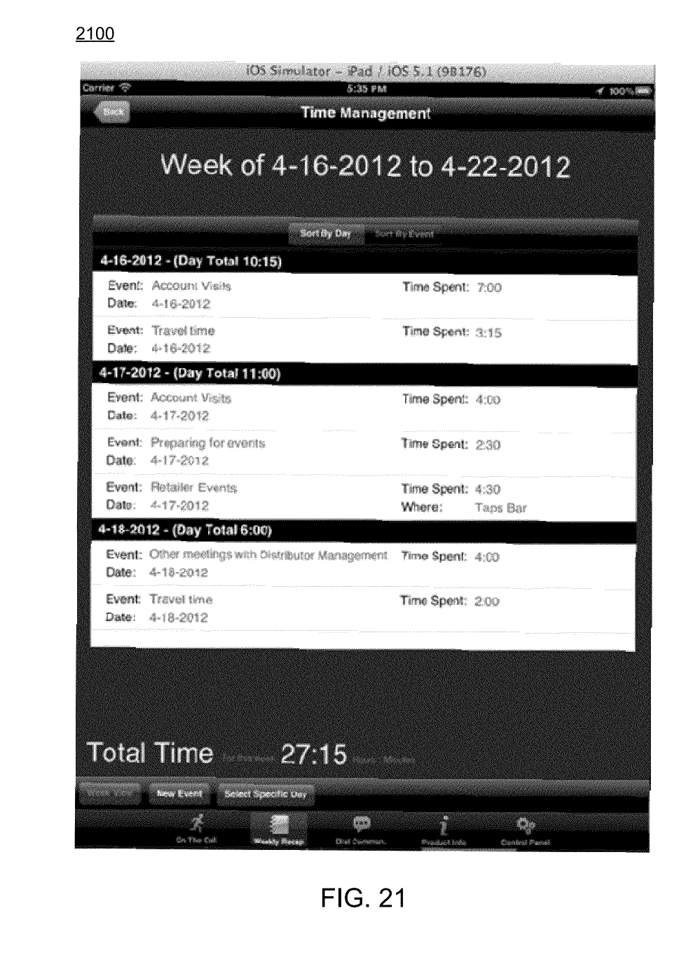

Referring now to FIG. 21, an embodiment depicting interface 2100 generated in accordance with CRM process 10 is depicted. Through a time management portal, each user may be able to keep track of their daily activities, and the corresponding lengths of time for each. For example, for each day of the week each user may choose from a number of different activities, and set an amount of time for each. The daily time aggregates may be shown by day, as well as an up-to-date total of hours worked that week.

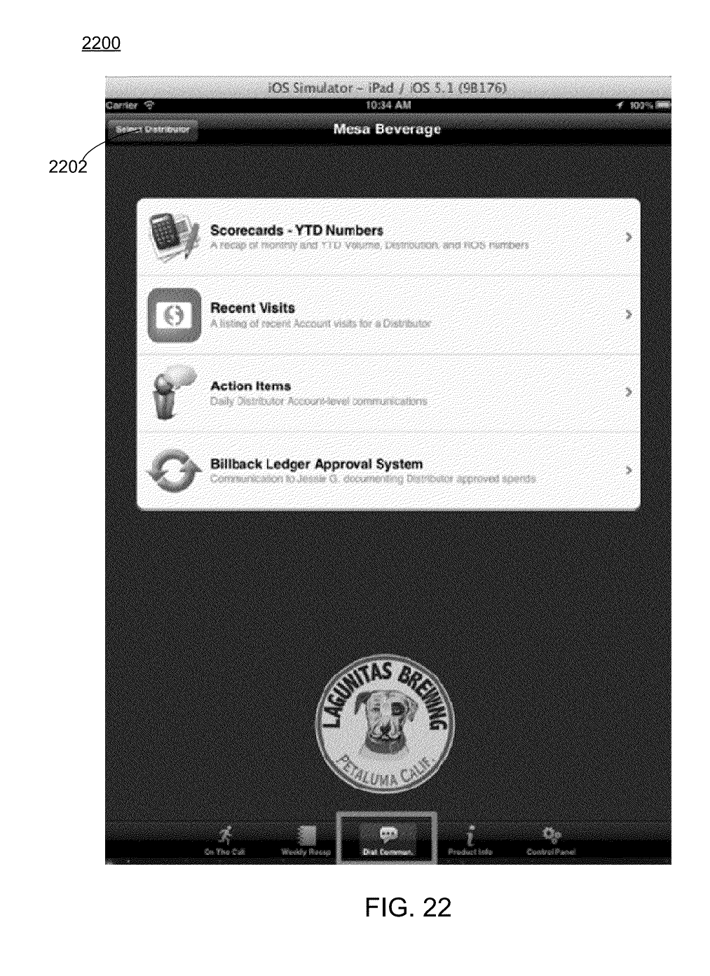

Referring now to FIG. 22, an embodiment depicting interface 2200 generated in accordance with CRM process 10 is depicted. In some embodiments, CRM process 10 may include a distributor communication feature 2202, which may allow one or more members of the sales team to view distributor scorecards, view a list of all recent visits to that distributor's accounts, view a list of all action items created during account visits, communicate approve distributor spends back to our accounting department, etc. In some embodiments, selecting the “Select Distributor” button may allow the user to report on a different distributor.

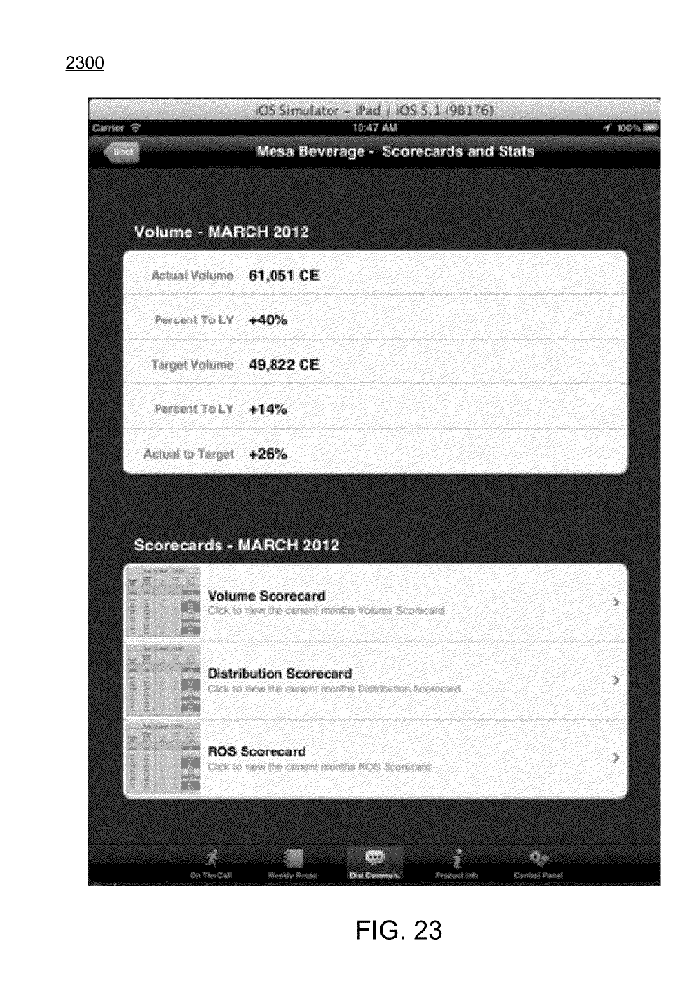

Referring now to FIG. 23, an embodiment depicting interface 2300 generated in accordance with CRM process 10 is depicted. CRM process 10 may generate a scorecard portal, which may be configured to allow users to view YTD volume, distribution, and ROS data pertaining to the Distributor. In some embodiments, the scorecard portal may also be configured to provide aggregate YTD volume data. In operation, a user may select one or more of the volume, distribution, and/or ROS buttons to bring up complete scorecards that may measure targets set by a company and the Distributor staff, with actual achievements. Scorecards may look at the numbers as a whole, individual SKU's, as well as aggregate numbers by pack size. (e.g., all cases, all kegs, etc.).

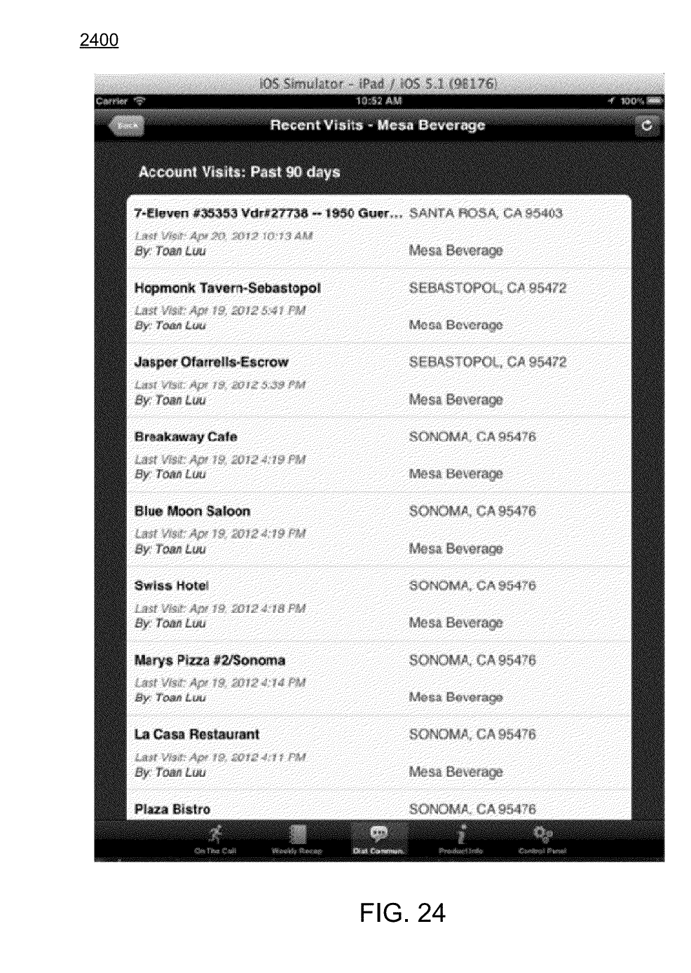

Referring now to FIG. 24, an embodiment depicting interface 2400 generated in accordance with CRM process 10 is depicted. CRM process 10 may generate a recent visits portal, which may allow one or more members of the sales team to view a list of recent account visits pertaining to this distributor. CRM process may allow a user to select one of the visits, which may show some or all activities that occurred during that visit. (e.g., sales goals, action items, etc.).

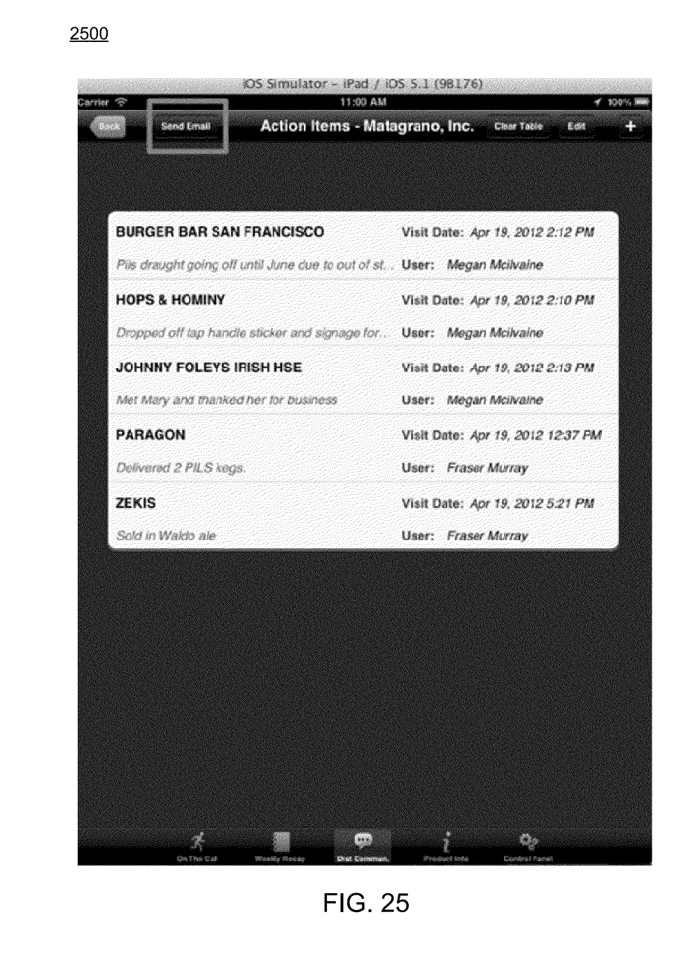

Referring now to FIG. 25, an embodiment depicting interface 2500 generated in accordance with CRM process 10 is depicted. CRM process 10 may generate an action items portal, which may be configured to show a list of all action items created during the days account visits. This list may provide a display of all action items created by all sales people making calls on this particular distributor's accounts. From this view, selecting the send email button may generate an email to the distributor displaying the information needing to be communicated.

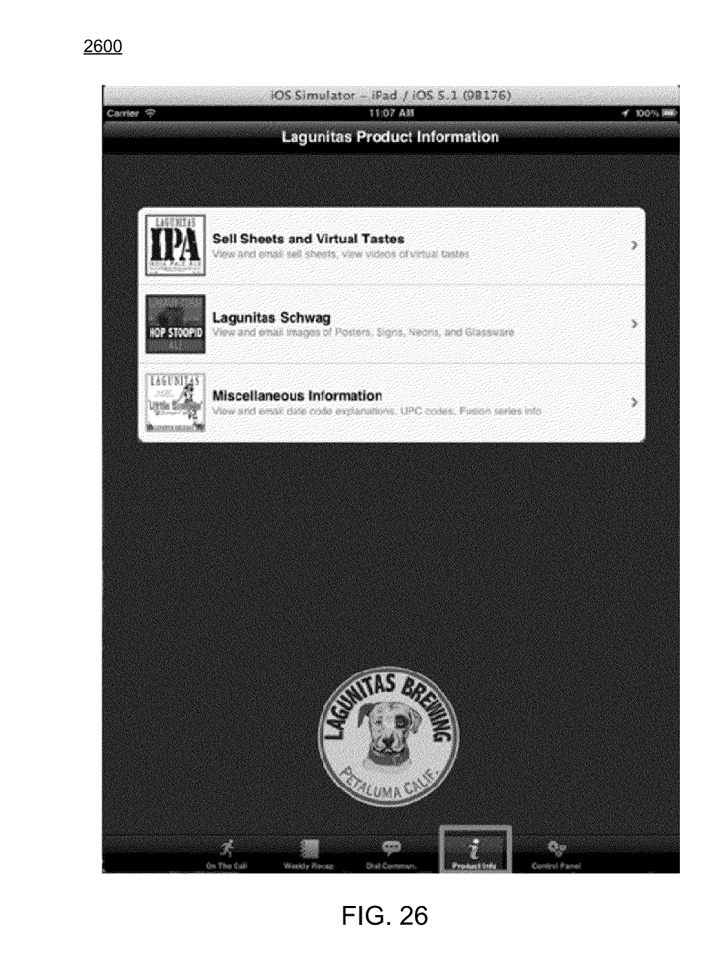

Referring now to FIG. 26, an embodiment depicting interface 2600 generated in accordance with CRM process 10 is depicted. CRM process 10 may include a product information feature, which may be configured to allow one or more members of the sales team to communicate product information to the account buyers, distributors, and/or consumers.

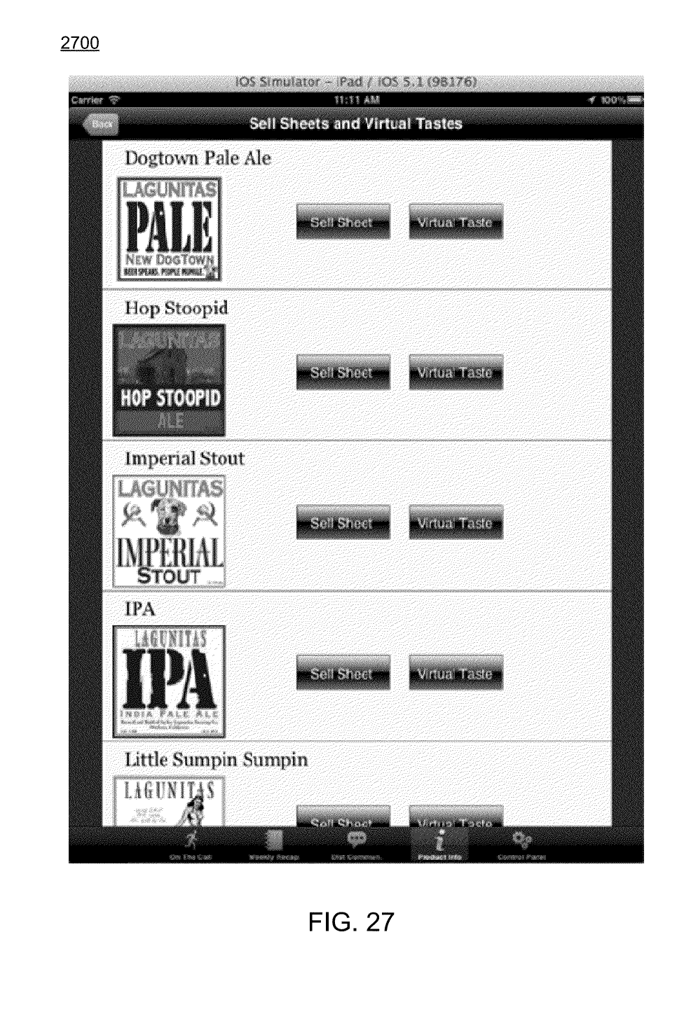

Referring now to FIG. 27, an embodiment depicting interface 2700 generated in accordance with CRM process 10 is depicted. CRM process 10 may generate a sell sheet and virtual taste display. In some embodiments, from the sell sheet and virtual taste view, one or more users may select the “Sell Sheet” button to view a detailed visual description of the product. This “sell sheet” may also be emailed to a buyer at an account, upon selection of a button or other suitable method. Upon receiving a selection of the “Virtual Taste” button, CRM process may generate and display an audio and/or video presentation (e.g., a video of a brewer delivering a virtual tasting of the product).

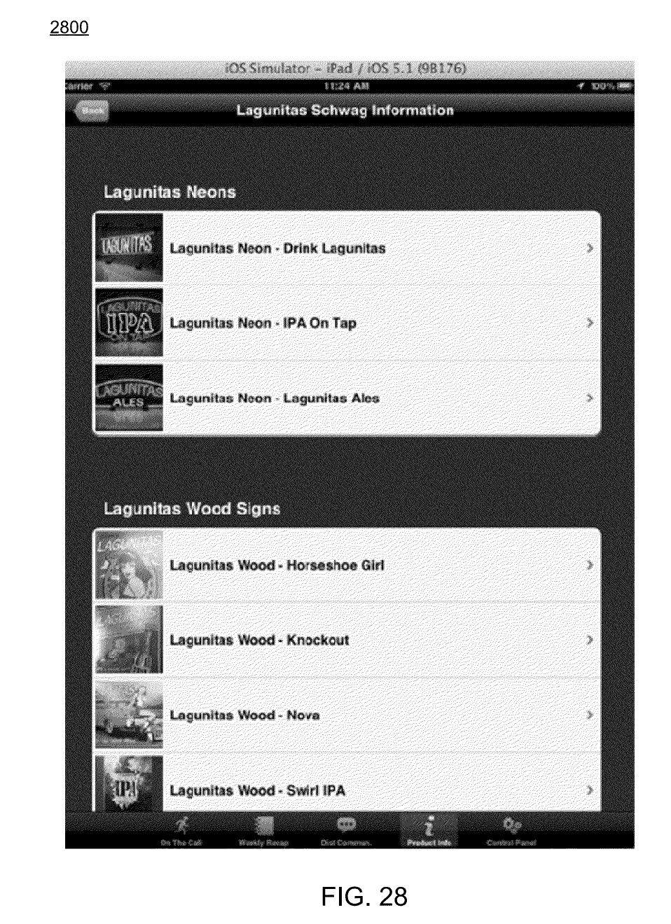

Referring now to FIG. 28, an embodiment depicting interface 2800 generated in accordance with CRM process 10 is depicted. CRM process 10 may be configured to provide a promotional items display. The promotional items display may assist a user in selling various promotional items (e.g., neons, wood signs, and glassware, etc.) into an account. Upon receiving a selection from a user (e.g. an image, etc), CRM process may be configured to present a large view of the item, as well as to allow that image to be emailed to account management.

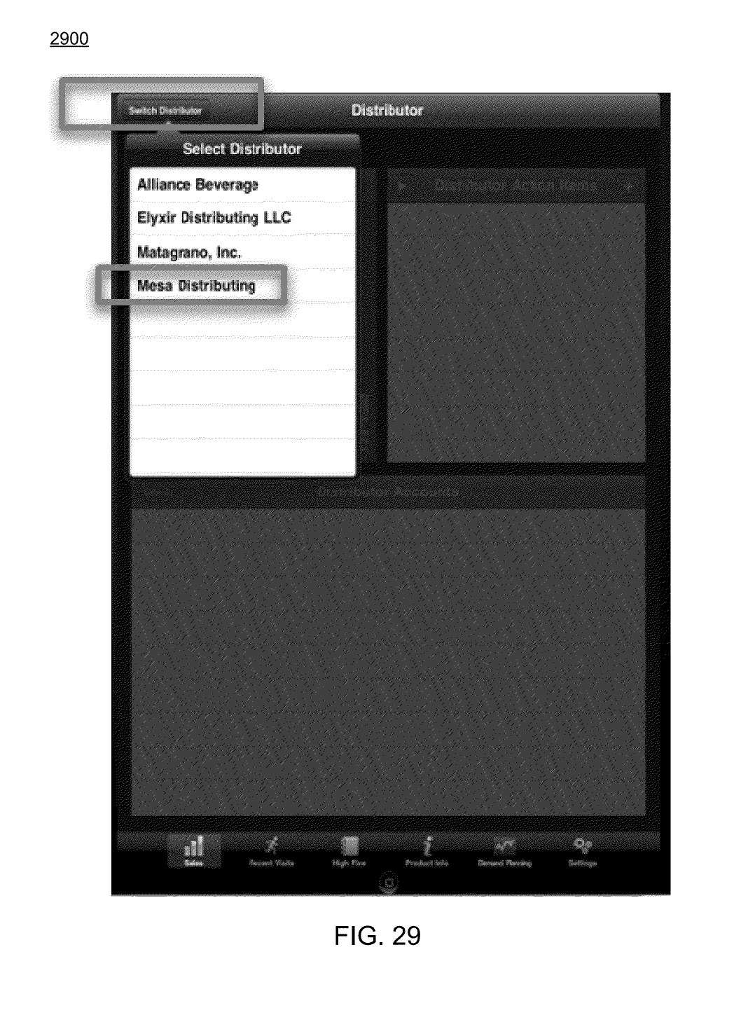

Referring now to FIG. 29, an embodiment depicting interface 2900 generated in accordance with CRM process 10 is depicted. CRM process 10 may be configured to generate a distributor specific home page. Accordingly, CRM process 10 may allow for a user to select the particular distributor account base of interest.

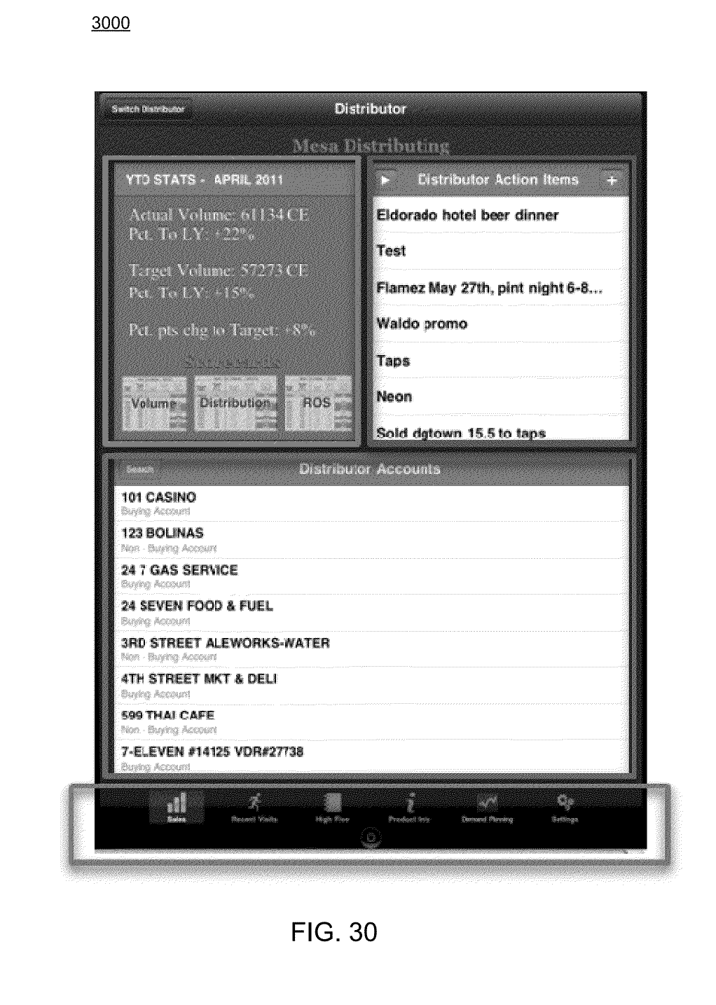

Referring now to FIG. 30, an embodiment depicting interface 3000 generated in accordance with CRM process 10 is depicted. CRM process 10 may be configured to generate and/or provide specific information pertaining to the distributor. Accordingly, CRM process 10 may generate one or more data portions. Some data portions may include, but are not limited to, a YTD STATS, Scorecards, YTD Volume, Target Volume, Distributor Accounts, Buying/Non Buying Accounts, On and Off-Premise, Account Search Tab, Distributor Action Items, Daily Communications to Distributor, Tab Section, Sales (current view), Recent Visits, High Five, Product Info, Demand Planning, Settings, etc.

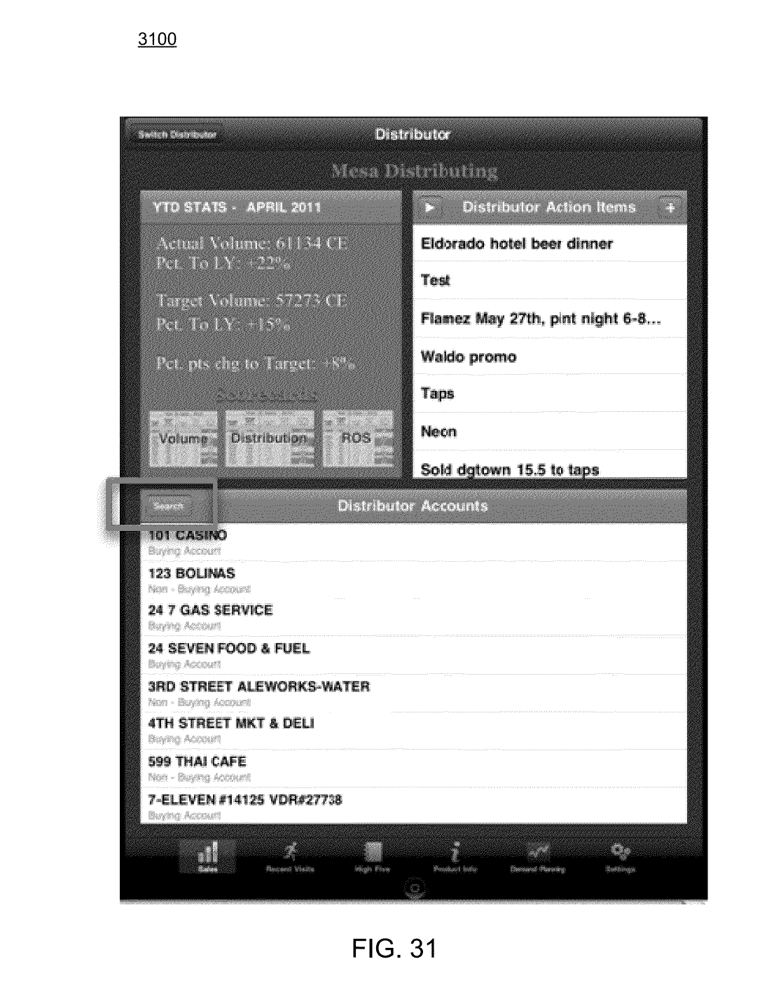

Referring now to FIG. 31, an embodiment depicting interface 3100 generated in accordance with CRM process 10 is depicted. CRM process 10 may be configured to allow a user to search for the account (e.g. by selecting the search tab prior to making a sales call).

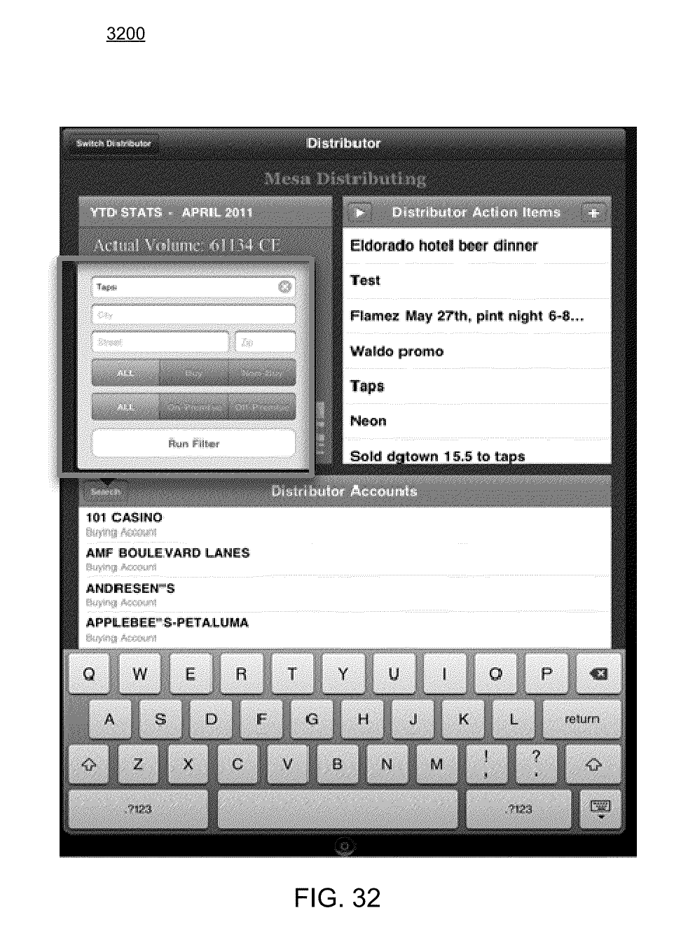

Referring now to FIG. 32, an embodiment depicting interface 3200 generated in accordance with CRM process 10 is depicted. CRM process 10 may be configured to provide various options by which the user may search for a particular account. For example, and as shown in FIG. 32, CRM process 10 may allow a user to Enter Search Options, including but not limited to, Account Name, City, Street, Zip Code, Buy/Non-Buy, On/Off Premise, etc.

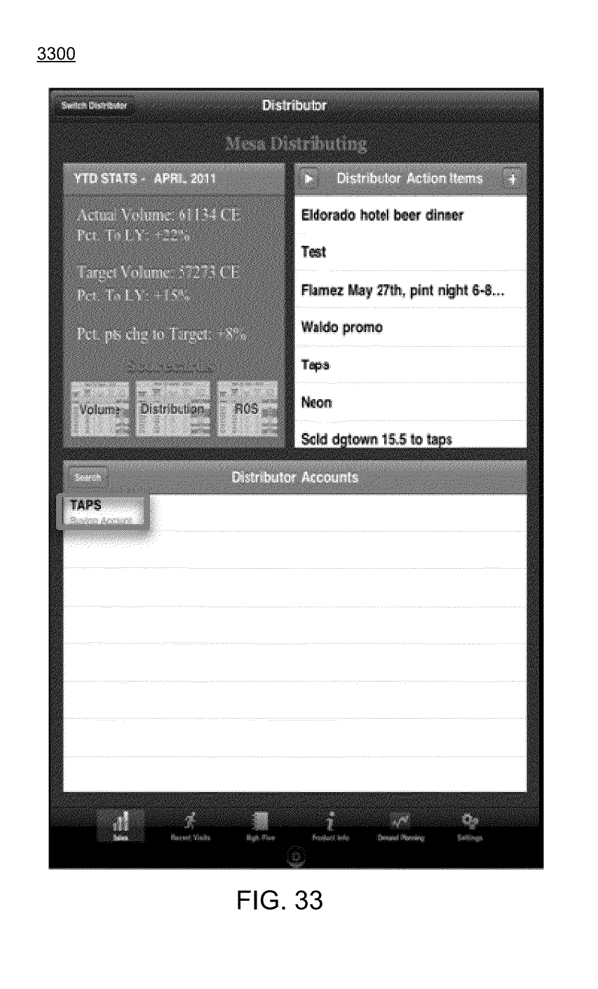

Referring now to FIG. 33, an embodiment depicting interface 3300 generated in accordance with CRM process 10 is depicted. CRM process 10 may be configured to allow a user to open an Account Page and provide a Taps option. Upon selection of the Taps option an additional interface may be generated (e.g., interface 3400).

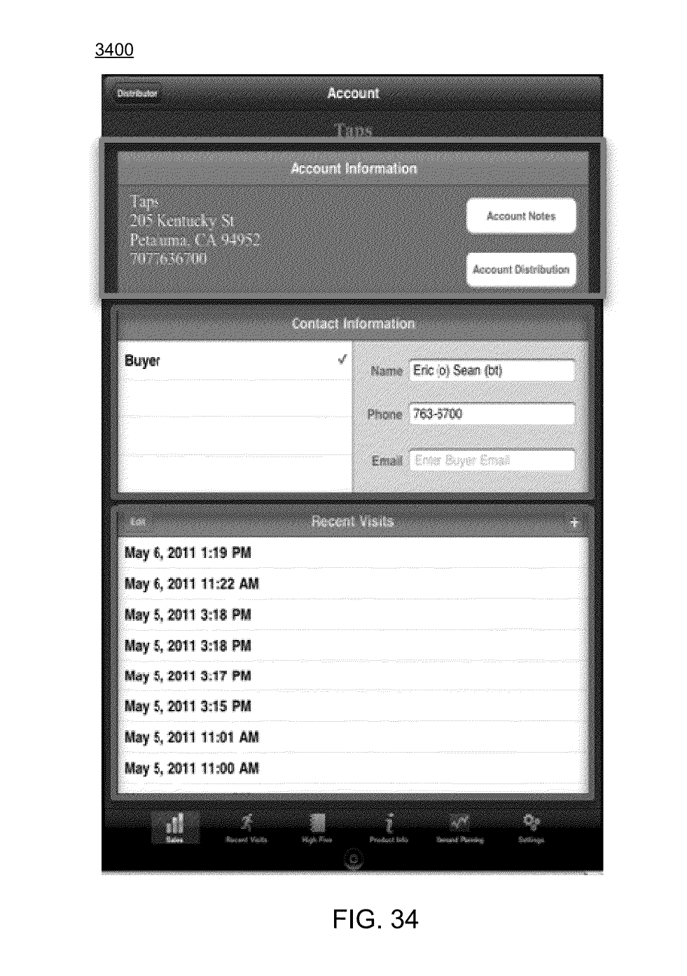

Referring now to FIG. 34, an embodiment depicting interface 3400 generated in accordance with CRM process 10 is depicted. CRM process 10 may be configured to generate an account home page. In some embodiments, the account home page may include Account Information (e.g., Name, address and phone), Account Notes, Account Distribution, Contact Information, Buyer, Manager, Owner information, Recent Visits, recent visit activity, etc.

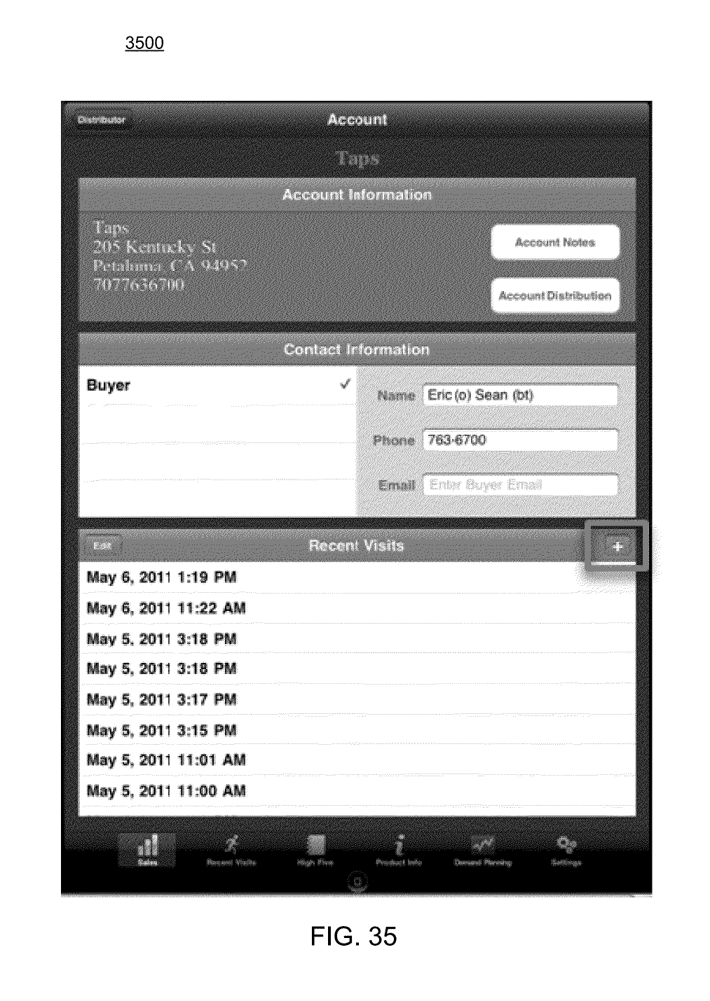

Referring now to FIG. 35, an embodiment depicting interface 3500 generated in accordance with CRM process 10 is depicted. CRM process 10 may be configured to allow a user to generate an account. For example, a user may select the “+” icon to begin the process.

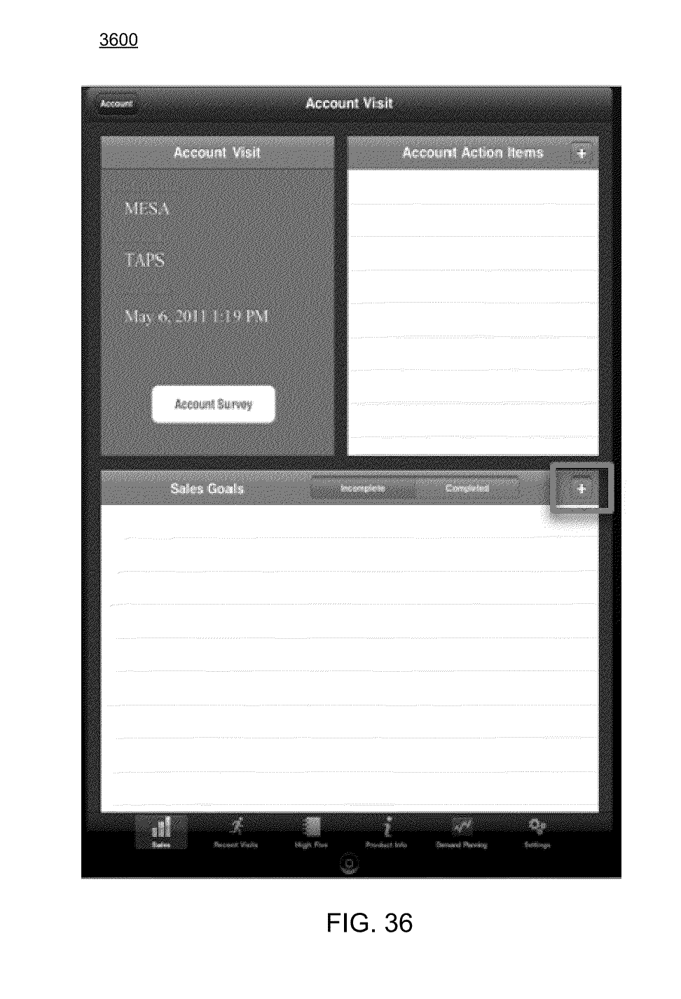

Referring now to FIG. 36, an embodiment depicting interface 3600 generated in accordance with CRM process 10 is depicted. CRM process 10 may be configured to generate an account visit page. Account visit page may include an option to create and/or edit a sales goal.

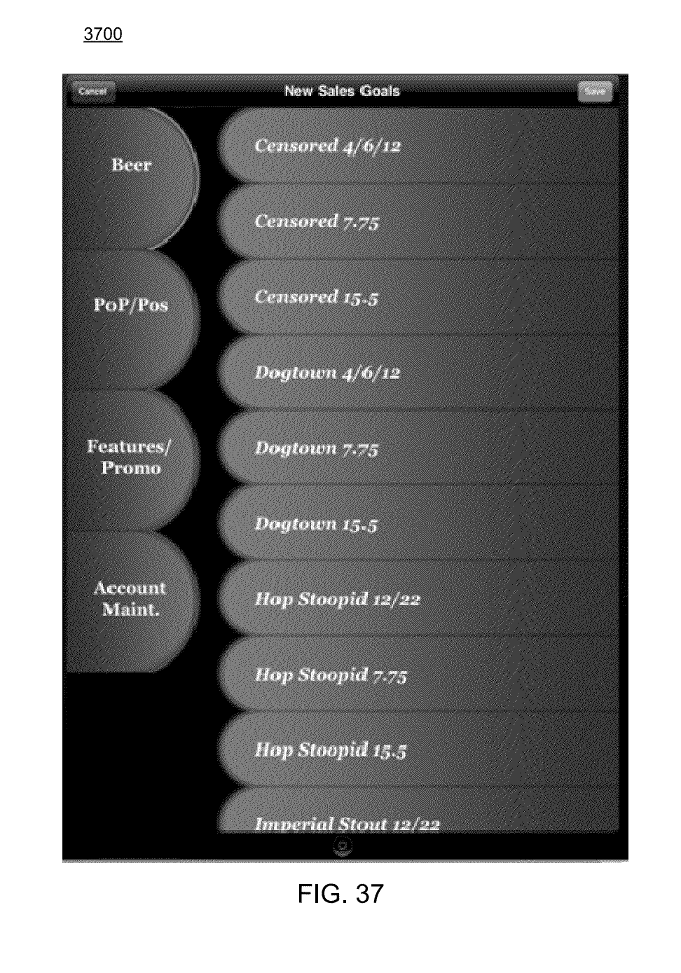

Referring now to FIG. 37, an embodiment depicting interface 3700 generated in accordance with CRM process 10 is depicted. CRM process 10 may be configured to generate a New Sales Goals Home Page. For example, a Beer Objective may be selected (e.g., What Brand and Pack Size?). Additionally and/or alternatively, a Pop/PoS Objective may be selected (e.g., Mason Jars, Neons/Signage, etc.). In some embodiments, a Features/Promos option may be selected (e.g., Lagunitas Night/Beer Dinner, Off-Premise TPR/Display, etc.). In some embodiments, an Account Maintenance option may be provided (e.g., Survey, Improved Position, Staff Training, Meet and Greet (Non-Buy/New Acct), etc.).

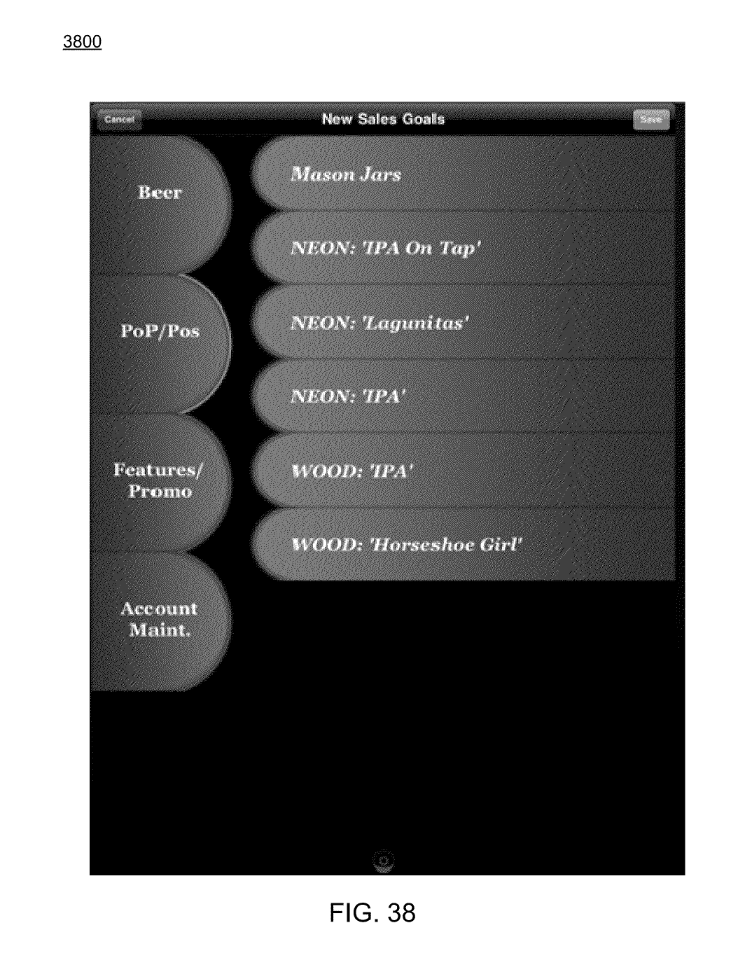

Referring now to FIG. 38, an embodiment depicting interface 3800 generated in accordance with CRM process 10 is depicted. CRM process 10 may be configured to display examples for one or more of the objectives identified above. For example, in the POP/POS example, Mason Jars, Neon: IPA on Tap, Neon: Lagunitas, Neon: IPA, Wood: IPA, Wood: 420 Girl are displayed.

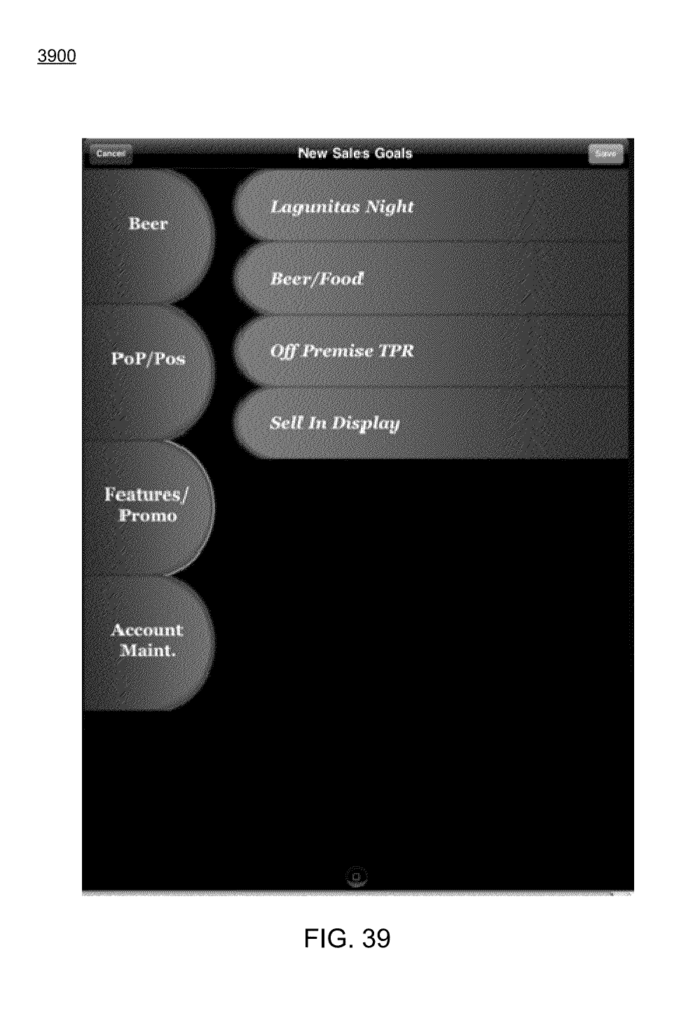

Referring now to FIG. 39, an embodiment depicting interface 3900 generated in accordance with CRM process 10 is depicted. CRM process 10 may be configured to generate examples in accordance with the Features/Promo option. For example, Lagunitas Night, Beer/Food, Off-Premise TPR, Sell in Display, etc., as shown in FIG. 39.

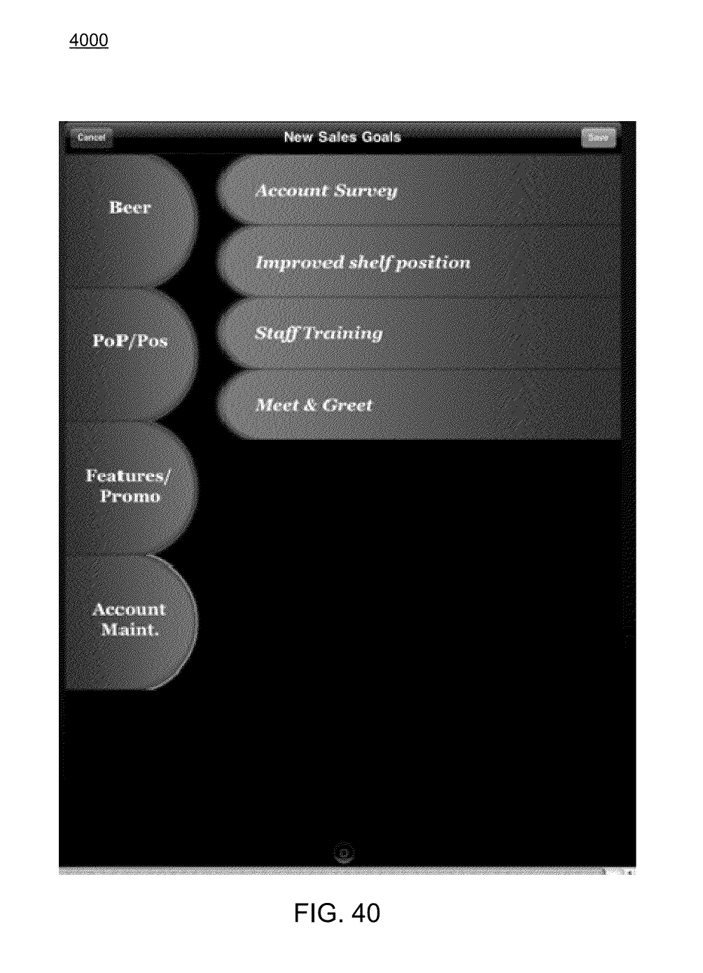

Referring now to FIG. 40, an embodiment depicting interface 4000 generated in accordance with CRM process 10 is depicted. CRM process 10 may be configured to generate examples in accordance with the Account Maintenance option. For example, Account Survey, Improved Shelf Position, Staff Training, Meet and Greet (for Non-Buy/New Acct), etc.

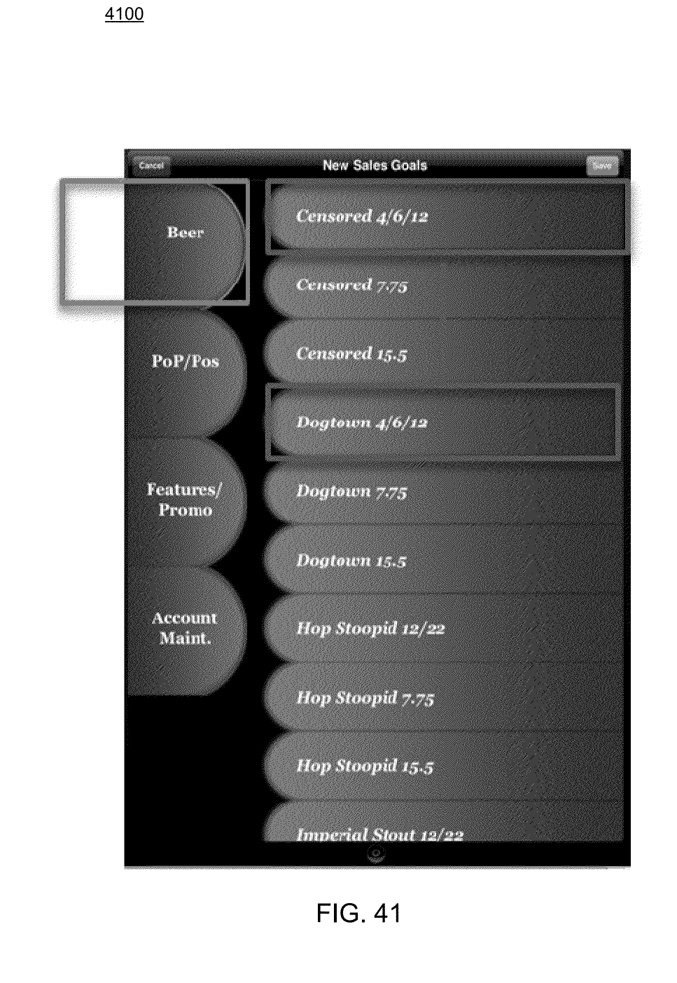

Referring now to FIG. 41, an embodiment depicting interface 4100 generated in accordance with CRM process 10 is depicted. CRM process 10 may be configured to display and/or generate sales goals. For example, a user may Highlight Chosen Sales in a particular category (e.g. Beer). In this example, green may refer to a user selection, blue may indicate a lack of a user selection. CRM process 10 may allow a user to tab each brand/pack that he/she wishes to sell. For example, a green indication may indicate a selection and a blue indication may indicate a lack of selection. CRM process 10 may also provide the user with an option to save any or all of the settings made in accordance with any of the interfaces discussed herein.

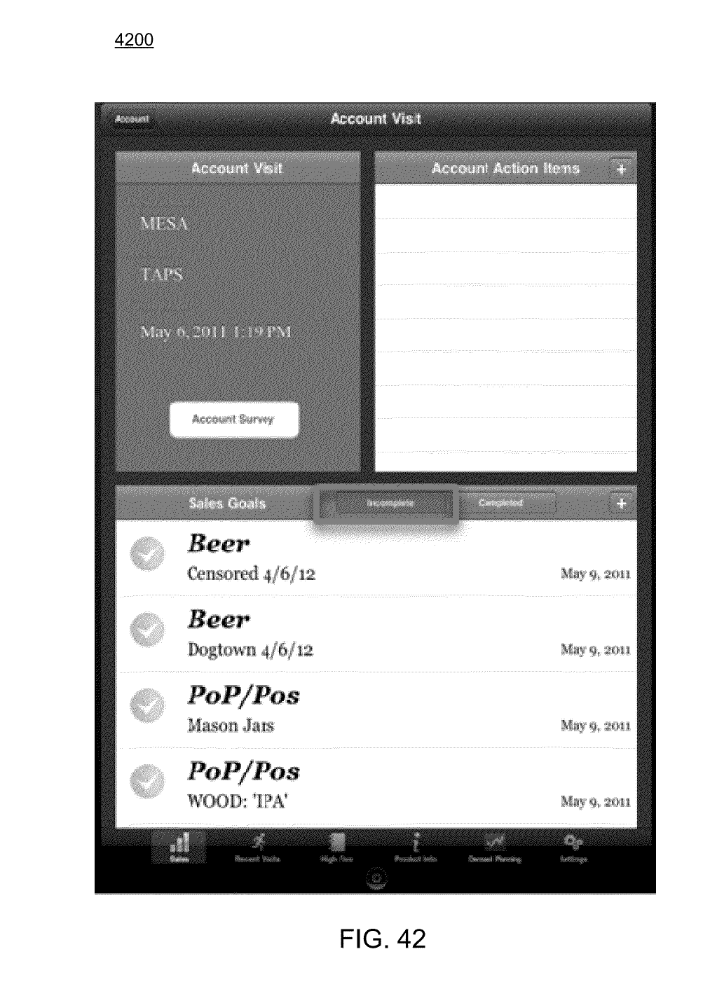

Referring now to FIG. 42, an embodiment depicting interface 4200 generated in accordance with CRM process 10 is depicted. CRM process 10 may be configured to display one or more sales goals, which may be marked in the account.

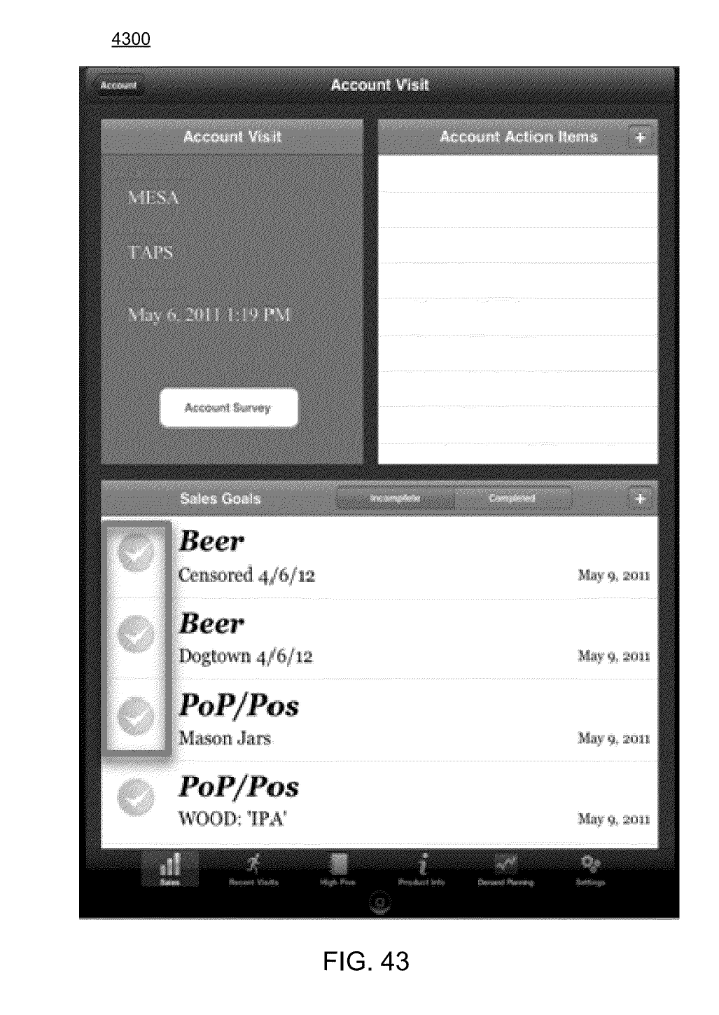

Referring now to FIG. 43, an embodiment depicting interface 4300 generated in accordance with CRM process 10 is depicted. CRM process 10 may be configured to display one or more incomplete sales goals, which may be marked in the account.

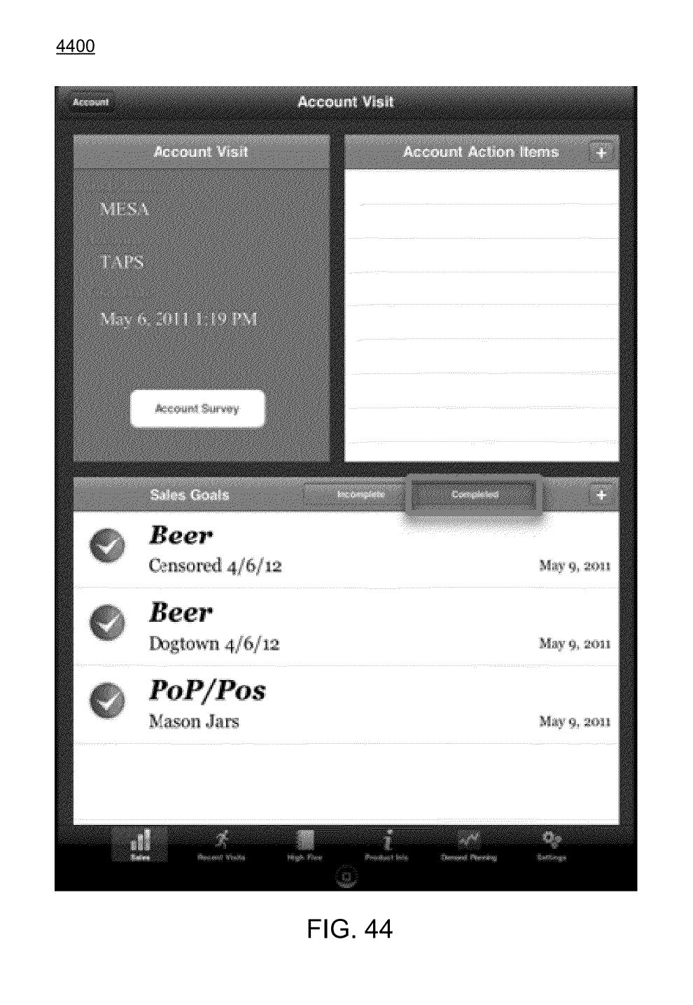

Referring now to FIG. 44, an embodiment depicting interface 4400 generated in accordance with CRM process 10 is depicted. CRM process 10 may be configured to display one or more complete sales goals, which may be marked in the account.

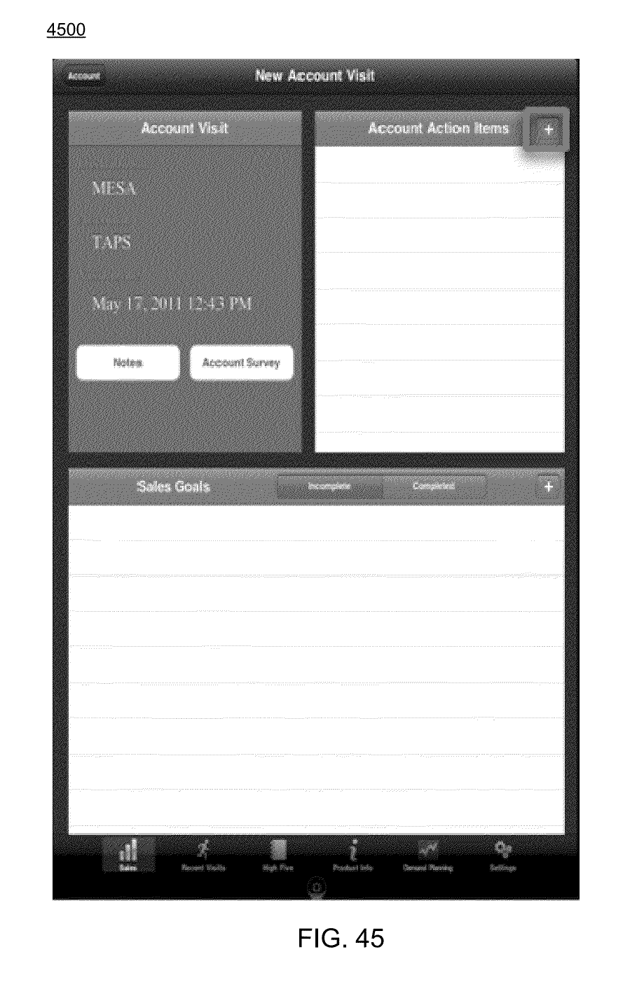

Referring now to FIG. 45, an embodiment depicting interface 4500 generated in accordance with CRM process 10 is depicted. CRM process 10 may be configured to generate one or more action items. Accordingly, CRM process 10 may provide a reminder and a mechanism by which to send a communication to the appropriate distributor. Interface 4500 may allow a user to enter information regarding the title, description, name, place, time, etc. Options to save the action items and to transmit the items to the distributor may also be provided.

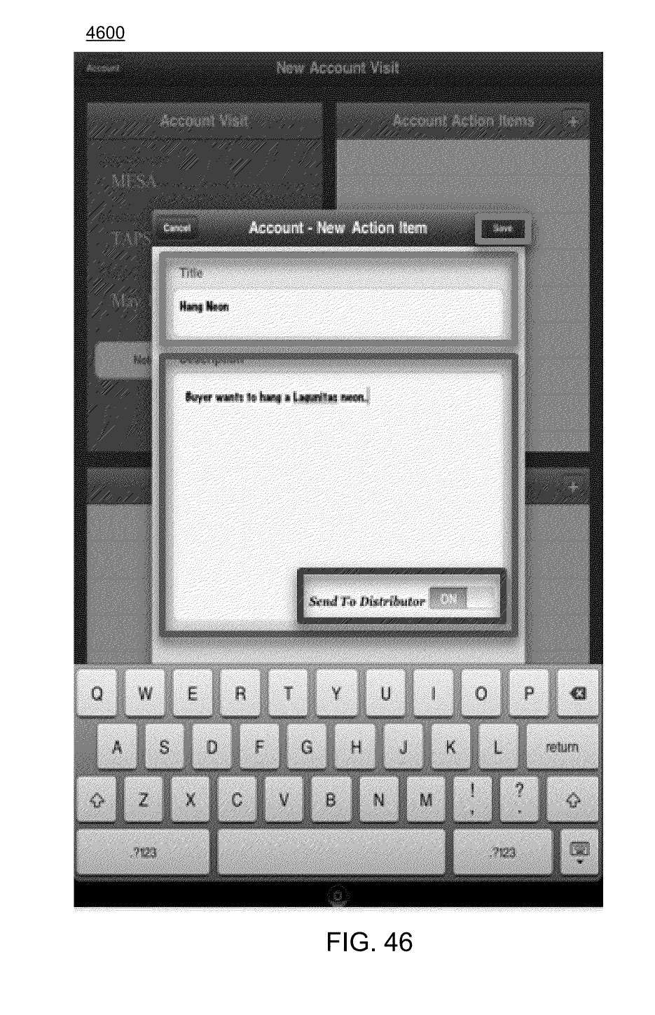

Referring now to FIG. 46, an embodiment depicting interface 4600 generated in accordance with CRM process 10 is depicted. CRM process 10 may be configured to allow for the generation of new action items. For example, once an Action Item is saved, it may appear as an Account Action item.

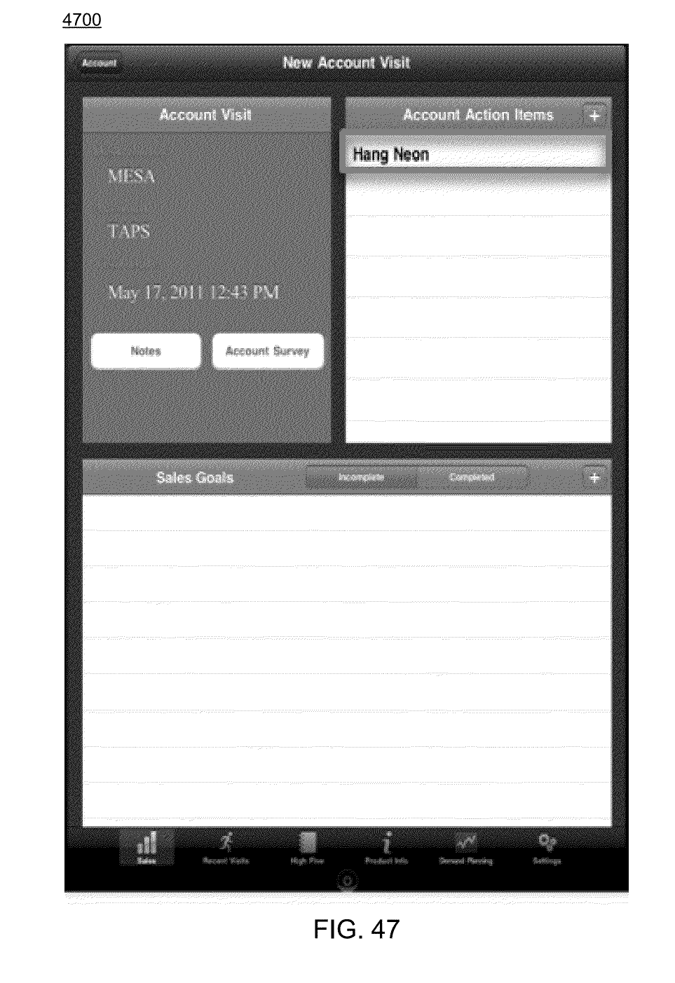

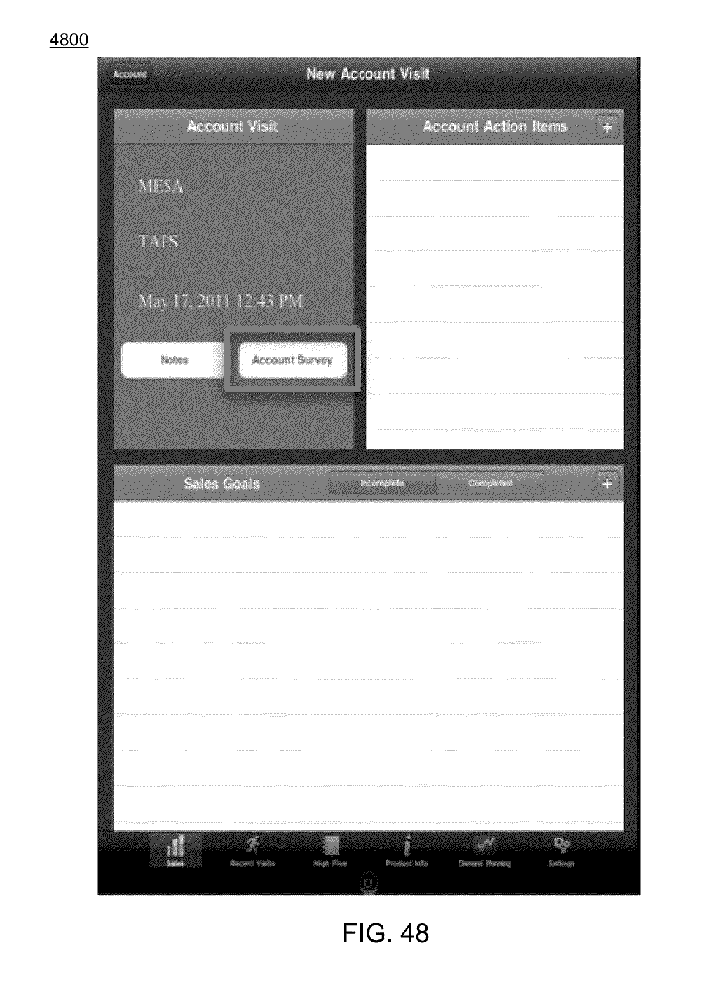

Referring now to FIGS. 47-48, embodiments depicting interfaces 4700 and 4800, which may be generated in accordance with CRM process 10 are depicted. CRM process 10 may be configured to allow for an Account Survey.

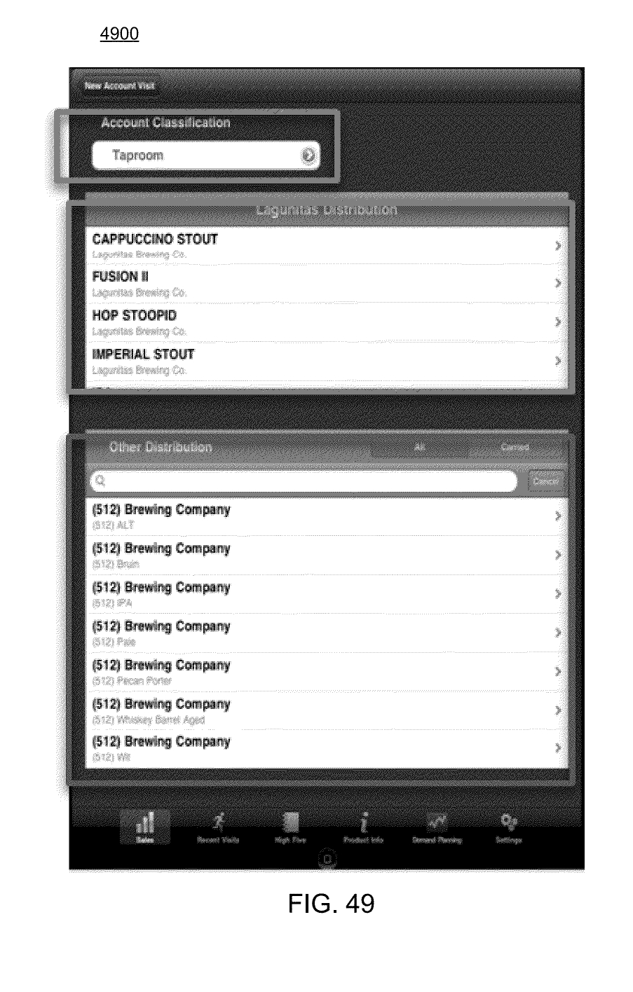

Referring now to FIG. 49, an embodiment depicting interface 4900 generated in accordance with CRM process 10 is depicted. CRM process 10 may be configured to allow for an Account Classification. Accordingly, a user may select the classification area and/or may choose a classification from the roll down menu, etc.

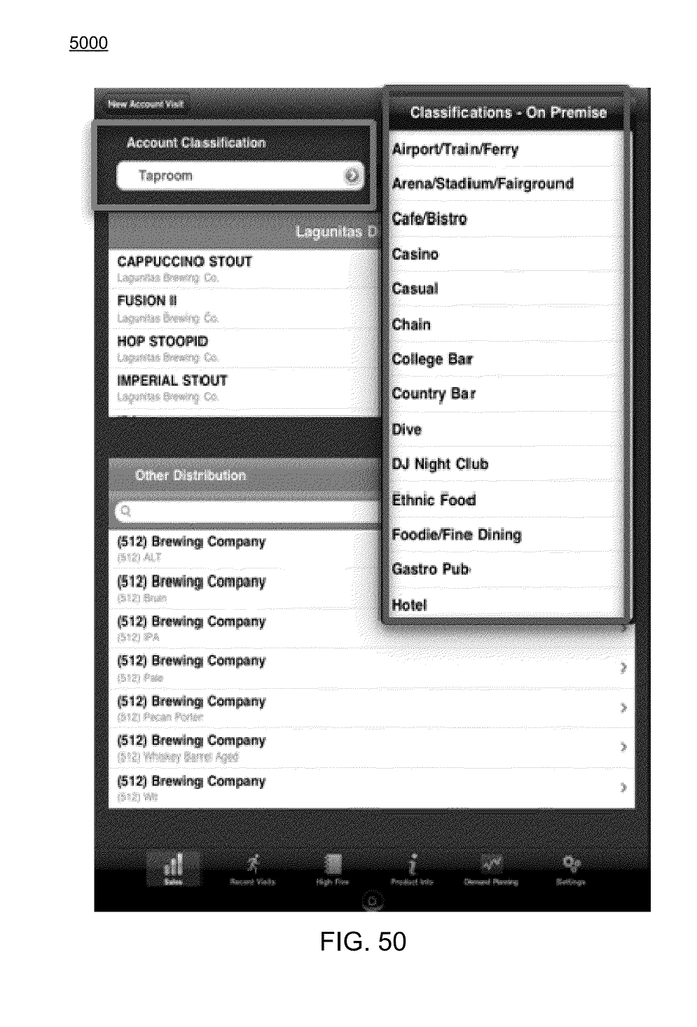

Referring now to FIG. 50, an embodiment depicting interface 5000 generated in accordance with CRM process 10 is depicted. CRM process 10 may be configured to generate an Account Classification. For example, and as shown in FIG. 50, Lagunitas Distribution may be filled in and may not require updating. In some embodiments, a user may track price and/or serving size by package. Various flavors may be listed.

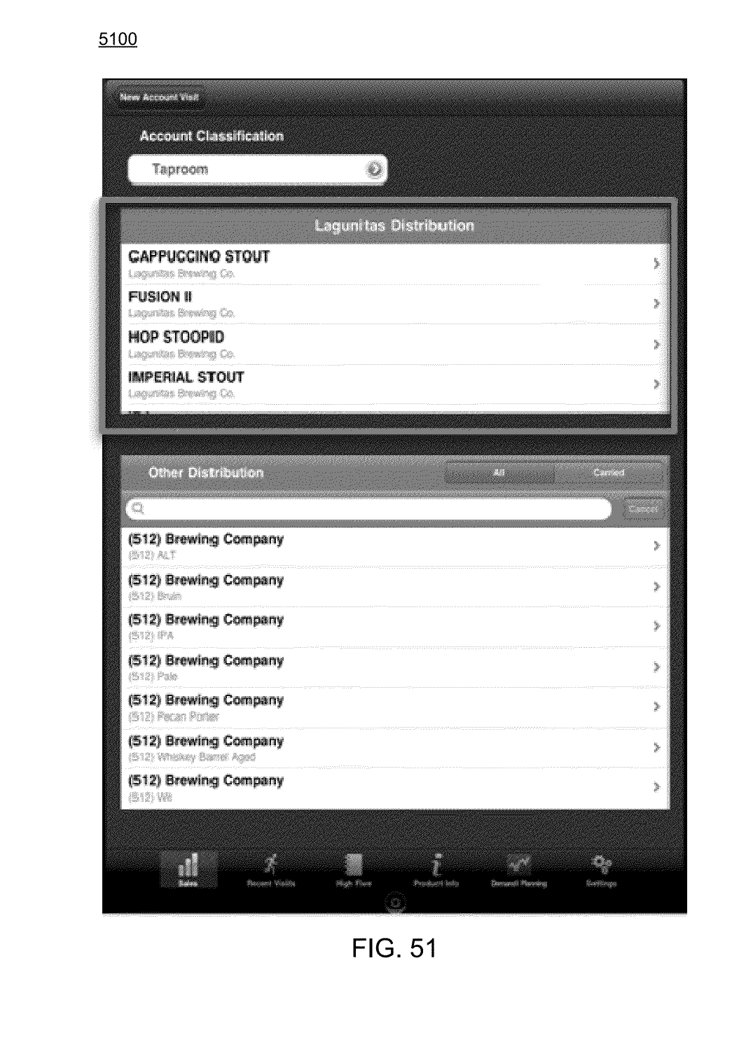

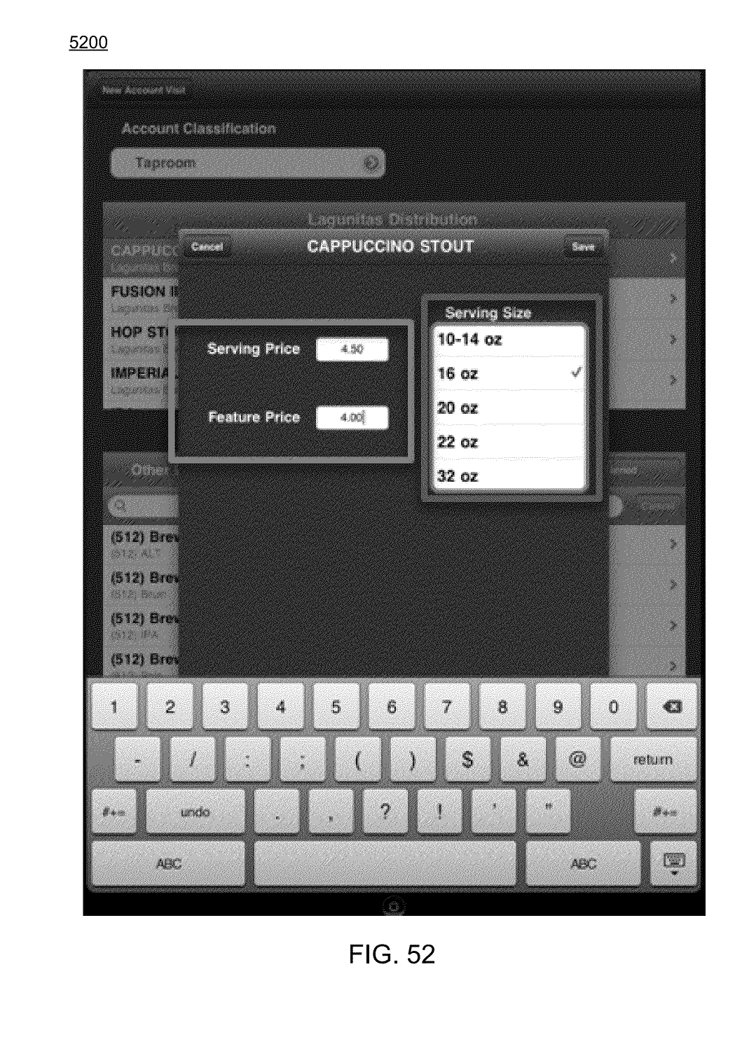

Referring now to FIGS. 51-52, embodiments depicting interfaces 5100 and 5200 generated in accordance with CRM process 10 are depicted. CRM process 10 may be configured to provide options corresponding to one or more products. Upon selection of a product an additional interface 5200 may be generated. Interface 5200 may include a Price Survey Input, Serving/Feature Price Input, Serving Size Input. In some embodiments, for Off-Premise the choices may be updated as necessary for that geographical area.

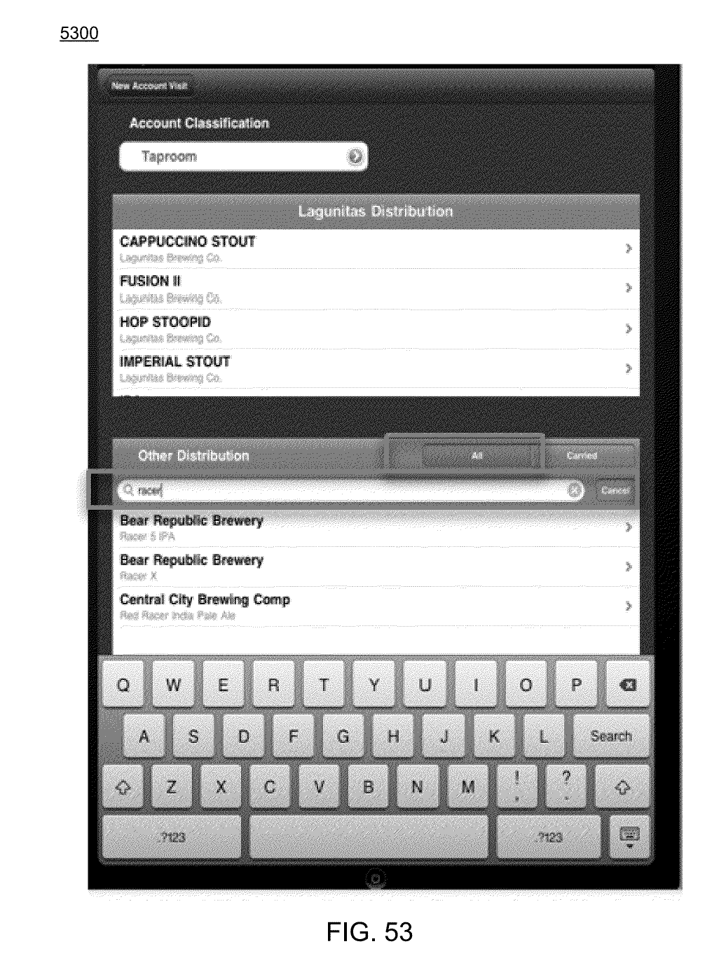

Referring now to FIG. 53, an embodiment depicting interface 5300 generated in accordance with CRM process 10 is depicted. CRM process 10 may be configured to allow a user to review Other Distribution options as is shown in FIG. 53. In this example, a user may select, “All” and may use the Search bar to find products, beers, etc.

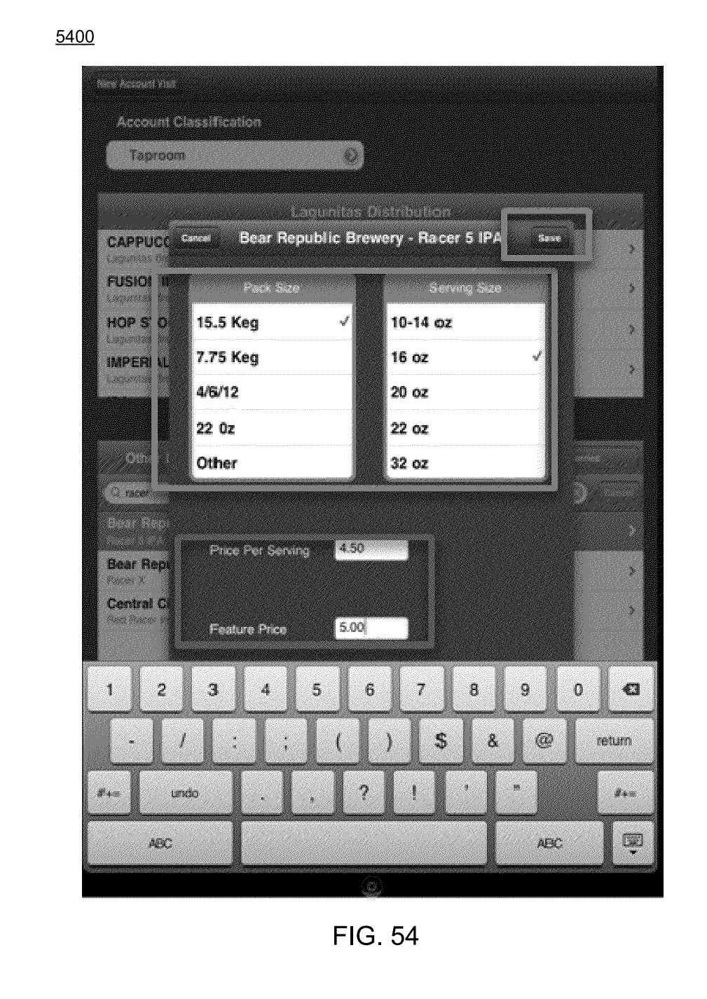

Referring now to FIG. 54, an embodiment depicting interface 5400 generated in accordance with CRM process 10 is depicted. CRM process 10 may be configured to allow a user to access and/or edit one or more features. Some of which may include, but are not limited to, Price Survey Box, Check the Pack Size/Serving Size, Fill in the Price/Feature Price. As discussed with regards to the other interfaces described herein, an option to save the settings may also be provided.

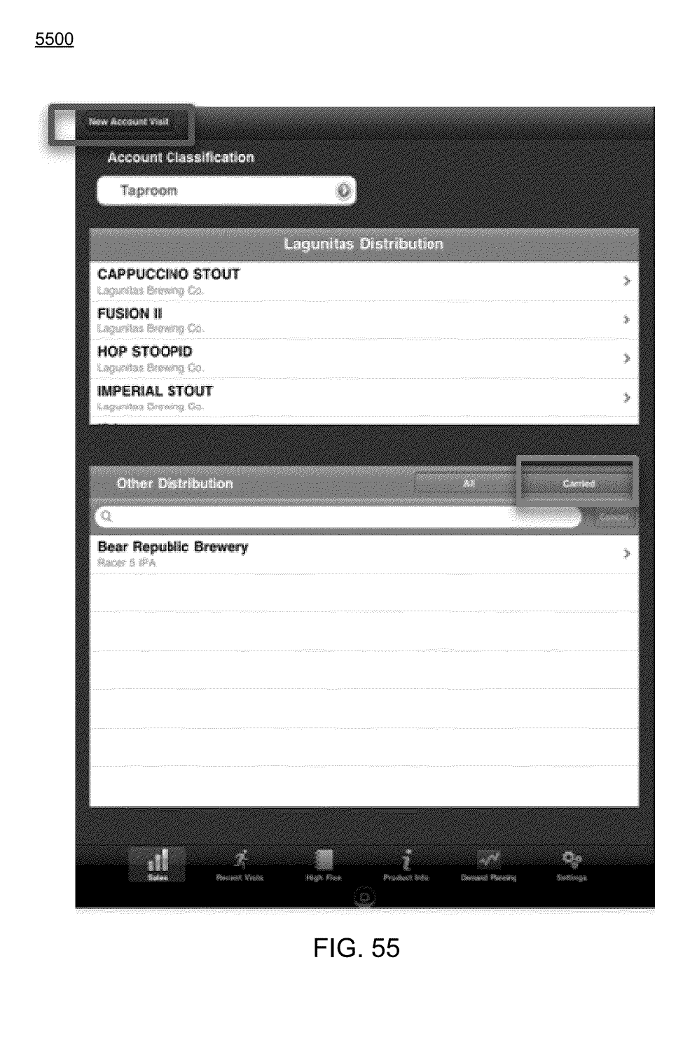

Referring now to FIG. 55, an embodiment depicting interface 5500 generated in accordance with CRM process 10 is depicted. CRM process 10 may be configured to allow a user to adjust any changes in distribution from visit to visit. In some embodiments, a user may be allowed to select a particular product or beer to visualize and may be permitted to edit pricing, serving, size, etc.

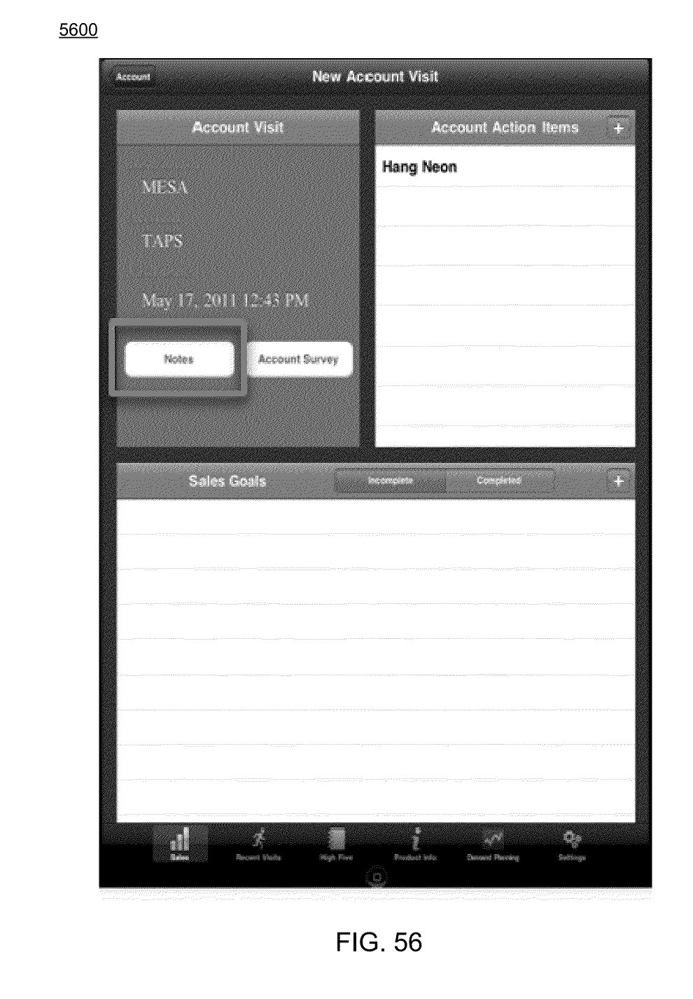

Referring now to FIG. 56, an embodiment depicting interface 5600 generated in accordance with CRM process 10 is depicted. CRM process 10 may be configured to allow a user to enter one or more Account Notes as shown in FIG. 56.

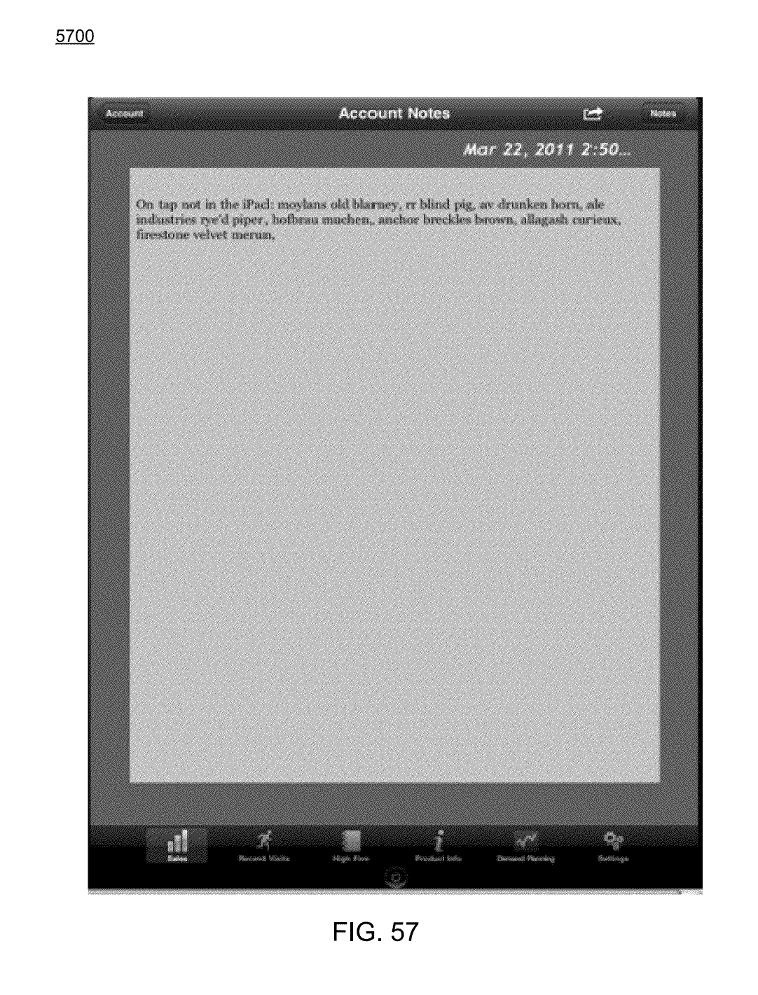

Referring now to FIG. 57, an embodiment depicting interface 5700 generated in accordance with CRM process 10 is depicted. CRM process 10 may be configured to enter account notes using a “Yellow Pad” format. In some embodiments, these notes may be provided to members of the sales team and viewing by distributors may be prevented. A notes tab may be provided, which may show a dropdown list of prior notes, from recent visits. An email tab may also provide a user with the ability to email notes.

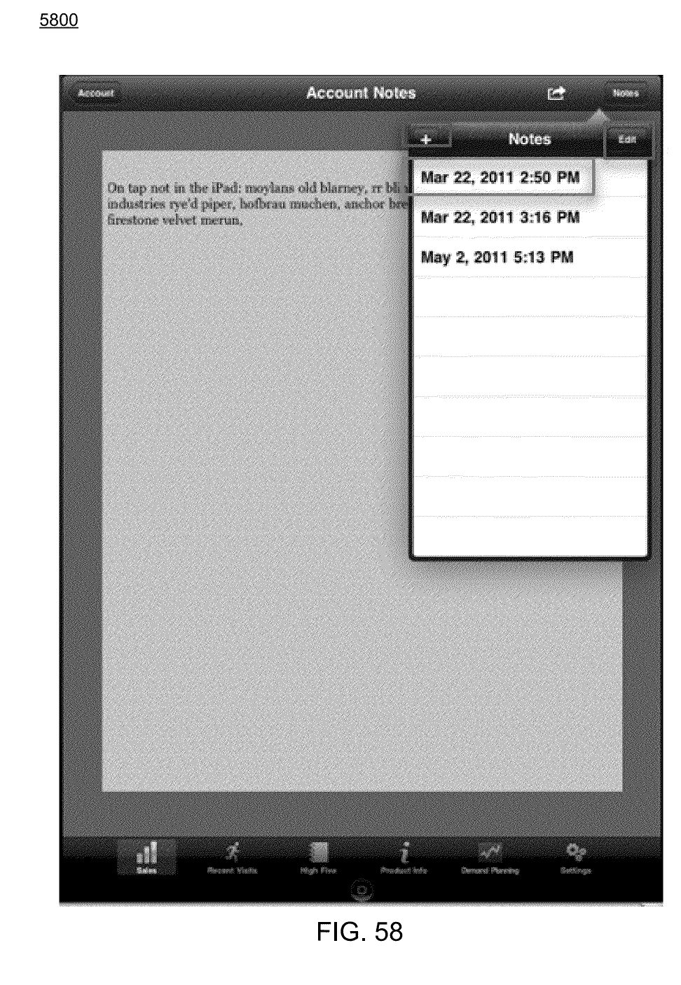

Referring now to FIG. 58, an embodiment depicting interface 5800 generated in accordance with CRM process 10 is depicted. CRM process 10 may be configured to provide one or more selectable options associated with the notes tab. For example, a user may select a date to view previous notes, may delete notes, and/or may add a new note.

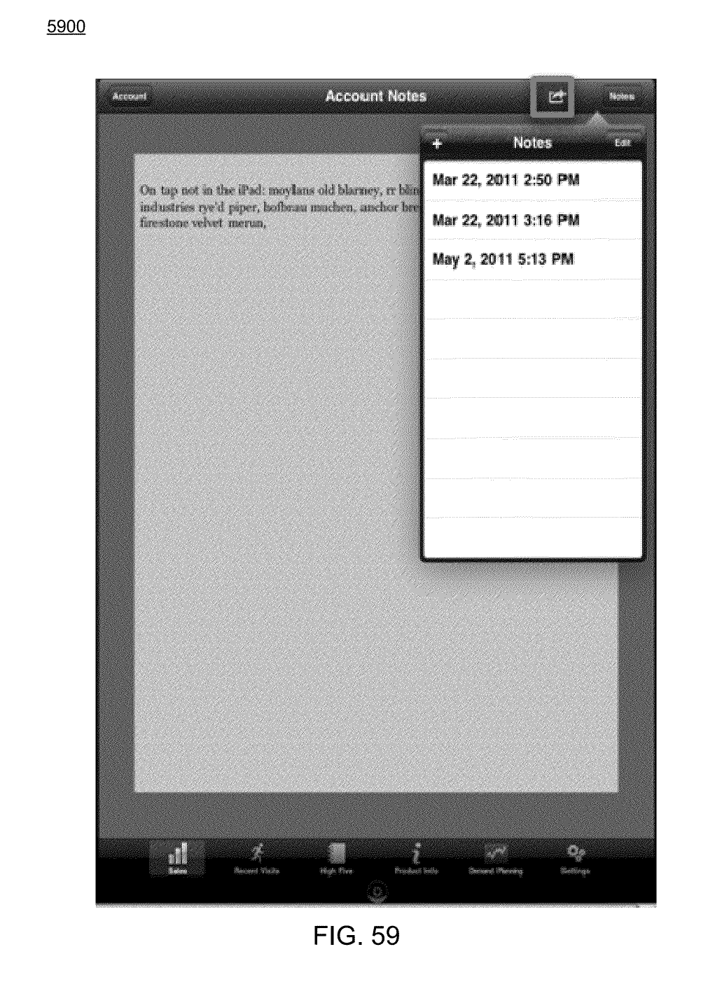

Referring now to FIG. 59, an embodiment depicting interface 5900 generated in accordance with CRM process 10 is depicted. CRM process 10 may be configured to allow a user to email an Account Note, create a note, etc.

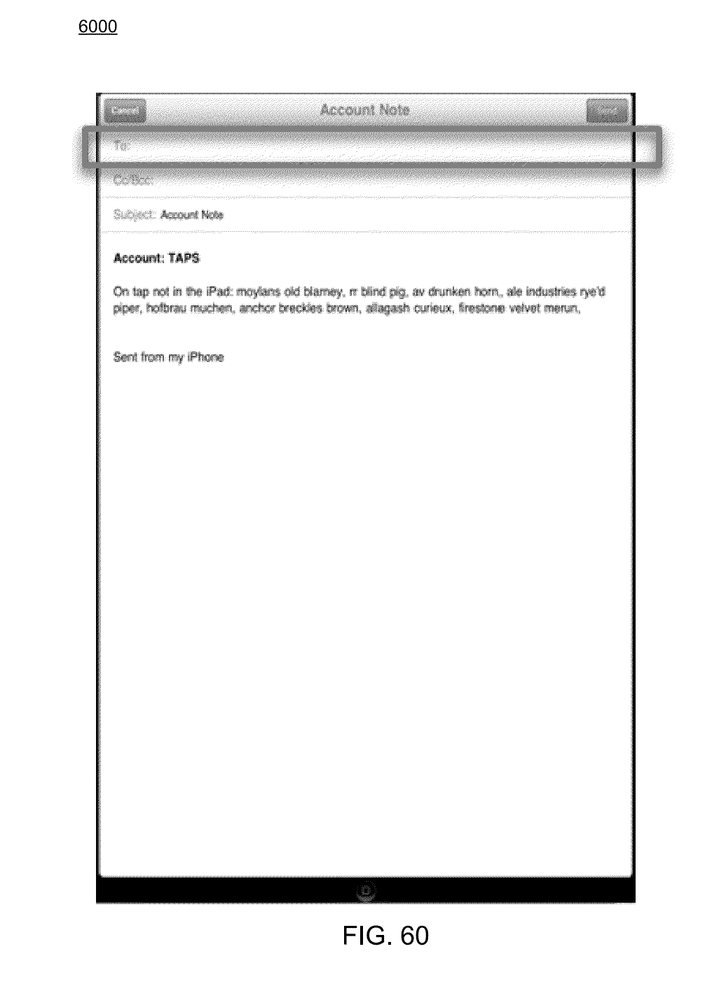

Referring now to FIG. 60, an embodiment depicting interface 6000 generated in accordance with CRM process 10 is depicted. CRM process 10 may be configured to allow a user to create an email.

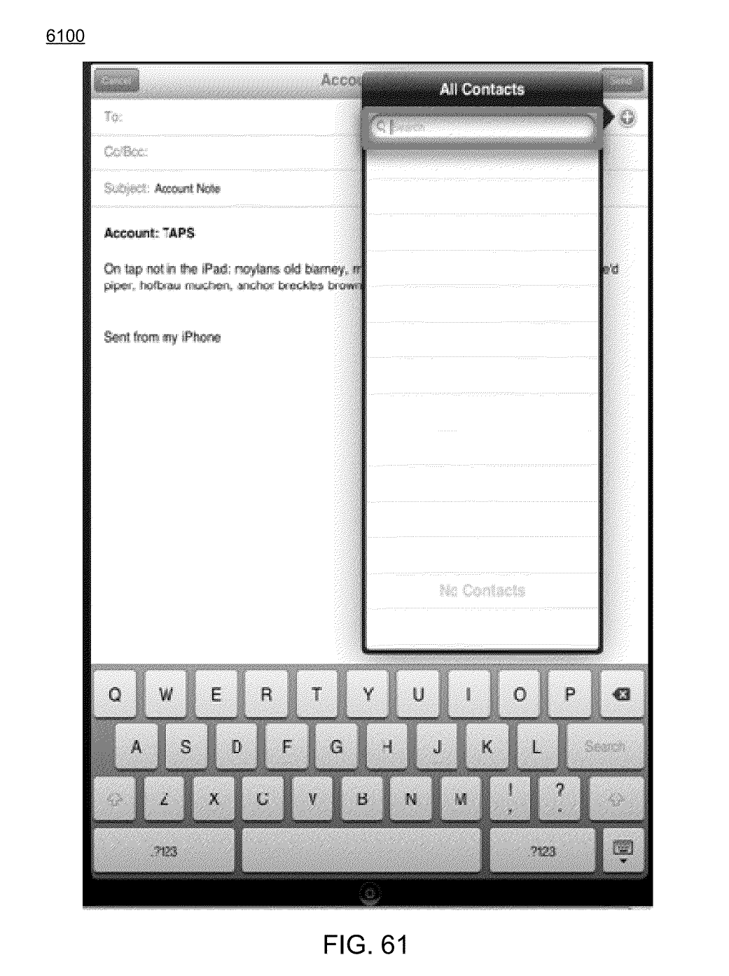

Referring now to FIG. 61, an embodiment depicting interface 6100 generated in accordance with CRM process 10 is depicted. CRM process 10 may be configured to allow a user to search various contacts via a contacts option. Contacts option may include a search bar which may be configured to allow for searching by name, etc. Once a contact is found, the Contact may populate in the “To:” area. The contacts email address may be accessed and/or edited in this manner.

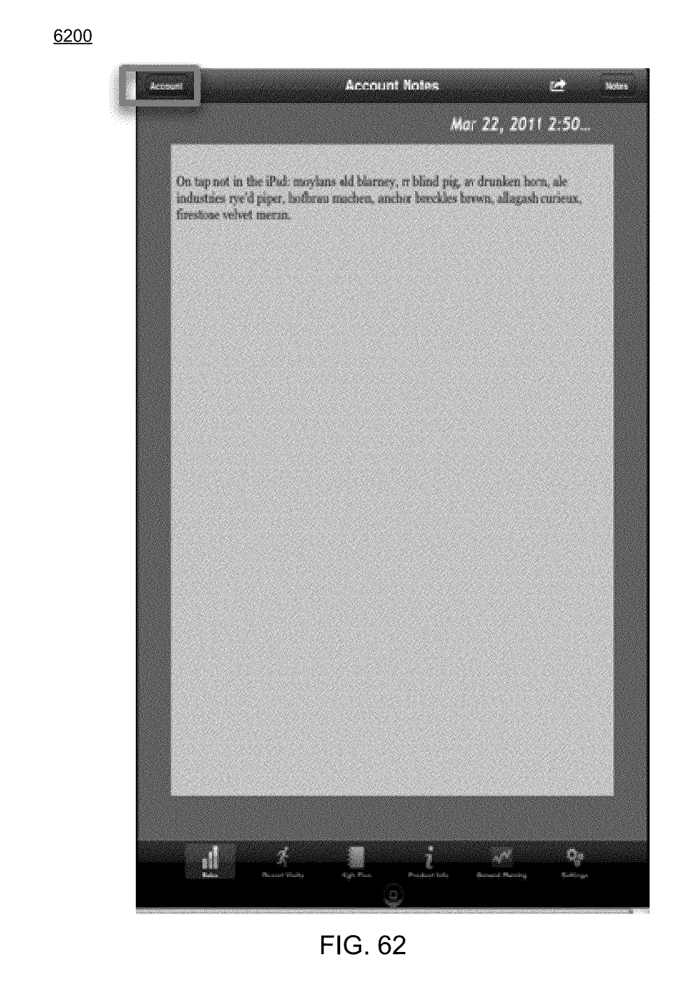

Referring now to FIG. 62, an embodiment depicting interface 6200 generated in accordance with CRM process 10 is depicted. CRM process 10 may be configured to allow a user to enter one or more Account Notes. In some embodiments, once a note has been emailed, a user may exit out of the notes area. For example, by pressing the Account tab to return to, the account home page.

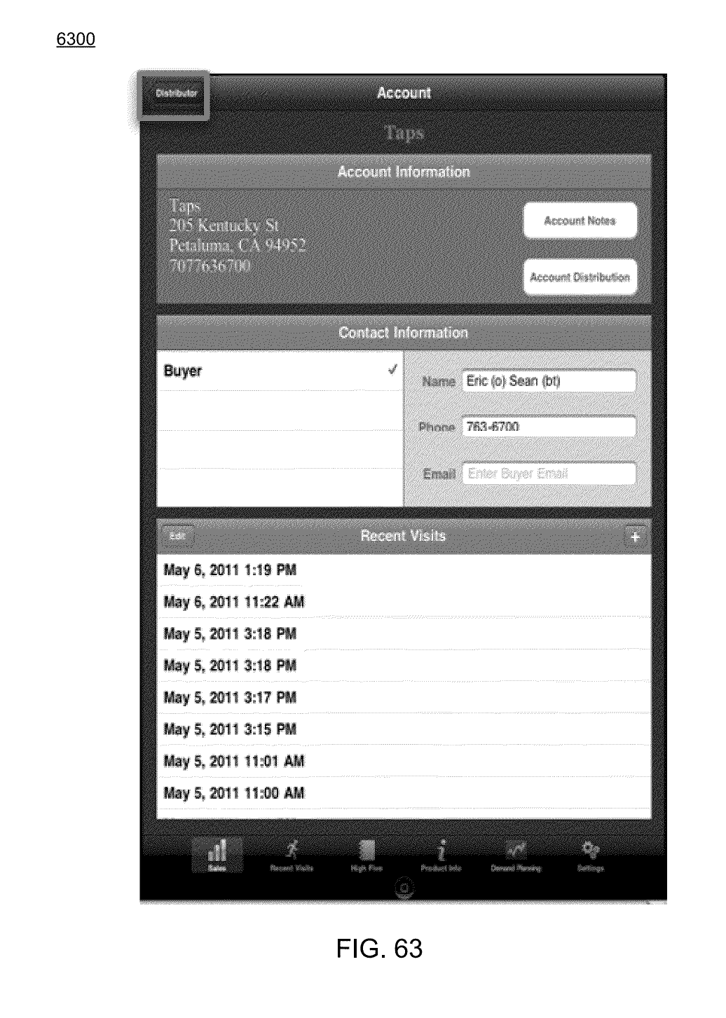

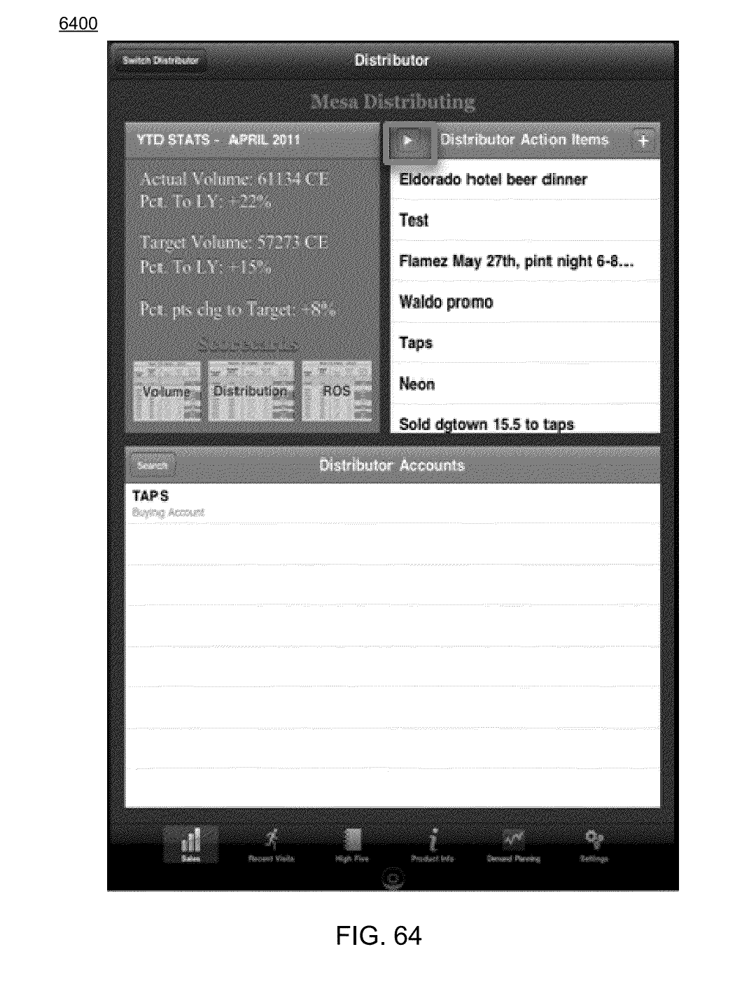

Referring now to FIGS. 63-64, embodiments depicting interfaces 6300 and 6400 generated in accordance with CRM process 10 are depicted. CRM process 10 may be configured to display Distributor Action Items. In some embodiments, a user may select the “play” tab in order to email any Distributor Action Items. In some embodiments, a user may select the + tab to add another Action Item. CRM process 10 may also allow for editing of action items and for transmission of action items to others.

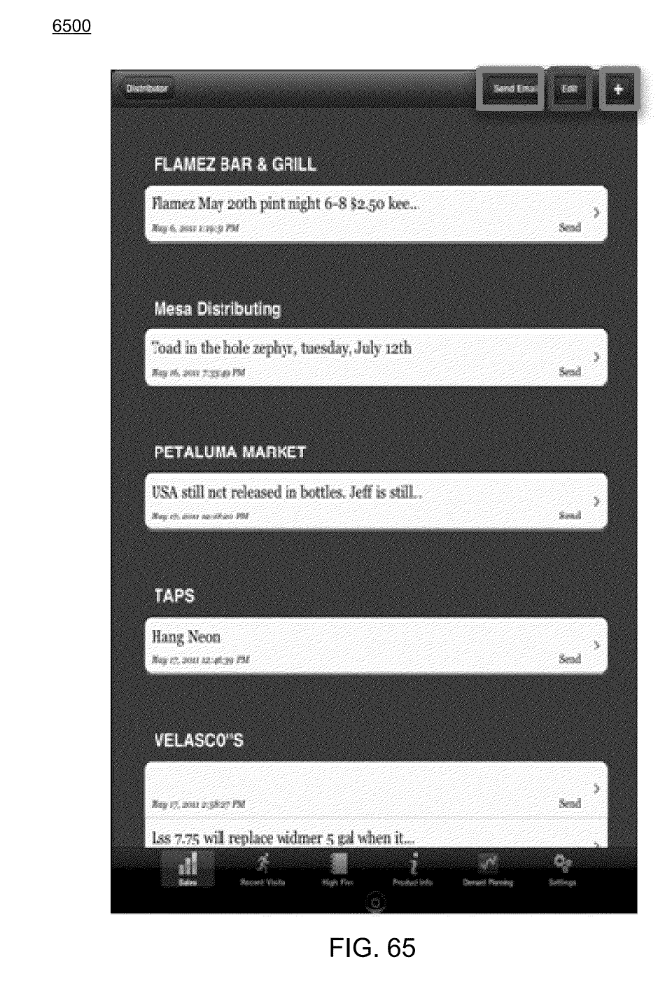

Referring now to FIG. 65, an embodiment depicting interface 6500 generated in accordance with CRM process 10 is depicted. CRM process 10 may be configured to allow a user to add an Action Item. In this way, a user may enter the Title and Description and may save the selections.

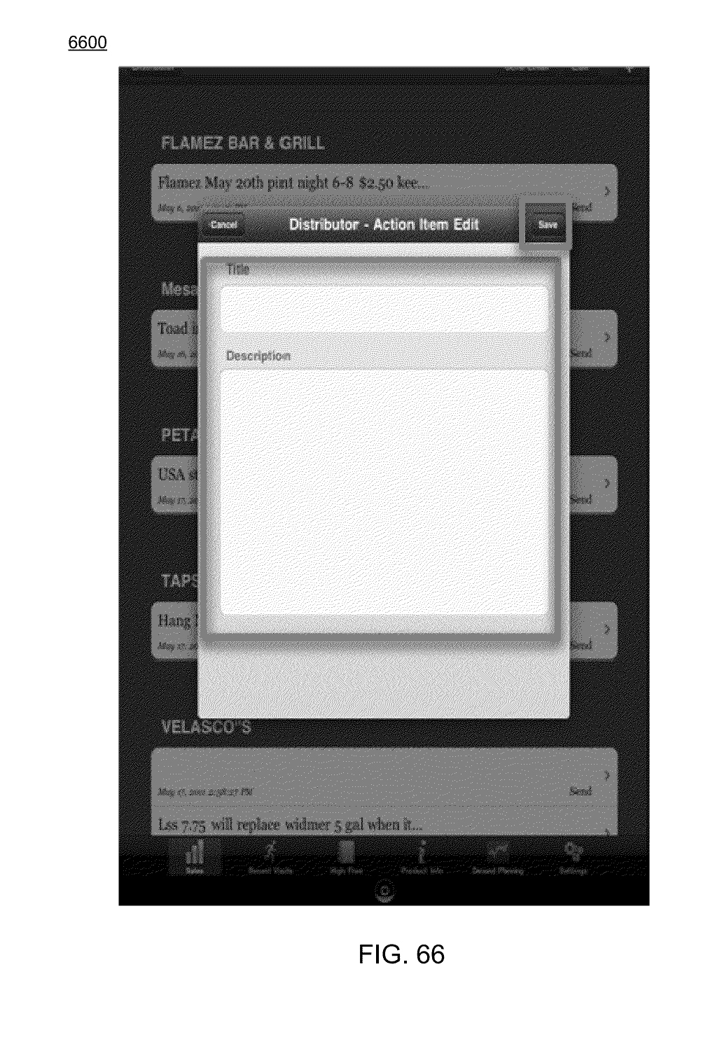

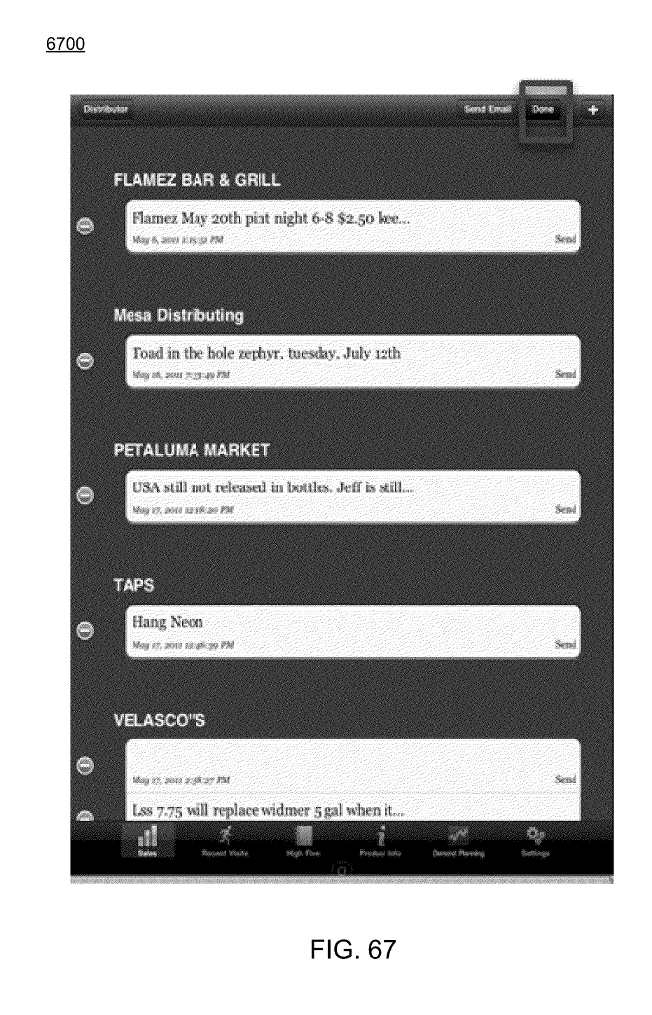

Referring now to FIGS. 66-67, embodiments depicting interfaces 6600 and 6700 generated in accordance with CRM process 10 are depicted. CRM process 10 may be configured to allow a user to Edit Action Items. Accordingly, upon selection of the Edit tab on the home page, this view may appear. CRM process 10 may allow for removal of some or all of the action items and subsequent saving of any changes.

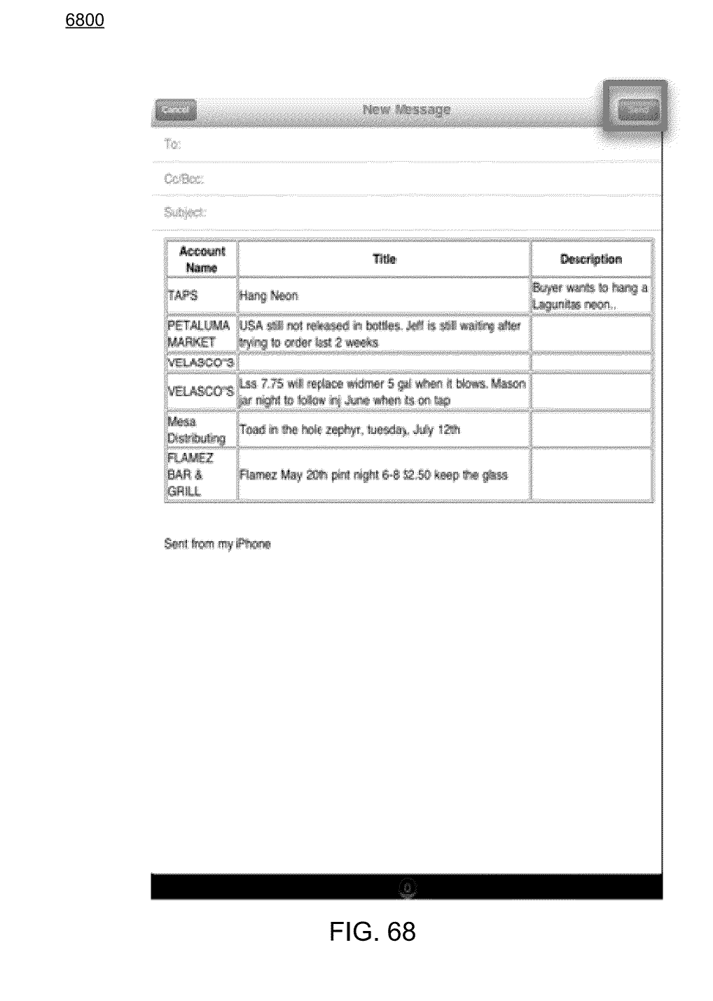

Referring now to FIG. 68, an embodiment depicting interface 6800 generated in accordance with CRM process 10 is depicted. CRM process 10 may be configured to allow a user to email an Account Action Item.

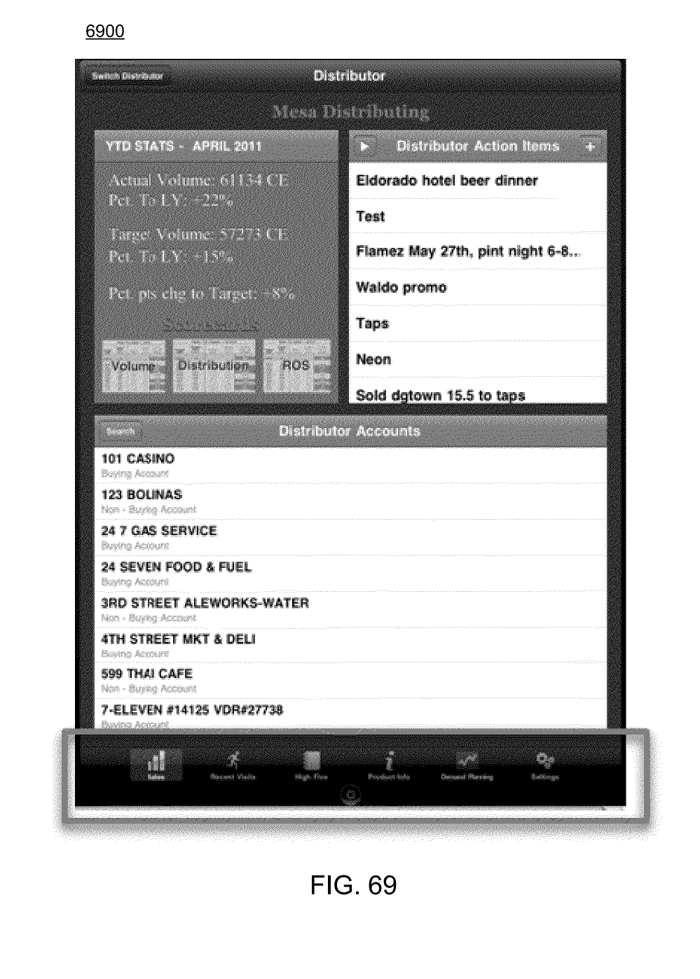

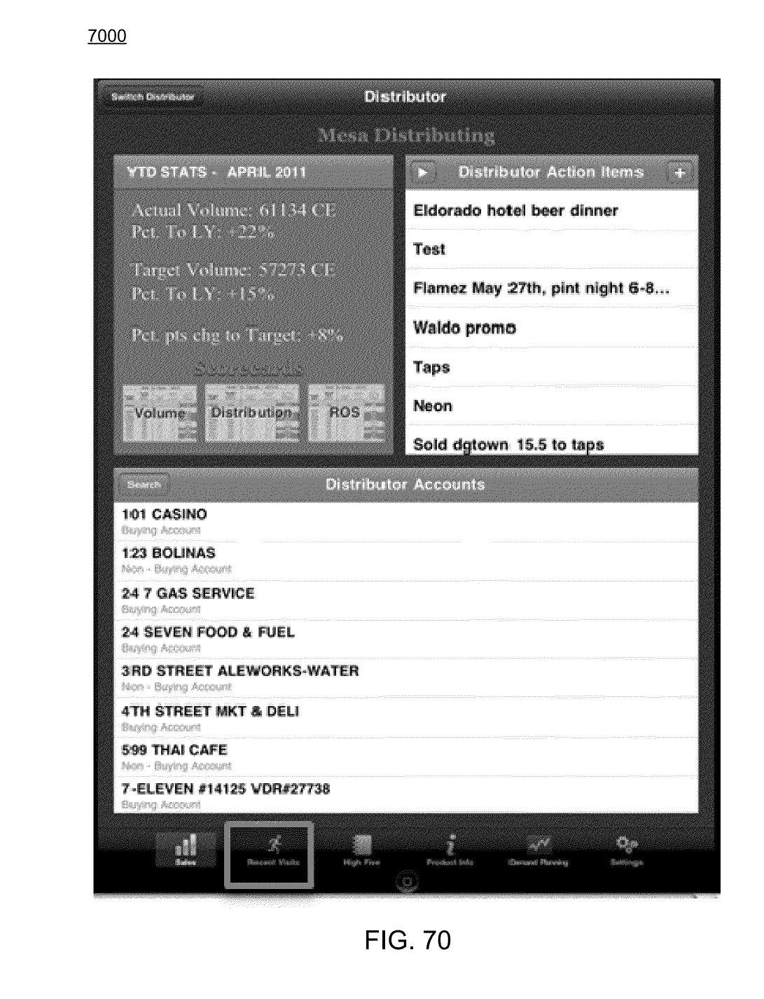

Referring now to FIGS. 69-70, embodiments depicting interfaces 6900 and 70000 generated in accordance with CRM process 10 are depicted. CRM process 10 may be configured to allow a user to view and edit distributor action items and distributor accounts.

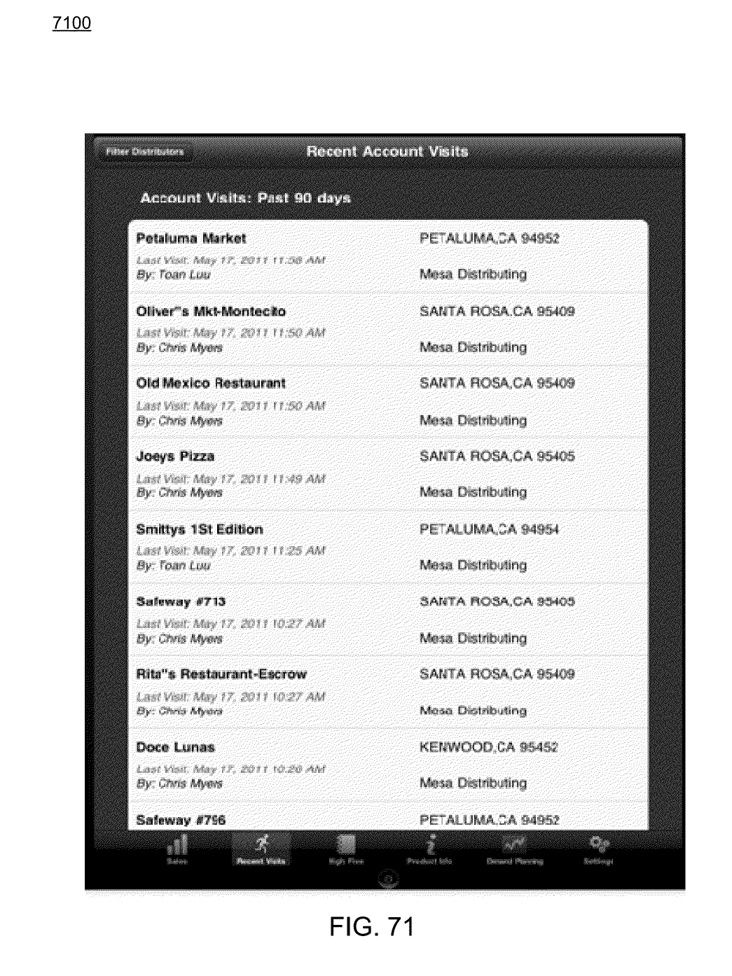

Referring now to FIG. 71, an embodiment depicting interface 7100 generated in accordance with CRM process 10 is depicted. CRM process 10 may be configured to display recent visits. The recent visits feature may allow a user to review the dates, times, and addresses of prior visits. In some embodiments, CRM process 10 may display the name of the sales member who visited the account. In some embodiments, all recent visits may be viewed by Distributor. Accordingly, a user may access any visit log by pressing on a visit to see what occurred. In some embodiments, the name of the sales person who visited the account may also be provided.

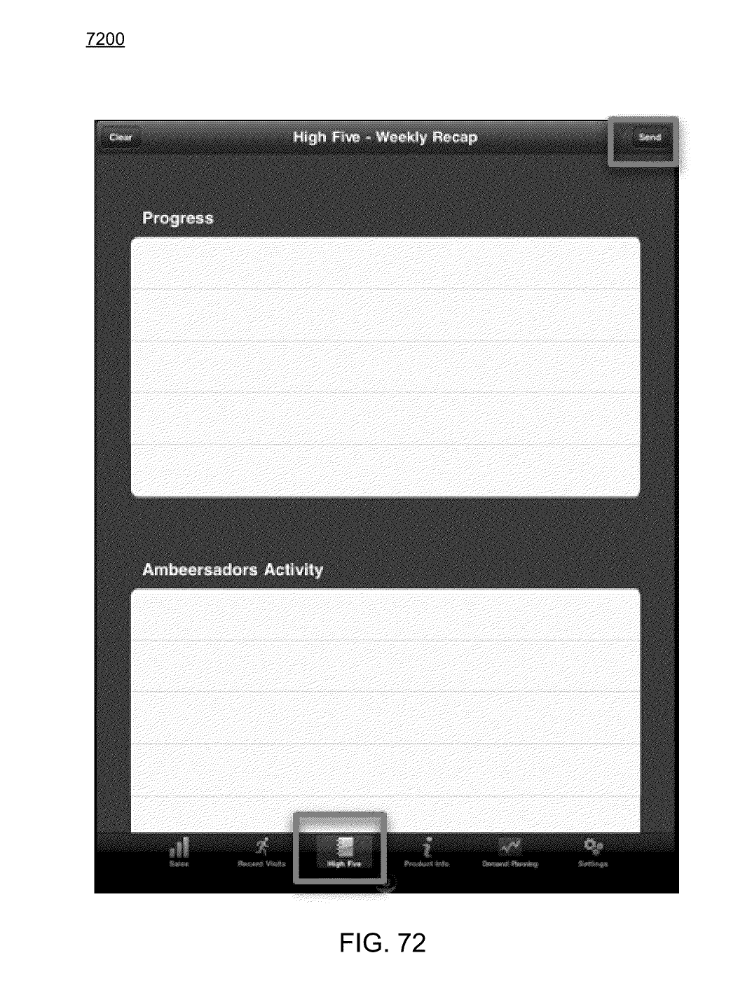

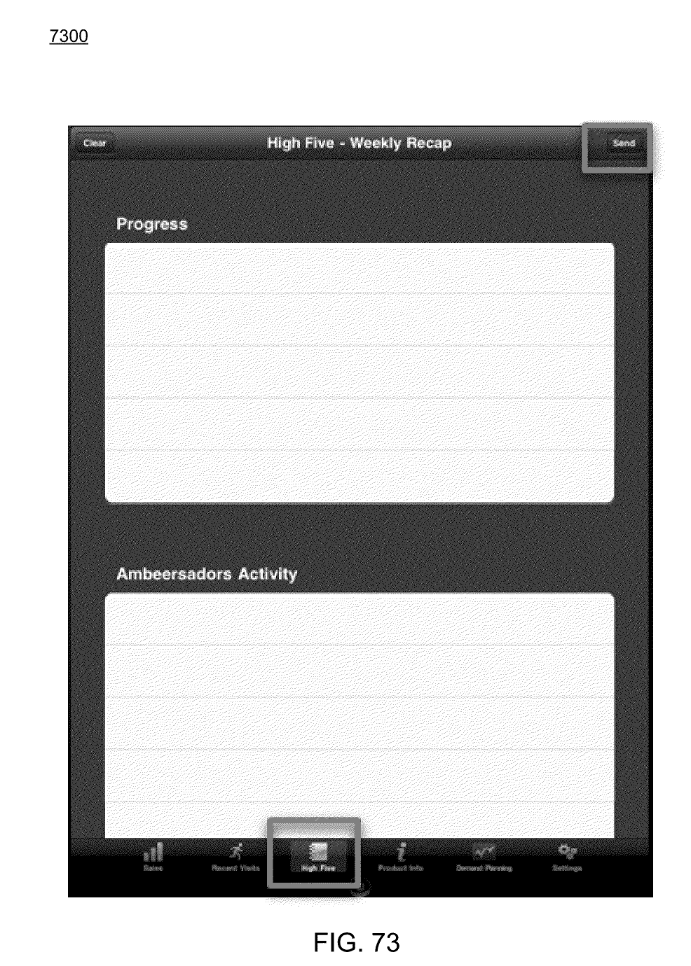

Referring now to FIG. 72-73, embodiments depicting interfaces 7200 and 7300 generated in accordance with CRM process 10 are depicted. CRM process 10 may be configured to provide a High Five Recap option. Accordingly, a user may communicate with other members of the sales team.

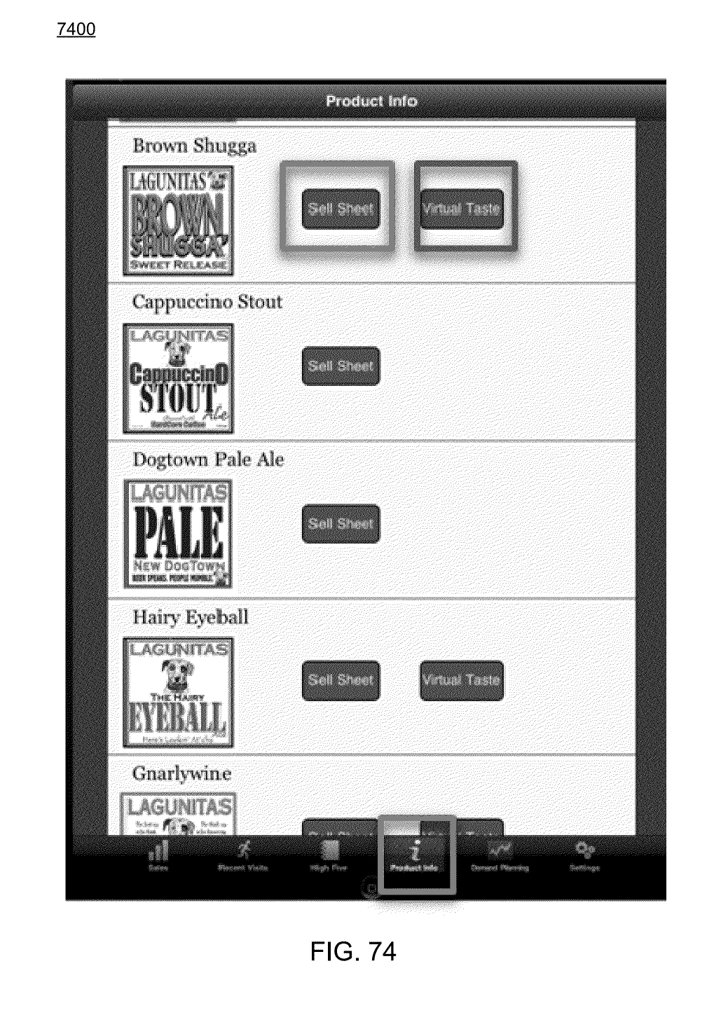

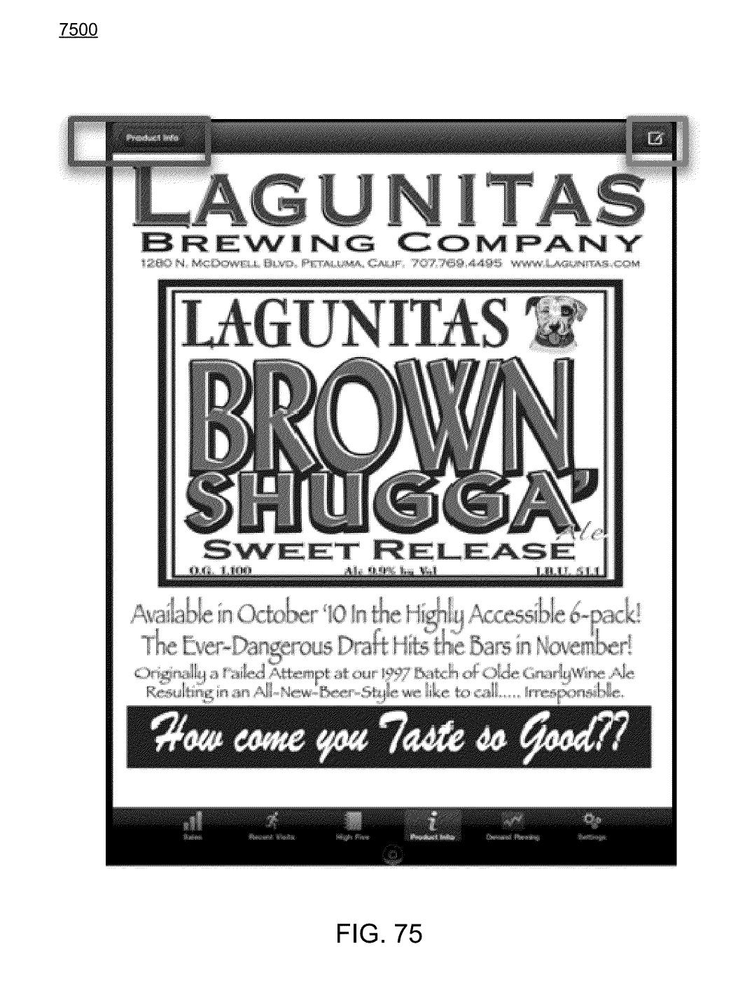

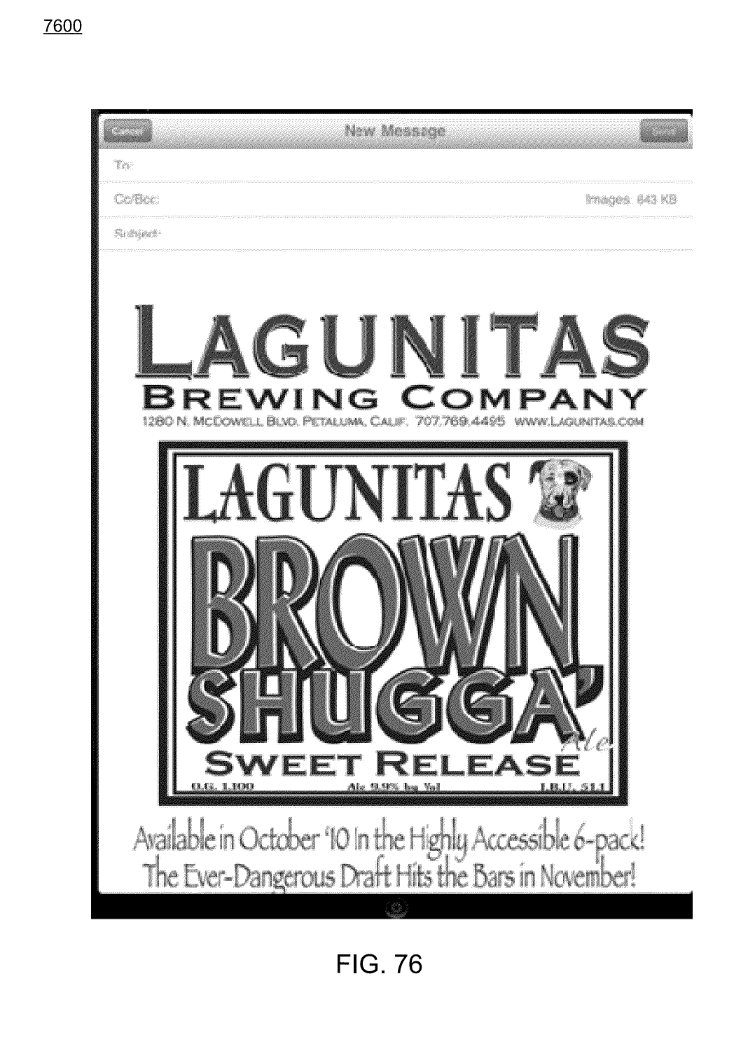

Referring now to FIG. 74-76, embodiments depicting interfaces 7400-7600 generated in accordance with CRM process 10 are depicted. CRM process 10 may be configured to provide a Product Information feature. In some embodiments, the product information feature may include a menu of electronic sell sheets and virtual tastes. These may be emailed to various buyers and prospective buyers using CRM process 10.

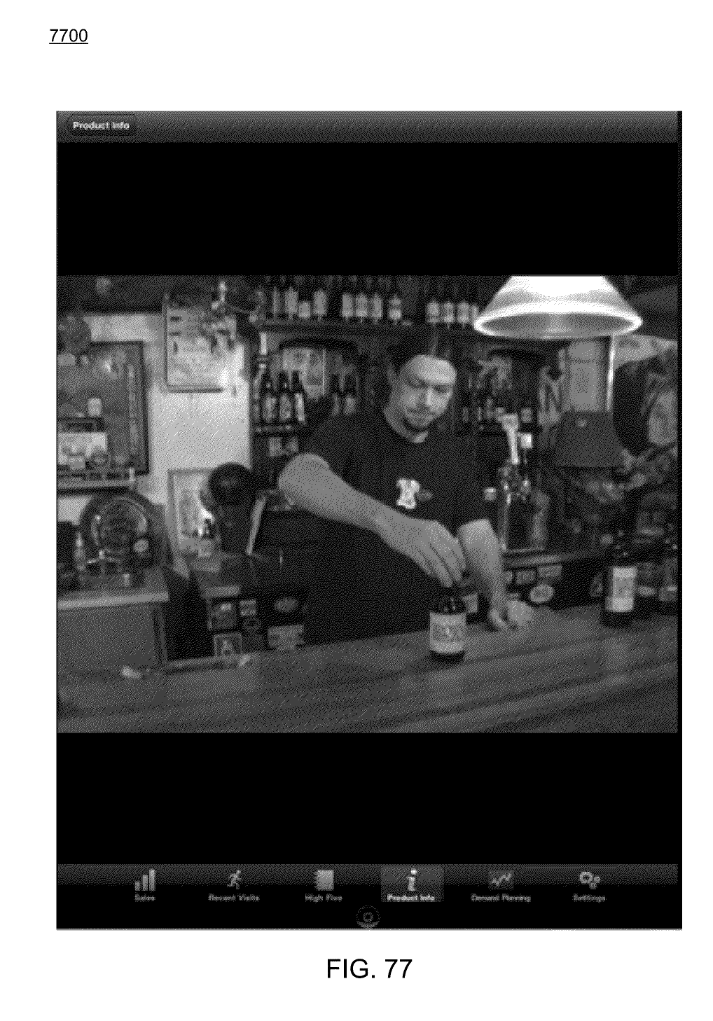

Referring now to FIG. 77, an embodiment depicting interface 7700 generated in accordance with CRM process 10 is depicted. CRM process 10 may be configured to provide a Virtual Taste feature. In some embodiments, this feature may allow the buyer to view a member of the sales team describing the beer in a video or audio presentation.

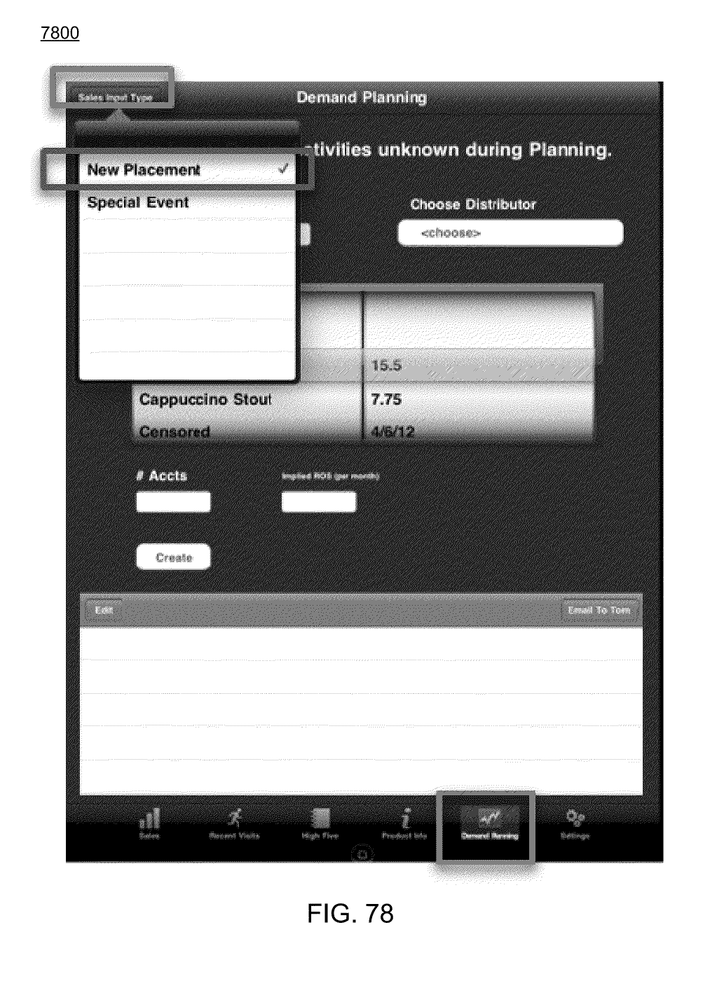

Referring now to FIG. 78, an embodiment depicting interface 7800 generated in accordance with CRM process 10 is depicted. CRM process 10 may be configured to generate a Demand Planning option. Accordingly, a user may select an Input Type Tab and may select which type is relevant.

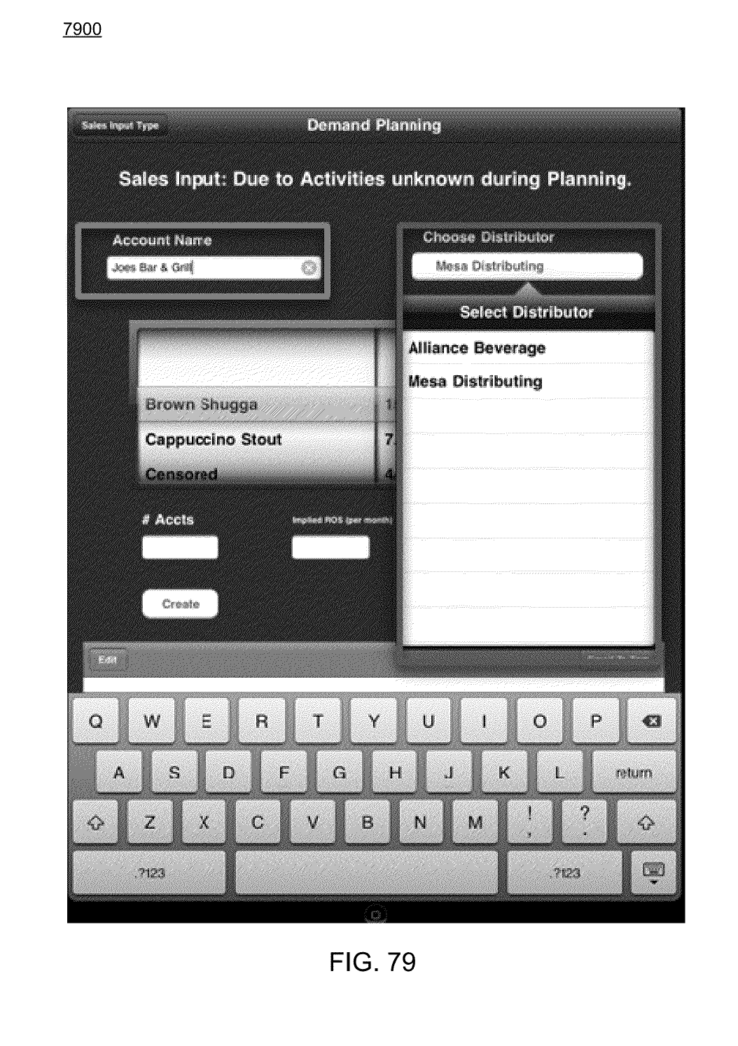

Referring now to FIG. 79, an embodiment depicting interface 7900 generated in accordance with CRM process 10 is depicted. CRM process 10 may be configured to allow a user to enter an account name and choose a distributor via demand planning option.

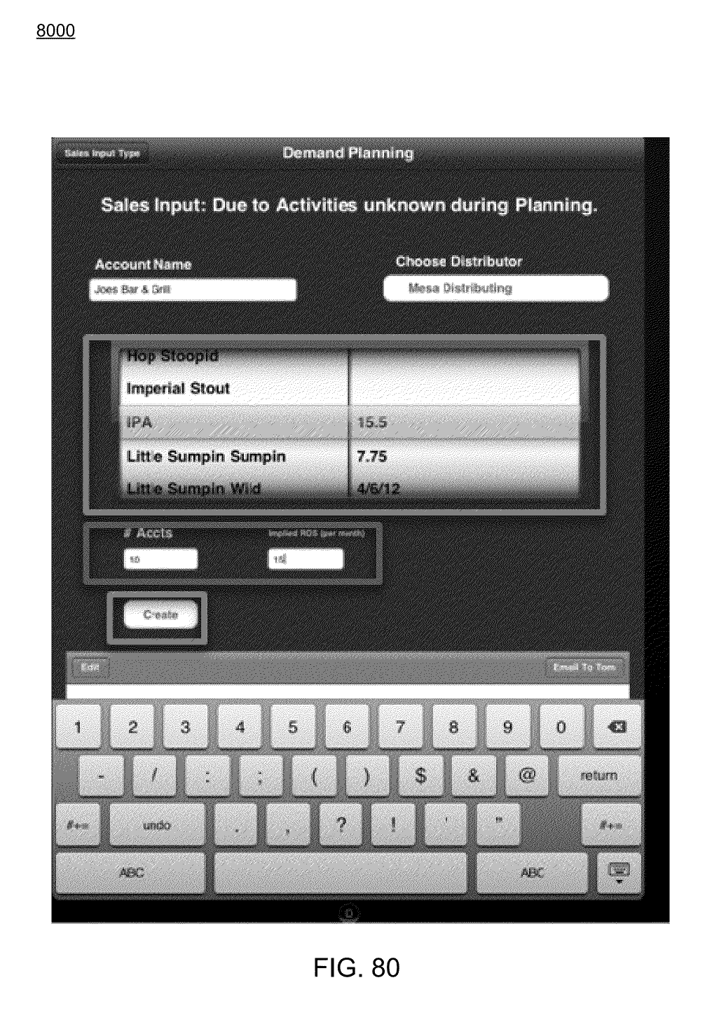

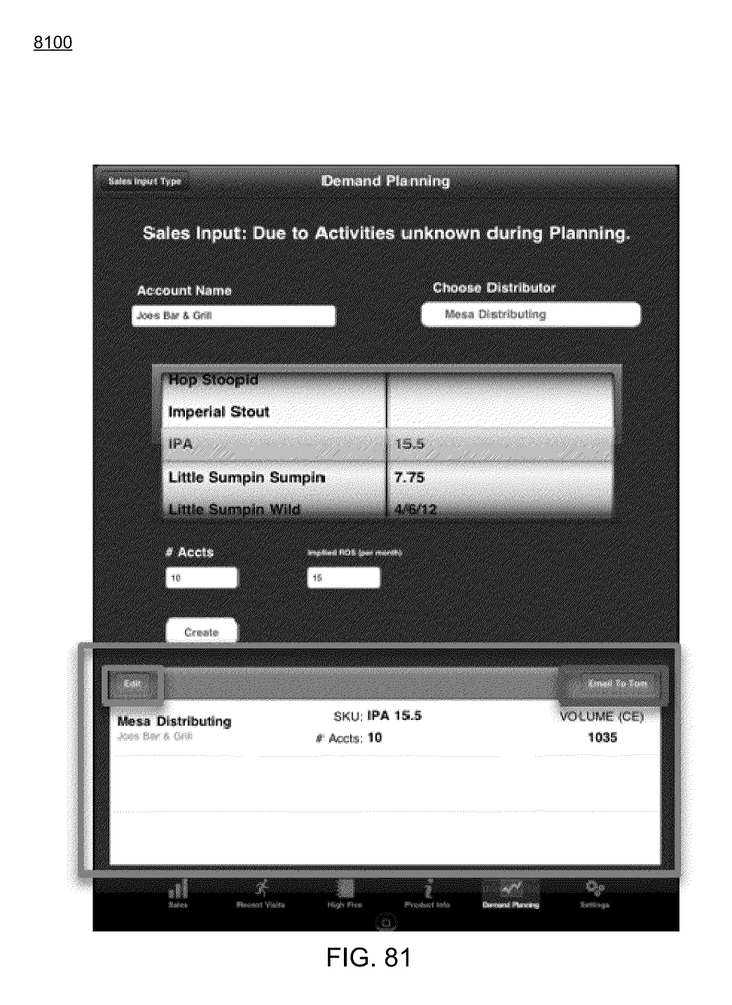

Referring now to FIG. 80-81, embodiments depicting interfaces 8000-8100 generated in accordance with CRM process 10 are depicted. CRM process 10 may be configured to allow a user to enter a brand and a pack size, enter a number of Accounts, Enter Implied ROS (per month), etc. Once the entry has been created it may be edited and emailed.

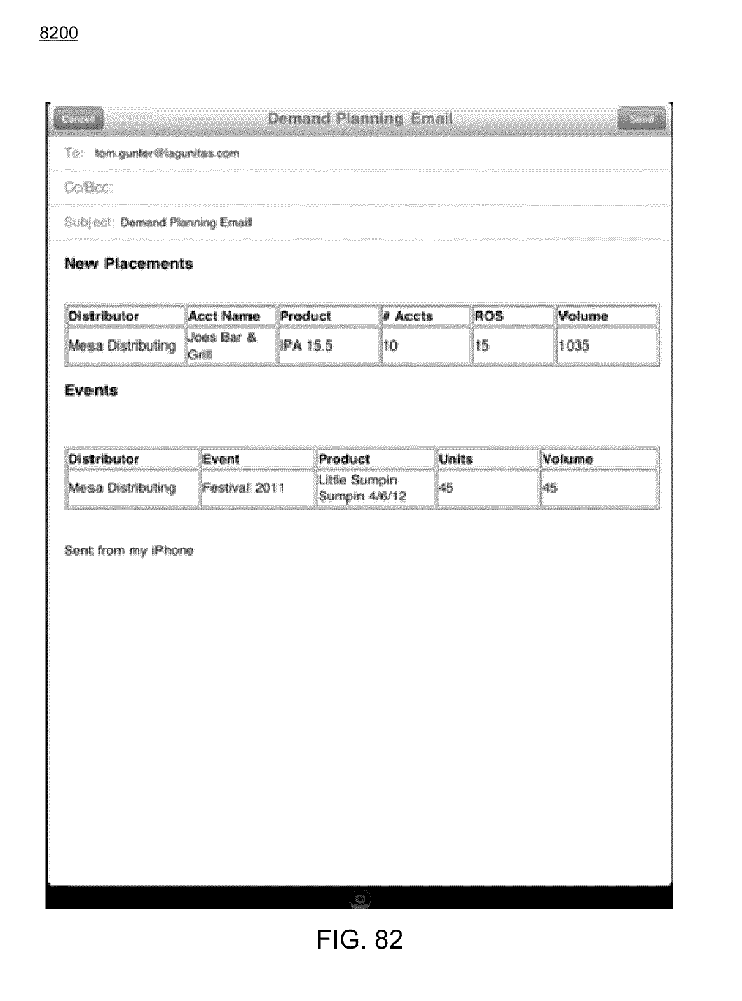

Referring now to FIG. 82, an embodiment depicting interface 8200 generated in accordance with CRM process 10 is depicted. CRM process 10 may be configured to allow a user to review email correspondence created via the demand planning option.

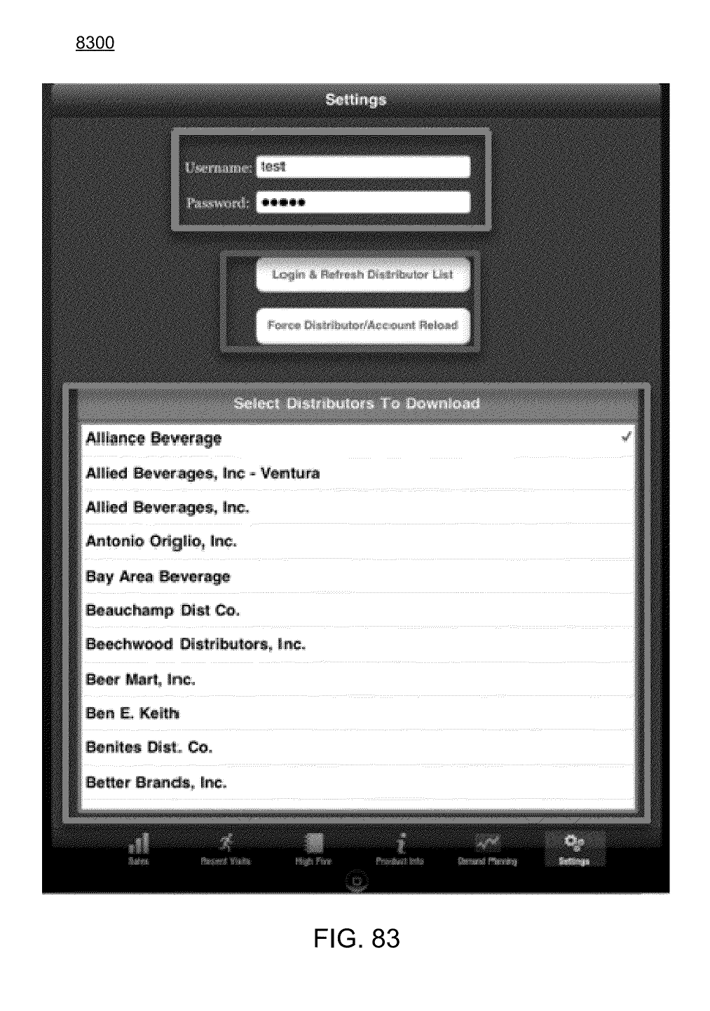

Referring now to FIG. 83, an embodiment depicting interface 8300 generated in accordance with CRM process 10 is depicted. CRM process 10 may be configured to generate a settings option. Through the settings option a user may be allowed to download distributors and to refresh available distributor lists.

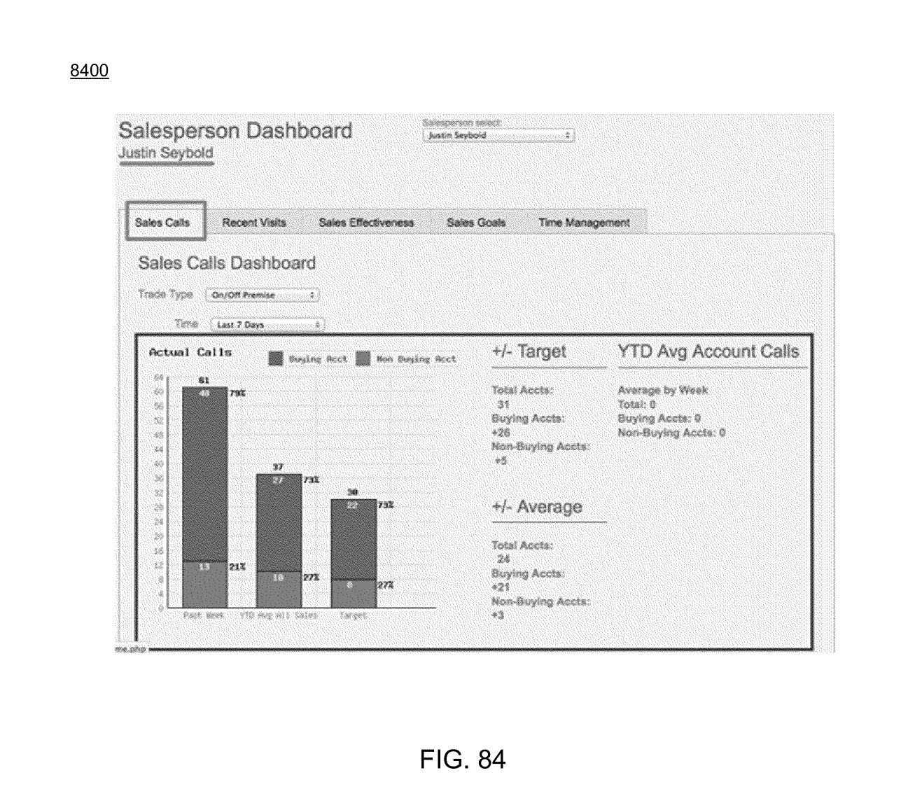

Referring now to FIG. 84, an embodiment depicting interface 8400 generated in accordance with CRM process 10 is depicted. CRM process 10 may be configured to generate one or more sales dashboards. For example, a “Sales Calls” dashboard may track the number of account visits that a sales person is making. The chart compares the number of visits to buying and non-buying accounts, on and off premise accounts, aggregated or individual, by week or month, and may compare those numbers against the sales person's target number of visits, and to the average numbers by the entire sales force. In some embodiments, from this view it may be possible to switch between individual members of the sales team to quickly report on each one.

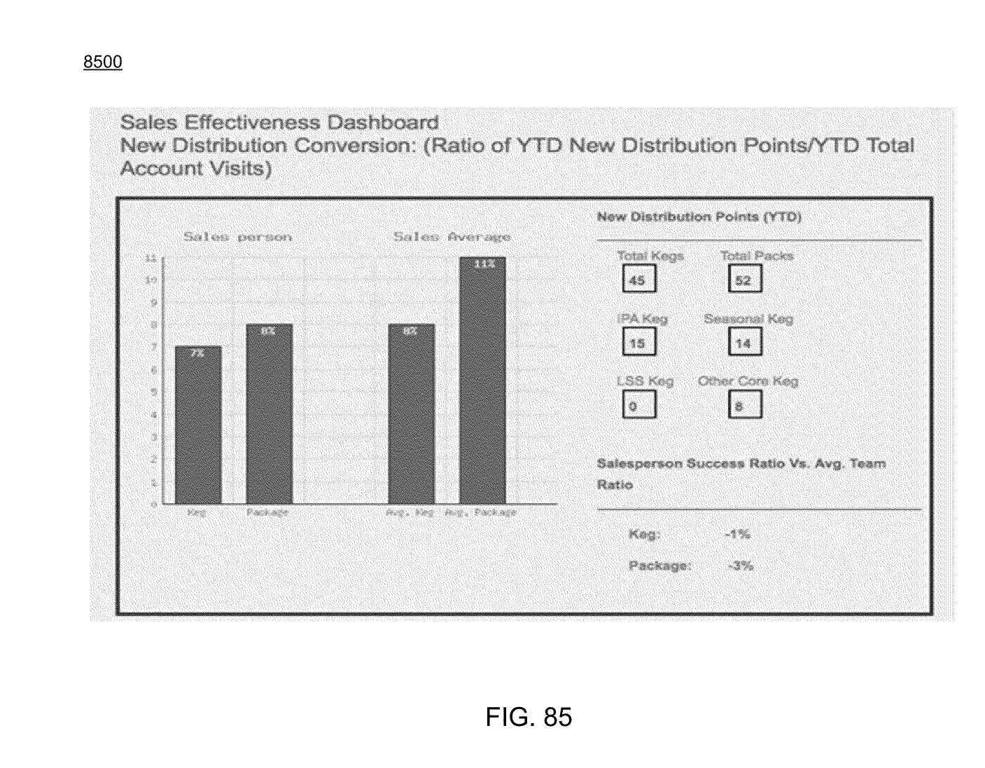

Referring now to FIG. 85, an embodiment depicting interface 8500 generated in accordance with CRM process 10 is depicted. CRM process 10 may be configured to generate a sales effectiveness dashboard. In some embodiments, the Sales Effectiveness dashboard may provide insight into the relationship between a member of the sales teams overall number of account visits, and the resulting number of new placements achieved. This percentage may be compared against the average for the entire sales force. The new placements may be broken up by keg and pack. In some embodiments, key products may also be highlighted individually.

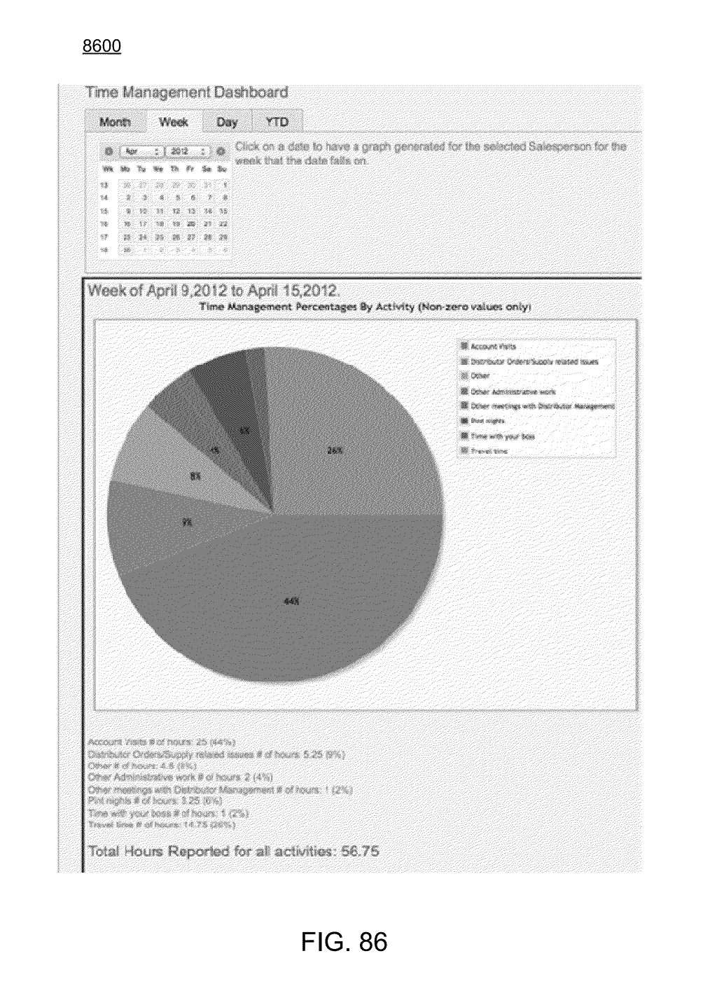

Referring now to FIG. 86, an embodiment depicting interface 8600 generated in accordance with CRM process 10 is depicted. CRM process 10 may be configured to generate a time management dashboard. In some embodiments, some or all of the entries made through the time management portal may be reported on. A user may be able to view a sales person's time by day, week, month, and/or YTD. All of the sales person's activities may be mapped out as a percentage of their total time, based on the level of aggregation chosen.

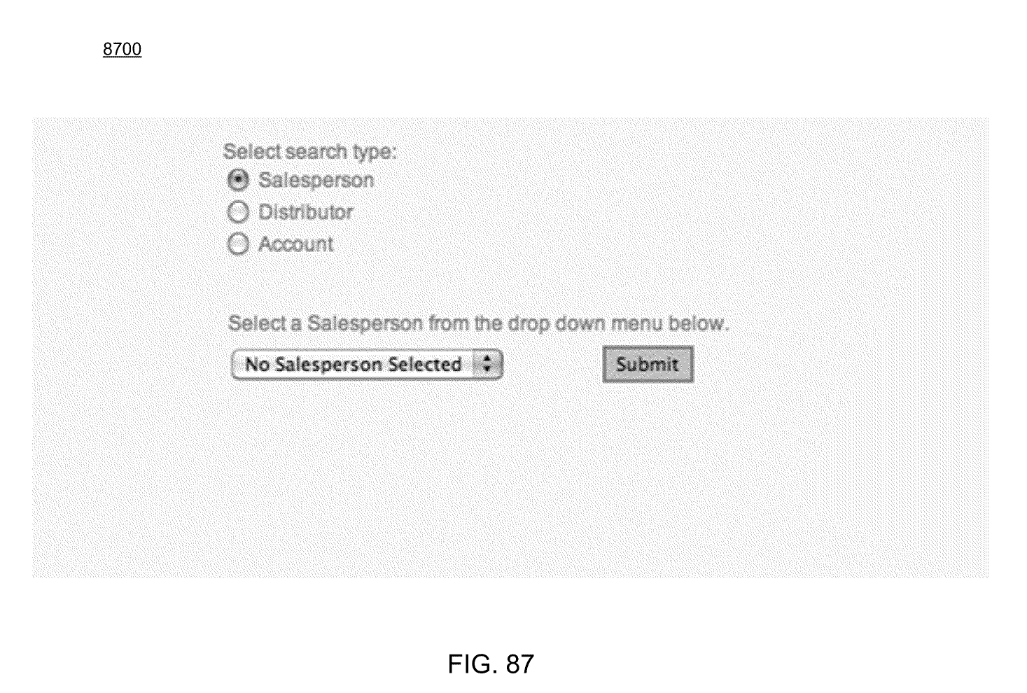

Referring now to FIG. 87, an embodiment depicting interface 8700 generated in accordance with CRM process 10 is depicted. CRM process 10 may be configured to allow a user to report on a Salesperson, a Distributor, a specific Account, etc.

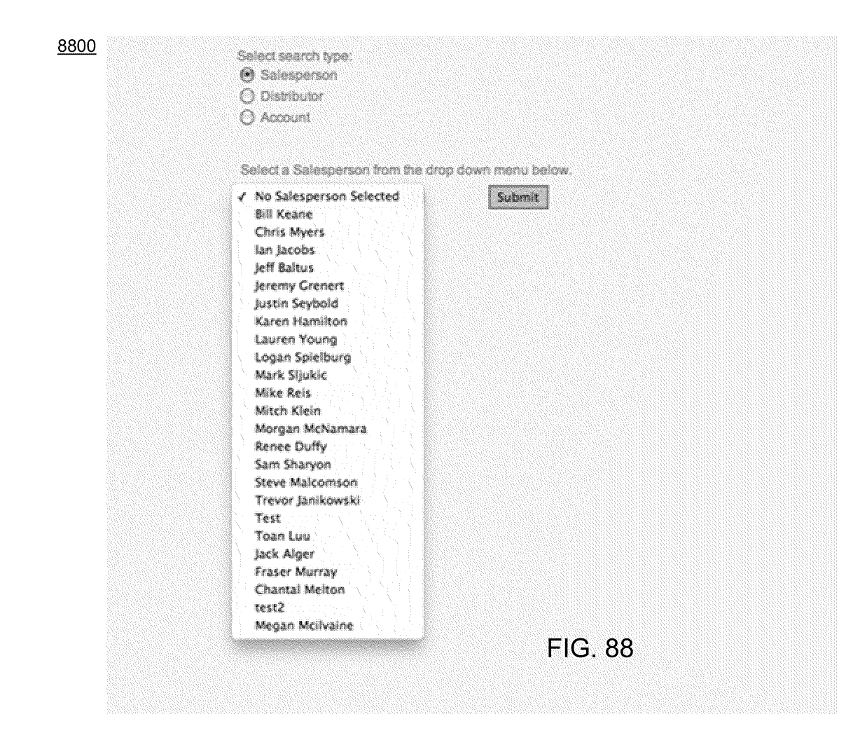

Referring now to FIG. 88, an embodiment depicting interface 8800 generated in accordance with CRM process 10 is depicted. CRM process 10 may be configured to allow a user to select a particular salesperson for which to provide a report.

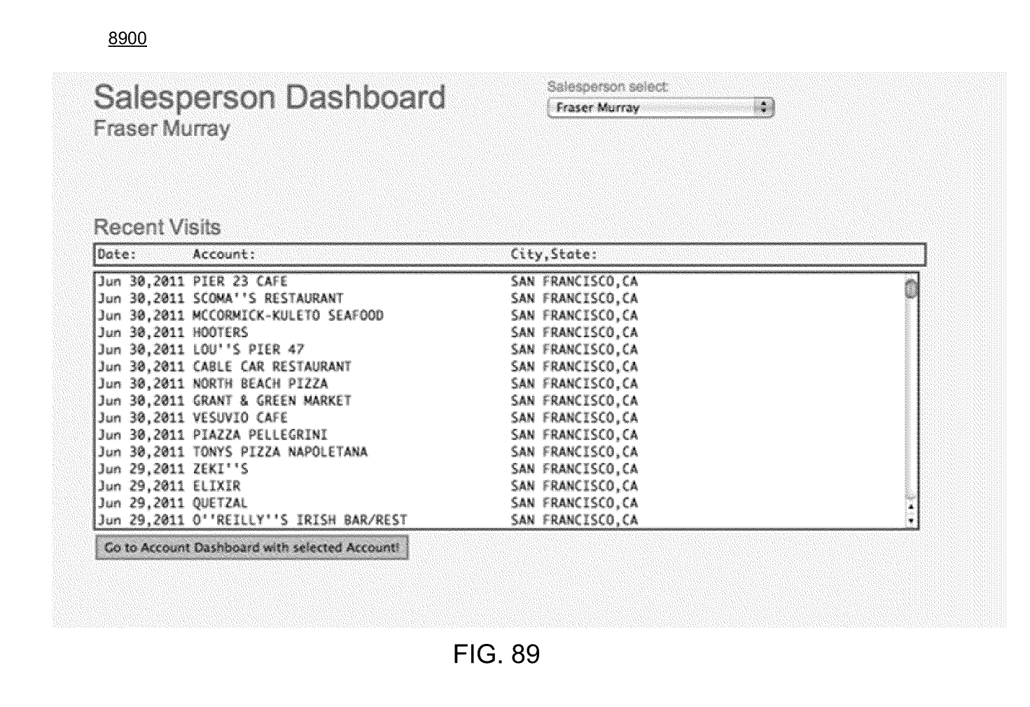

Referring now to FIG. 89, an embodiment depicting interface 8900 generated in accordance with CRM process 10 is depicted. CRM process 10 may be configured to generate a Recent Account Visits display. In some embodiments, choosing a salesperson may provide the user with access to that salesperson's dashboard. At the top of the dashboard there may be a list of this person's account visits for the last 90 days. Clicking an account may take you to the account dashboard page.

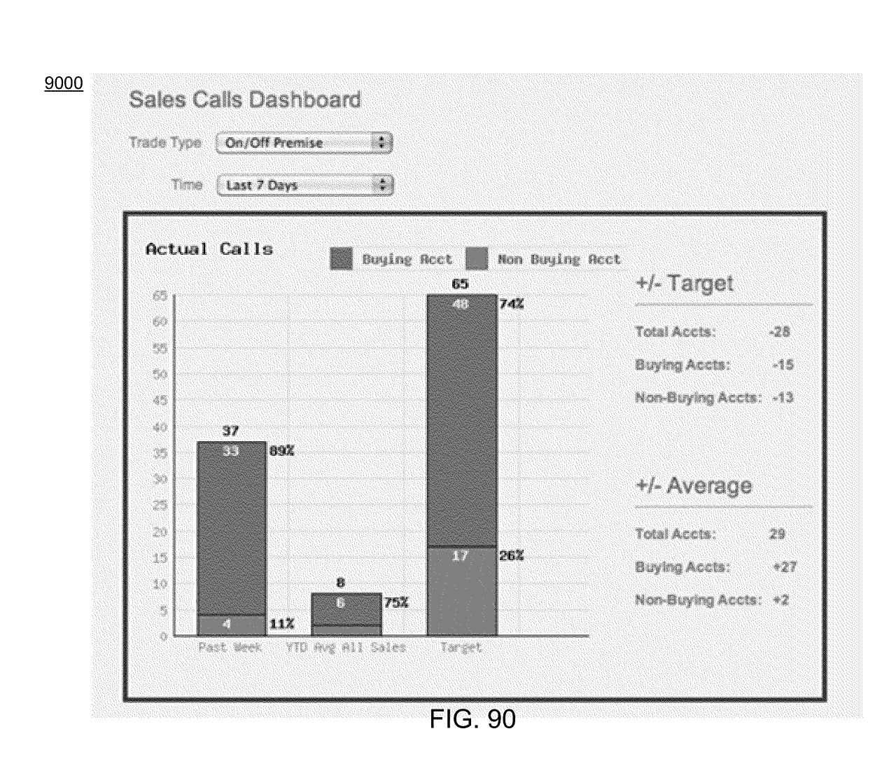

Referring now to FIG. 90, an embodiment depicting interface 9000 generated in accordance with CRM process 10 is depicted. CRM process 10 may be configured to generate a Sales Calls Dashboard. In some embodiments, the Sales Calls Dashboard may provide the number of account visits a Salesperson has made, and whether they were buying or non-buying accounts. In some embodiments, this may be viewed for the last 7 or 30 days, and may also be filtered by on/off premise account types. The number of account visits may be compared with the salesperson's target, along with the average of the sales force.

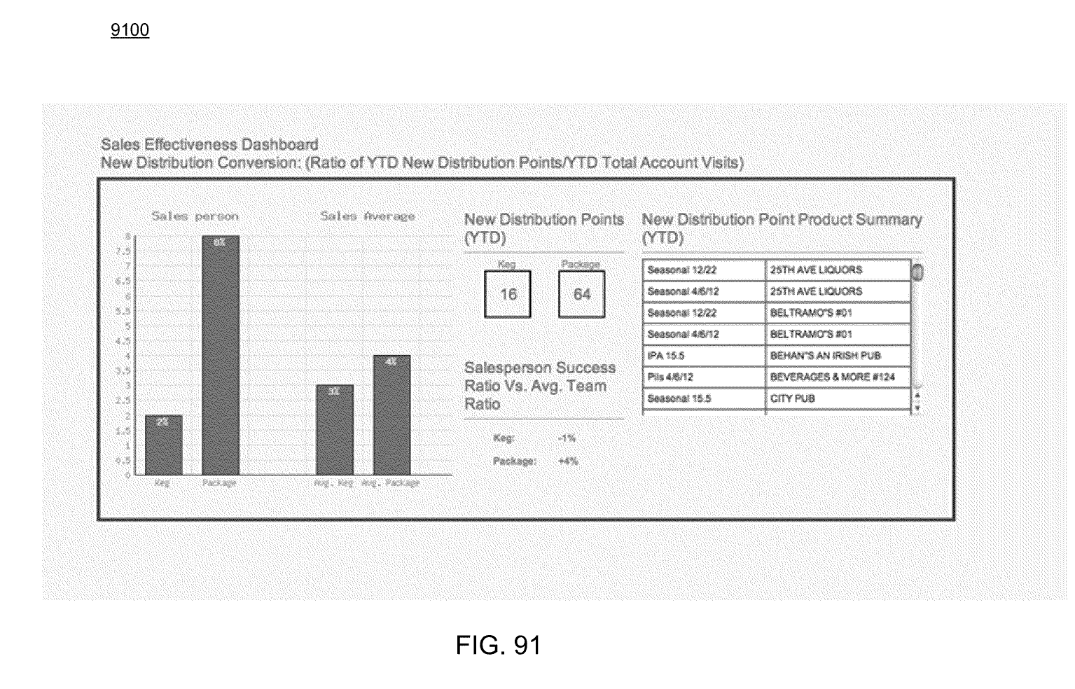

Referring now to FIG. 91, an embodiment depicting interface 9100 generated in accordance with CRM process 10 is depicted. CRM process 10 may be configured to generate a Sales Effectiveness Dashboard. The Sales Effectiveness Dashboard may determine what percentage of a person's account visits turn into new points of distribution (YTD). This ratio may be determined by comparing the total number of account visits with account visits that have turned a new placement. This number may be divided up by new “Keg” placements, and “Pack” placements. The number may also be compared against the average of the sales force. The actual “hard” number of new placements (by keg and pack) may be outputted, along with how that number compares to the average of the sales force. In some embodiments, a view of a list of all new placements (YTD) for this Salesperson, what product was sold in, and to which account may be provided.

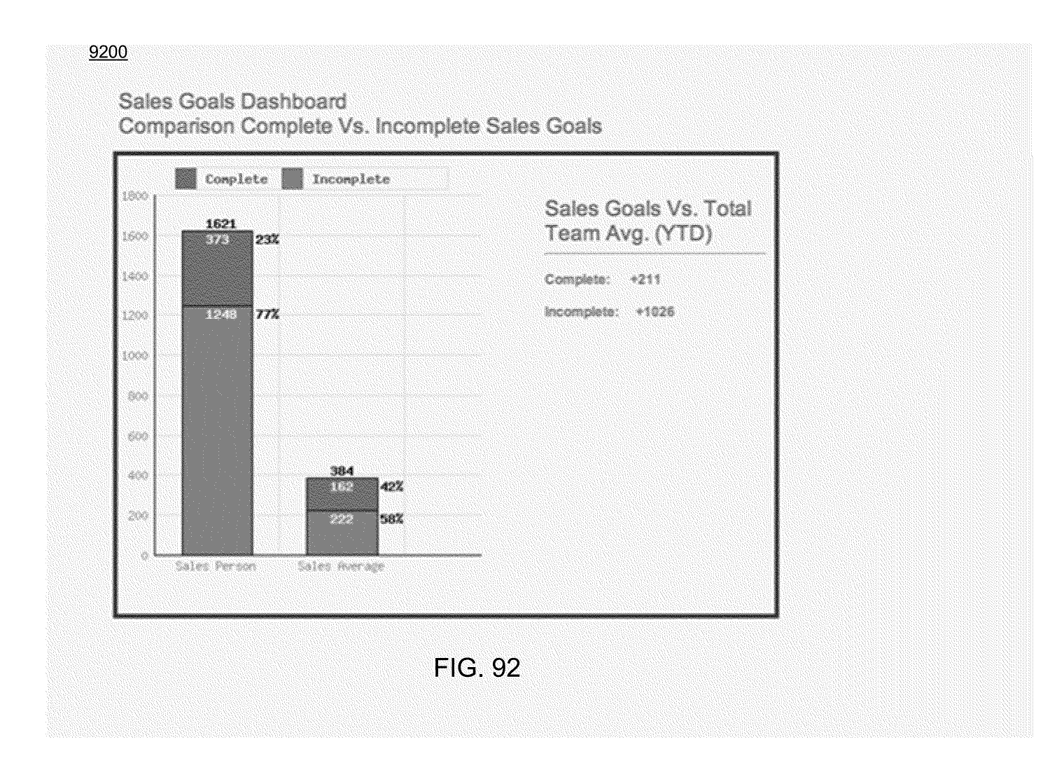

Referring now to FIG. 92, an embodiment depicting interface 9200 generated in accordance with CRM process 10 is depicted. CRM process 10 may be configured to generate a Sales Goals Dashboard. In some embodiments, the Sales Goals dashboard may provide how many goals have been set (YTD), and what percentage of those goals have ended up being completed. This number may be compared to the average of the sales force.

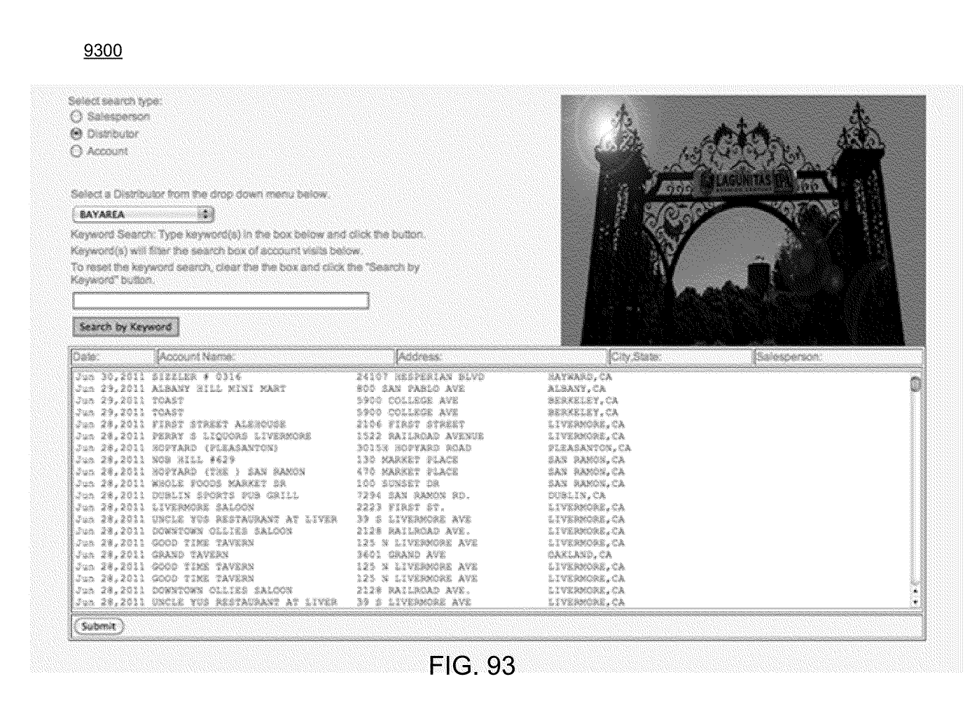

Referring now to FIG. 93, an embodiment depicting interface 9300 generated in accordance with CRM process 10 is depicted. CRM process 10 may be configured to generate a Reporting—Distributors page. In some embodiments, reporting on a specific Distributor may filter the list of total Accounts, by ones pertaining to that Distributor. CRM process 10 may allow the user to then scroll through the list, or enter in all (or part) of an account name to narrow a search.

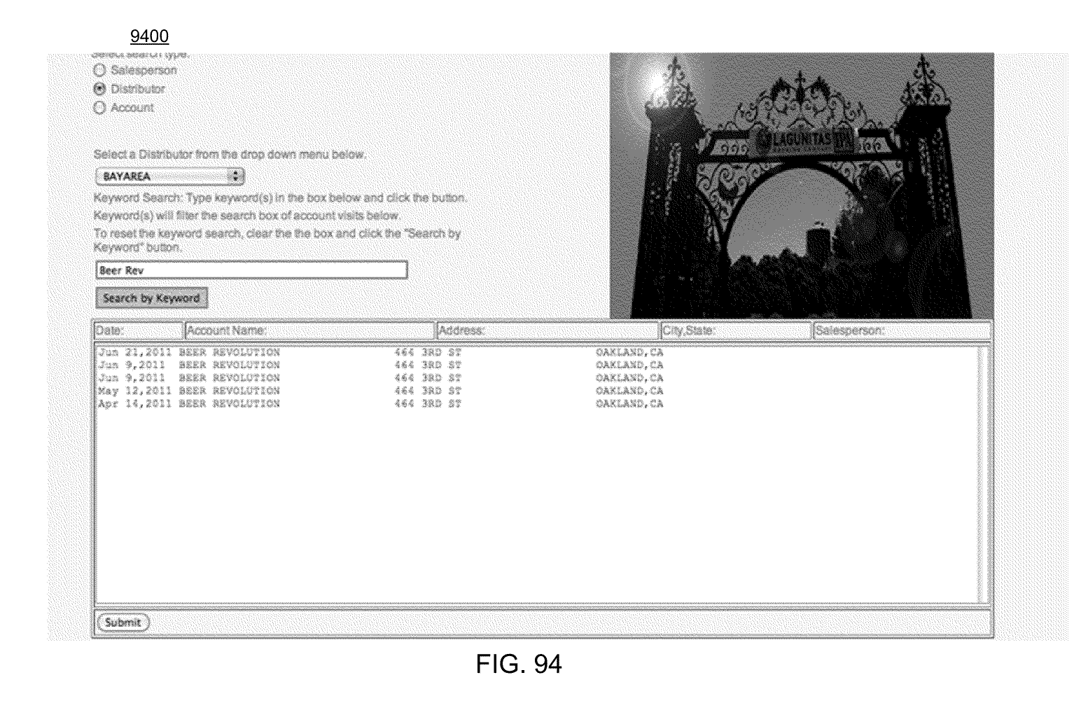

Referring now to FIG. 94, an embodiment depicting interface 9400 generated in accordance with CRM process 10 is depicted. CRM process 10 may be configured to generate a distributor reporting page.

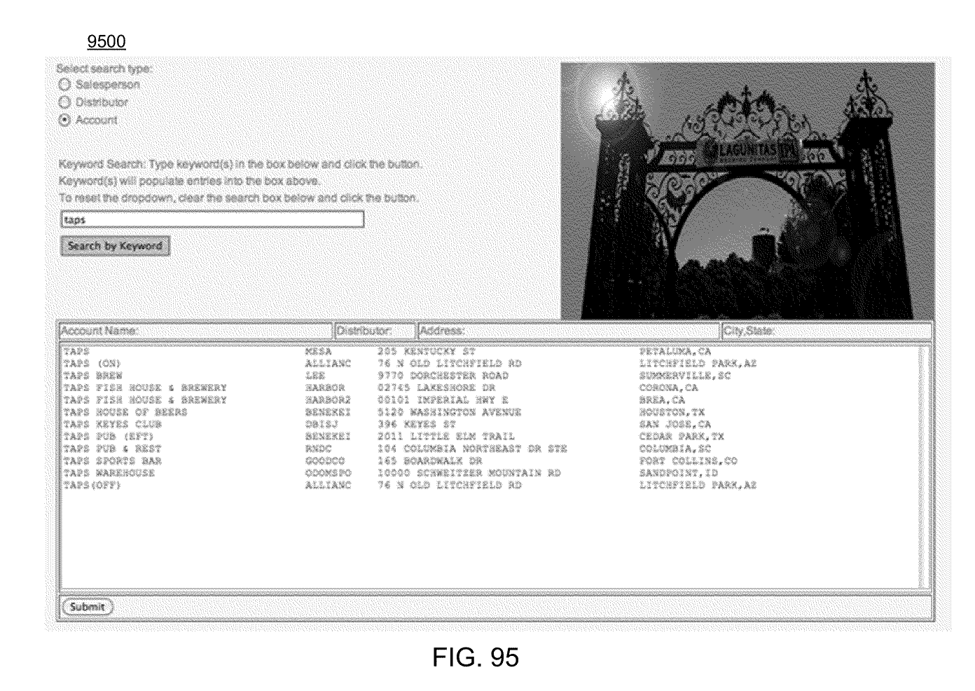

Referring now to FIG. 95, an embodiment depicting interface 9500 generated in accordance with CRM process 10 is depicted. CRM process 10 may be configured to generate an account reporting page. In order to view the Dashboard for a specific account, a user may type a keyword into the search bar.

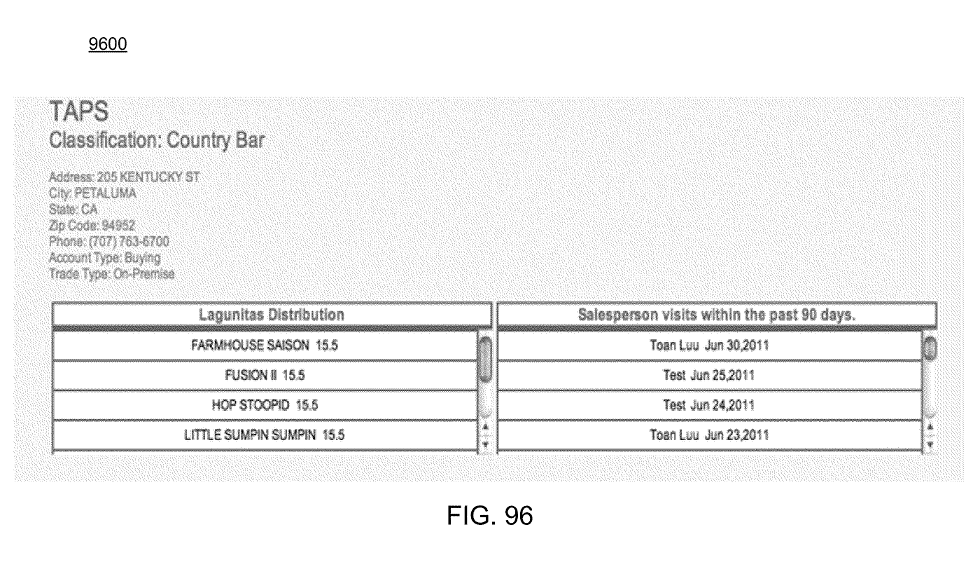

Referring now to FIG. 96, an embodiment depicting interface 9600 generated in accordance with CRM process 10 is depicted. CRM process 10 may be configured to generate an Account Dashboard view. Accordingly, a user may select a desired account to bring up the Dashboard for that Account. Information regarding the account may be provided. For example, a list of Distribution within the account, along with a list of recent visits to that account within the past 90 days.

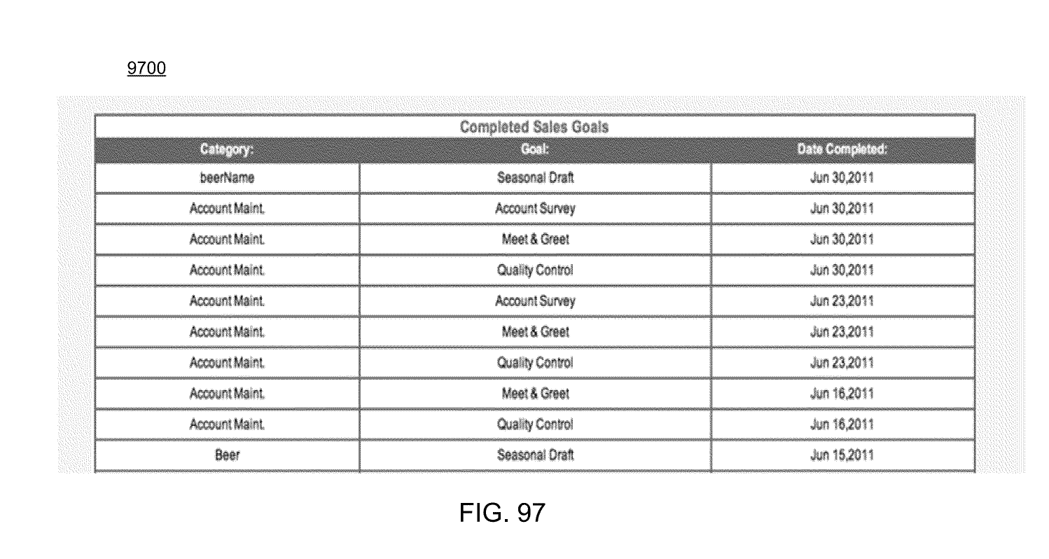

Referring now to FIG. 97, an embodiment depicting interface 9700 generated in accordance with CRM process 10 is depicted. CRM process 10 may be configured to generate an Account Dashboard page. In some embodiments, the Account Dashboard may also show all Sales Goals (both completed and incomplete), for the account (e.g., in the last 90 days).

In some embodiments, CRM process 10 may utilize, at least in part, xCode (Integrated Development Environment), along with the Cocoa framework (Application Programming Interface) available from Apple, Inc. CRM process 10 may also utilize, at least in part, the Objective C programming language, which is a high level object oriented programming language.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method for customer relationship management comprising:
receiving, using one or more computing devices, an indication from a user at one or more customer relationship management graphical user interfaces;
identifying, using one or more computing devices, one or more accounts associated with the user;
providing, using the one or more computing devices, an itinerary or portion of an itinerary to the user for a particular time period via at least one of the one or more customer relationship management graphical user interfaces;
filtering, using the one or more computing devices, the one or more accounts based upon, at least in part, an input from the user to generate a filtered result set; and
storing, using the one or more computing devices, at least one of the filtered result set and the itinerary.

2. The computer-implemented method of claim 1, further comprising:
ordering, using the one or more computing devices, the filtered result set based upon a predetermined setting.

3. The computer-implemented method of claim 2, wherein ordering is based upon at least one of, a volume of products sold, a dollar amount of products sold, a city name, a zip code, and a name.

4. The computer-implemented method of claim 1, further comprising:
providing, using the one or more computing devices, a map view with a geographical location corresponding to each of the one or more accounts.

5. The computer-implemented method of claim 4, further comprising:
generating, using the one or more computing devices, at least one route based upon, at least one of, the geographical location, account information, and account volume.

6. The computer-implemented method of claim 1, further comprising:
generating, using the one or more computing devices, a new account based upon, at least in part, information received from the user.

7. The computer-implemented method of claim 1, wherein the new account information includes classification information.

8. A computer program product residing on a computer readable storage medium having a plurality of instructions stored thereon, which when executed by a processor, cause the processor to perform operations comprising:
receiving, using one or more computing devices, an indication from a user at one or more customer relationship management graphical user interfaces;
identifying, using one or more computing devices, one or more accounts associated with the user;
providing, using the one or more computing devices, an itinerary or portion of an itinerary to the user for a particular time period via at least one of the one or more customer relationship management graphical user interfaces;
filtering, using the one or more computing devices, the one or more accounts based upon, at least in part, an input from the user to generate a filtered result set; and
storing, using the one or more computing devices, at least one of the filtered result set and the itinerary.

9. The computer program product of claim 8, wherein operations further comprise:
ordering, using the one or more computing devices, the filtered result set based upon a predetermined setting.

10. The computer program product of claim 9, wherein ordering is based upon at least one of, a volume of products sold, a dollar amount of products sold, a city name, a zip code, and a name.

11. The computer program product of claim 8, further comprising:
providing, using the one or more computing devices, a map view with a geographical location corresponding to each of the one or more accounts.

12. The computer program product of claim 11, further comprising:
generating, using the one or more computing devices, at least one route based upon, at least one of, the geographical location, account information, and account volume.

13. The computer program product of claim 8, further comprising:
generating, using the one or more computing devices, a new account based upon, at least in part, information received from the user.

14. The computer program product of claim 8, wherein the new account information includes classification information.

15. A computing system comprising:
one or more processors configured to receive an indication from a user at one or more customer relationship management graphical user interfaces, the one or more processors further configured to identify one or more accounts associated with the user, the one or more processors further configured to provide an itinerary or portion of an itinerary to the user for a particular time period via at least one of the one or more customer relationship management graphical user interfaces, the one or more processors further configured to filter the one or more accounts based upon, at least in part, an input from the user to generate a filtered result set, the one or more processors further configured to enable storing at least one of the filtered result set and the itinerary.

16. The computing system of claim 15, wherein the one or more processors are further configured to order the filtered result set based upon a predetermined setting.

17. The computing system of claim 16, wherein ordering is based upon at least one of, a volume of products sold, a dollar amount of products sold, a city name, a zip code, and a name.

18. The computing system of claim 15, wherein the one or more processors are further configured to provide a map view with a geographical location corresponding to each of the one or more accounts.

19. The computing system of claim 18, wherein the one or more processors are further configured to generate at least one route based upon, at least one of, the geographical location, account information, and account volume.

20. The computing system of claim 15, wherein the one or more processors are further configured to generate a new account based upon, at least in part, information received from the user

21. The computing system of claim 15, wherein the new account information includes classification information
